(19) United States
(12) Patent Application Publication
(10) Pub. No.: US 2008/0207864 A1
(43) Pub. Date: Aug. 28, 2008

(54) Organosilanes, Process For Production of the Same, and Use Thereof

(76) Inventors: Masatoshi Nakagawa, Nara (JP); Hiroyuki Hanato, Nara (JP); Toshihiro Tamura, Nara (JP)

Correspondence Address: NIXON & VANDERHYE, PC, 901 NORTH GLEBE ROAD, 11TH FLOOR, ARLINGTON, VA, 22203, US

(21) Appl. No.: 10/593,204

(22) PCT Filed: Mar. 16, 2005
(86) PCT No.: PCT/JP2005/004658

§ 371 Date: Mar. 18, 2008

(30) Foreign Application Priority Data
Mar. 18, 2004 (JP) 2004-079056
Mar. 18, 2004 (JP) 2004-079062
Mar. 19, 2004 (JP) 2004-080333
Mar. 19, 2004 (JP) 2004-080375
Aug. 24, 2004 (JP) 2004-243508

(51) Int. Cl. C08G 77/04

(52) U.S. Cl. 528/25

(57) ABSTRACT

An organic silane compound represented by the general formula (a); (T)ₖ-SiX¹X²X³ (a) wherein T is an organic group derived from a fused polycyclic hydrocarbon compound of a fusion number of 2 to 10 composed of a 5-membered and/or 6-membered monocyclic hydrocarbon; k is an integer of 1 to 10; at least one group of X¹ to X³ is a group which gives a hydroxy group by hydrolysis, or a halogen atom, and other groups are a group which does not react with an adjacent molecule.

### TECHNICAL FIELD

The present invention relates to an organic silane compound, a process for producing the same, and use of the same. More particularly, the present invention relates to a novel organic silane compound which is useful as an electric material and has electrical conductivity or electrical semiconductivity, a process for producing the same, and use of the same.

### BACKGROUND ART

Recently, a semiconductor of an organic compound (organic semiconductor) is paid an attention, because in comparison with a semiconductor of a inorganic material, it is simple on production, is easy on processing, can lead scale up of a device, can expect to cost down by mass production and can synthesized as having a variety of functions. For this reason, an organic semiconductor material, as well as an electronic device (e.g. organic thin film transistor (organic TFT), an organic electroluminescence device (organic EL device)) using the same are being researched and developed. Previously, since a semiconductor layer of an electronic device has been formed mainly by a deposition method, material development has focused mainly on a compound having a skeleton of a π electron conjugation system, and its representative example is pentacene. On the other hand, a semiconductor layer formed by the deposition method has problems that its process is troublesome, or a film strength is small. Therefor, development of an organic material which can form a thin film having strong interaction with a substrate is sought.

As a method of forming such the organic thin film, in recent years, a method utilizing self organization has been paid an attention and, accompanying therewith, a material having the self organizing ability has been also developed. Inter alia, a silicon-based compound film is paid an attention in that it has high durability and, as representative development thereof, a silane coupling agent having an alkyl group or a fluorinated alkyl group having high water-repellency effect as a functional group, or a compound having one thiophene ring as a functional group at an end of a molecule, in which the thiophene ring is bound to a silicon atom via a linear hydrocarbon group has been proposed (e.g. patent document 1).

[Patent document 1] Japanese Patent No. 2889768)

### DISCLOSURE OF INVENTION

### Problems that the Invention is to Solve

However, the aforementioned organic compound could not afford an organic thin film having sufficient ordering property and electrical conducting property.

Specifically, when an electronic device is organic TFT, there is the following problem. That is, the organic compound is chemically adsorbed on a substrate by forming a two-dimensional network of Si—O—Si, and has a possibility that ordering property due to intermolecular interaction between particular long chain alkyls is obtained. However, expansion of π electron conjugation system essential for electrical conductivity is very small, because a π electron conjugation system molecule contributing to improvement in electrical conductivity is one thiophene ring. Therefore, there is a problem that even when the organic compound is used as a semiconductor layer in an organic thin film transistor, sufficient carrier mobility is not obtained.

In addition, in the case of organic EL, there is the following problem. That is, mobility of a hole or an electron is small, because a π electron conjugation system molecule contributing to improvement in an efficiency of injecting a hole or an electron is one thiophene ring. Then, there is a problem that, even when the organic compound is used as an organic layer in an organic EL device, it is difficult to generate light emission at a sufficiently low driving voltage.

In order to attain the aforementioned object, the present inventors intensively studied and, as a result, found out that, for preparing a thin film which can be applied to an electron device such as organic TFT and an organic EL device, a firm chemical binding with a substrate is possible by formation of a two-dimensional network of Si—O—Si and, at the same time, ordering property (crystallizability) of the thin film can be controlled by interaction, that is, an intermolecular force of an organic group (π electron conjugation system molecule) derived from a fused polycyclic hydrocarbon compound formed on a two-dimensional network of Si—O—Si, resulting in finding of a novel organic silane compound containing an organic group.

Thus, according to the present invention, there is provided an organic silane compound represented by the general formula (a);

(T)ₖ-SiX¹X²X³ (a)

wherein T is an organic group derived from a fused polycyclic hydrocarbon compound of a fusion number of 2 to 10 composed of a 5-membered and/or 6-membered monocyclic hydrocarbon; k is an integer of 1 to 10; at least one group of X¹ to X³ is a group which gives a hydroxy group by hydrolysis, or a halogen group, and other groups of X¹ to X³ are a group which does not react with an adjacent molecule.

Also, according to the present invention, there is provided a process for producing an organic silane compound, comprising subjecting to the Grignard reaction of a compound represented by the general formula (b);

(T)ₖ-MgL¹ (b)

wherein T is an organic group derived from a fused polycyclic hydrocarbon compound of a fusion number of 2 to 10 composed of a 5-membered and/or 6-membered monocyclic hydrocarbon; k is an integer of 1 to 10; L¹ is a halogen atom, with a compound represented by the general formula (c);

L²-SiX¹X²X³ (c)

wherein L² is a hydrogen atom, a halogen atom or an alkoxy group of a carbon number of 1 to 4; at least one group of X¹ to X³ is a group which gives a hydroxy group by hydrolysis or a halogen atom, and other groups of X¹ to X³ are a group which does not react with an adjacent molecule, to obtain an organic silane compound represented by the general formula (a);

(T)ₖ-SiX¹X²X³ (a)

wherein T, k, X¹ to X³ are as defined above.

Further, according to the present invention, there is provided a functional organic thin film comprising a thin film which is derived from an organic silane compound represented by the general formula (a);

(T)ₖ-SiX¹X²X³ (a)

wherein T is an organic group derived from a fused polycyclic hydrocarbon compound of a fusion number of 2 to 10 composed of 5-membered and/or 6-membered monocyclic hydrocarbon; k is an integer of 1 to 10; at least one group of X¹ to X³ is a group which gives a hydroxyl group by hydrolysis or a halogen atom, and other groups of X¹ to X³ are a group which does not react with an adjacent molecule, and is bound to a substrate via a siloxane bond.

Also, according to the present invention, there is provided a process for producing a functional organic thin film bound to a substrate via a siloxane bond, comprising subjecting an organic silane compound represented by the general formula (a);

(T)ₖ-SiX¹X²X³ (a)

wherein T is an organic group derived from a fused polycyclic hydrocarbon compound of a fusion number of 2 to 10 composed of 5-membered and/or 6-membered monocyclic hydrocarbon; k is an integer of 1 to 10; at least one group of X¹ to X³ is a group which gives a hydroxyl group by hydrolysis or a halogen atom, and other groups of X¹ to X³ are a group which does not react with an adjacent molecule, to a chemical binding method.

Further, according to the present invention, there is provided an organic thin film transistor comprising a substrate, a functional organic thin film which is derived from an organic silane compound represented by the general formula (a);

(T)ₖ-SiX¹X²X³ (a)

wherein T is an organic group derived from a fused polycyclic hydrocarbon compound of a fusion number of 2 to 10 composed of 5-membered and/or 6-membered monocyclic hydrocarbon; k is an integer of 1 to 10; at least one group of X¹ to X³ is a group which gives a hydroxyl group by hydrolysis or a halogen atom, and other groups of X¹ to X³ are a group which does not react with an adjacent molecule, and is bound to the substrate via a siloxane bond, a gate electrode formed on one surface of the functional organic thin film via a gate insulating film, and a source electrode/a drain electrode which are formed on both sides of the gate electrode, contacting with one surface or other surface of the functional organic thin film.

Also, according to the present invention, there is provided a process for producing an organic thin film transistor, comprising the steps of (A) forming a functional organic thin film which is derived from an organic silane compound represented by the general formula (a);

(T)ₖ-SiX¹X²X³ (a)

wherein T is an organic group derived from a fused polycyclic hydrocarbon compound of a fusion number of 2 to 10 composed of 5-membered and/or 6-membered monocyclic hydrocarbon; k is an integer of 1 to 10; at least one group of X¹ to X³ is a group which gives a hydroxyl group by hydrolysis or a halogen atom, and other groups of X¹ to X³ are a group which does not react with an adjacent molecule, and is bound to a substrate via a siloxane bond, directly or indirectly on the substrate, (B) forming a gate electrode indirectly or directly on the substrate, (C) forming a source electrode•a drain electrode on one surface side or other surface side of the functional organic thin film, and (D) forming a gate insulating film between the gate electrode and the source electrode•the drain electrode.

Further, according to the present invention, there is provided an organic electroluminescence device comprising one or more organic thin films between an anode and a cathode, wherein at least one organic thin film is a functional organic thin film which is derived from an organic silane compound represented by the general formula (a);

(T)ₖ-SiX¹X²X³ (a)

wherein T is an organic group derived from a fused polycyclic hydrocarbon compound of a fusion number of 2 to 10 composed of 5-membered and/or 6-membered monocyclic hydrocarbon; k is an integer of 1 to 10; at least one group of X¹ to X³ is a group which gives a hydroxyl group by hydrolysis or a halogen atom, and other groups of X¹ to X³ are a group which does not react with an adjacent molecule, and is bound to an anode, a cathode or other organic thin film via a siloxane bond.

### EFFECT OF THE INVENTION

The organic silane compound of the present invention has the self organizing ability derived from a silyl group. Therefor, an organic thin film having very high stability can be constructed by a solution method.

In addition, the organic silane compound of the present invention can form a two-dimensional network of Si—O—Si between organic silane compounds. Further, the organic thin film having very high stability and durability is obtained, because the organic silane compound can be chemically bound to a substrate via this network. Therefore, physical peeling of the resulting organic thin film can be prevented, because it is adsorbed on the substrate surface firm as compared with a film prepared by physical adsorption on a substrate.

When the organic silane compound has a hydrophobic functional group, relatively high solubility in a non-aqueous solvent is possessed. Therefore, for example, when the organic thin film is formed, a solution method which is a relatively simple procedure can be applied. When the hydrophobic group is a linear hydrocarbon group, solubility in a non-aqueous solvent can be increased.

Further, since the organic silane compound of the present invention, when formed into the organic thin film, can impart high electrical conductivity, because it has an organic group (π electron conjugation system) derived from a fused polycyclic hydrocarbon compound. Therefore, the organic silane compound of the present invention is very useful not only in an organic TFT material and an organic EL device material, but also in an organic device such as a solar cell, a fuel cell, a sensor and the like.

The organic EL device of the present invention has a construction in which at least one organic thin film constituting the device is bound to an anode, a cathode or other organic thin film via a chemical bond derived from the organic silane compound. For this reason, durability of the organic thin film comprising the organic silane compound can be improved. In addition, injection of a hole or an electron at an interface between the organic thin film of the organic silane compound, and other layer adjacent to the thin film can be effectively performed. In addition, mobility of a hole or an electron of the organic thin film is great, because the organic thin film contains the organic group derived from the fused polycyclic hydrocarbon compound. Therefore, the organic EL device of the present invention can cause light emission at a relatively low driving voltage.

When a light emitting layer of the organic EL device of the present invention is derived from the organic silane compound having an acene skeleton, the organic EL device can be made to be a one layer-type device consisting of this light emitting layer, and one pair of electrodes holding the light emitting layer. In addition, by introducing an electronattracting group or the electron donating group into an organic silane compound having an acene skeleton, a hole transporting layer can be obtained from the former, and an electron transporting layer can be obtained from the latter. By holding these hole transporting layer and electron transporting layer, and the light emitting layer by one pair of electrodes, a multilayer-type organic EL device can be obtained. With the organic group derived from the fused polycyclic hydrocarbon compound other than the acene skeleton, the similar organic EL device can be obtained.

In addition, the organic silane compound itself of the present invention has the electronattracting effect, because it has the organic group derived from the fused polycyclic hydrocarbon compound, and a silicon atom, and they are directly bound. For this reason, when the organic silane compound is used, particularly, as the electron transporting layer, electron transferring property is particularly excellent, and the organic EL device which is highly effective in a light emitting at a lower driving voltage can be realized.

In addition, in order to impart higher light emitting property, electron transporting property or a transferring property to the organic thin film, it is preferable that the thin film is amorphous. In view of this point, it is preferable to use an organic silane compound also having a functional group at a position other than a long axis direction of the organic group derived from the fused polycyclic hydrocarbon compound among the organic silane compound of the present invention, in the organic EL device. This can reduce intermolecular interaction between adjacent molecules since a distance between adjacent molecules becomes great due to steric hindrance of the functional group.

Further, such the organic thin film excellent in hole or electron transporting property can be widely applied not only to the organic EL device but also to a device such as a solar cell and a sensor.

The present invention can provide an organic thin film transistor having a semiconductor layer derived from the organic silane compound. The organic thin film transistor of the present invention has high charge mobility, because it has the semiconductor layer derived from the organic silane compound. In addition, a leak current of the transistor can be suppressed small, because organic groups derived from adjacent fused polycyclic hydrocarbon compounds are not directly bound.

In addition, in order to impart higher electrical conductivity to the semiconductor layer, it is preferable that the semiconductor layer has crystallizability. In the present invention, by using the organic silane compound having the functional group in a direction along a long axis of the organic group derived from the fused polycyclic hydrocarbon compound, crystallizability of the semiconductor layer can be improved and, as a result, higher electrical conductivity can be imparted to the semiconductor layer. In addition, hopping conduction in a direction vertical to a molecular plane of the organic group derived from the fused polycyclic hydrocarbon compound constituting the organic group is also improved, and a carrier in this direction can be moved directly.

Such the semiconductor layer improved in crystallizability can be widely applied to not only the organic TFT, but also a device such as a solar cell, a fuel cell, a sensor and the like.

### BRIEF DESCRIPTION OF DRAWINGS

FIG. 1 is an outline construction view showing one example of the organic EL device of the present invention.

FIG. 2 is a conceptional view at a molecular level of an organic silane compound-containing layer used in the organic EL device of the present invention.

FIG. 3 is a conceptional view at a molecular level of an organic silane compound-containing layer used in the organic EL device of the present invention.

FIG. 4 is an outline view at a molecular level of a thin film using the organic silane compound of the present invention.

FIG. 5 is an outline view at a molecular level of a thin film using another organic silane compound of the present invention.

FIG. 6 is a conceptional view at a molecular level when FIG. 5 is seen from another viewpoint.

FIG. 7 is an outline view at a molecular level of organic TFT using the organic silane compound of the present invention.

FIG. 8 is a property view of organic TIT in Example 15-3.

FIG. 9 is a property view of organic TFT in Example 15-4.

FIG. 10 is property view of organic TFT in Example 15-5.

FIG. 11 is property view of organic TFT in Example 15-6.

### EXPLANATION OF REFERENCE

1: anode, 2: hole transporting layer, 3: light emitting layer, 4: electron transporting layer, 5: cathode, 6:21:24: substrate, 10:20: organic thin film, 11:14: layer on which the layer is to be formed, 12:15:23:31: organic group, 13:16: functional group, 22:30: network, 25; gate electrode, 26: gate insulating film, 27: source electrode, 28: drain electrode, 29: organic semiconductor layer, 32: linear hydrocarbon group,

### BEST MODE FOR CARRYING OUT THE INVENTION

### (Organic Silane Compound)

An organic silane compound of the present invention is represented by the general formula (a);

(T)ₖ-SiX¹X²X³ (a)

wherein T is an organic group derived from a fused polycyclic hydrocarbon compound of a fusion number of 2 to 10 composed of a 5-membered and/or 6-membered monocyclic hydrocarbon; k is an integer of 1 to 10; at least one group of X¹ to X³ is a group which gives a hydroxy group by hydrolysis, or a halogen atom, and other groups of X¹ to X³ are a group which does not react with an adjacent molecule.

In the formula (a), T is the organic group of a π electron conjugation system derived from the fused polycyclic hydrocarbon compound composed of the 5-membered and/or 6-membered monocyclic hydrocarbon, that is, a residue obtained by removing 1 or 2 or more hydrogen atoms from any ring constituting atom of the fused polycyclic hydrocarbon compound. The π electron conjugation means that a π electron governing a π bond is non-localized based on a σ bond and a σ bond possessed by a compound.

Examples of such the 5-membered and 6-membered monocyclic hydrocarbons constituting the fused polycyclic hydrocarbon compound include the following rings.

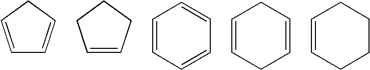

A total number of fused rings (monocyclic hydrocarbon) constituting the fused polycyclic hydrocarbon compound is 2 to 12, preferably 2 to 10 and, in view of a yield, more preferably 2 to 5.

The fused polycyclic hydrocarbon compound is not particularly limited as far as it forms a π electron conjugation system molecule and, from a viewpoint of electrical conductivity, a compound having symmetry, particularly, linear symmetry is preferable. As an example of such the preferable compound, for example, there are compounds having a straight line fused ring system acene skeleton, a wing-like fused ring system aphene skeleton, a fused ring system alene skeleton in which two same rings are aligned, a fused ring system phenylene skeleton in which benzene rings are concentrated around a center of one ring, and a fluorene skeleton in which 6-membered rings are fused on both sides of a 5-membered ring.

Preferable examples of the acene skeleton include naphthalene, anthracene, tetracene (naphthacene), pentacene, hexacene, heptacene, octacene and the like. Preferable examples of the aphene skeleton include phenanthrene, chrysene, teteraphene, pentaphene, hexaphene, heptaphene, octaphene and the like. Preferable examples of the phenylene skeleton include phenalene, perylene, fluoranthene, coronene, ovalene and the like. Preferable examples of the fluorene skeleton include fluorene, dibenzofuran, dibenzothiophene, carbazole and the like.

Among the aforementioned skeletons, in view of carrier mobility, particularly, the acene skeleton or the phenylene skeleton in which benzene rings are linearly bound is preferable. Examples of the acene skeleton include naphthalene, anthracene, tetracene (naphthacene), pentacene, hexacene, heptacene, octacene and the like. In addition, examples of the phenylene skeleton include phenalene, perylene, coronene, ovalene and the like.

Examples of the fused polycyclic hydrocarbon compound which can derive an organic group T include compounds represented by the following general formula (I) to (IX). That is, the organic group T may be an organic group derived from the fused polycyclic hydrocarbon compound which is each independently selected from the group consisting of such the compounds.

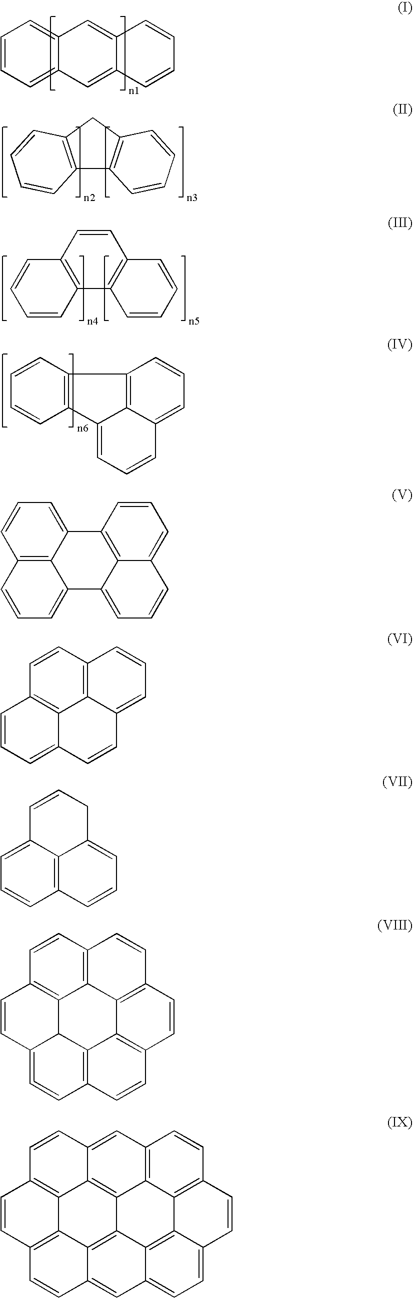

In the formula (I), n¹ is an integer of 0 to 10, preferably 0 to 8, more preferably 0 to 4.

In the formula (II), n² and n³ are integers of 0 or more, respectively, a sum of which is 1 to 9, preferably 2 to 6. And, n² and n³ represent the number of fused benzene rings which extend in a left lower direction and a right lower direction in the above general formula, respectively.

In the formula (III), n⁴ and n⁵ are integers of 1 or more, respectively, a sum of which is 2 to 9, preferably 2 to 6. And, n⁴ and n⁵ represent the number of fused benzene rings which extend in a left lower direction and a right lower direction in the above general formula, respectively.

In the formula (IV), n⁶ is an integer of 0 to 7, preferably 2 to 6. And, n⁶ represents the number of fused benzene rings which extend in a right direction in the above general formula.

In the formula (X), it is preferable that Y is an atom selected from carbon, nitrogen, oxygen and sulfur atoms, or an organic residue containing any of these atoms.

Examples of the fused polycyclic hydrocarbon compound represented by the general formula (I) include the following compounds.

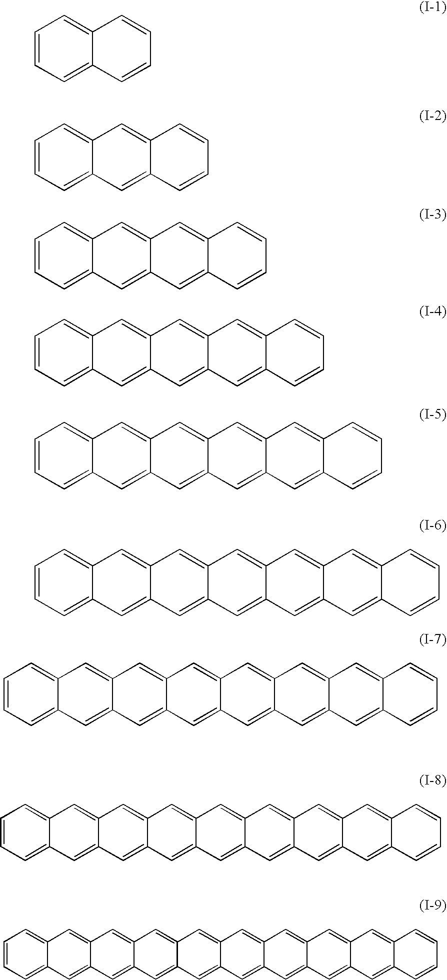

Examples of the fused polycyclic hydrocarbon compound represented by the general formula (II) include the following compounds.

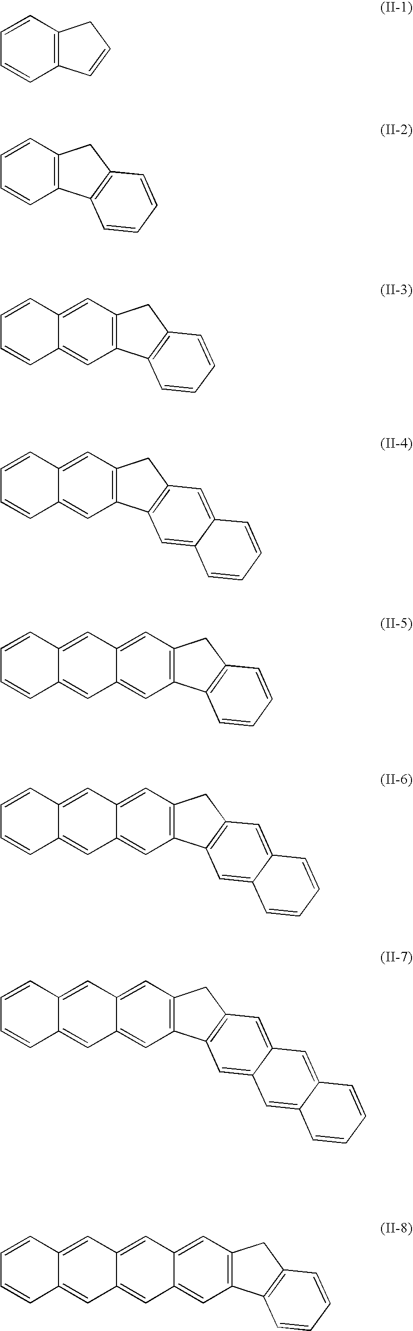

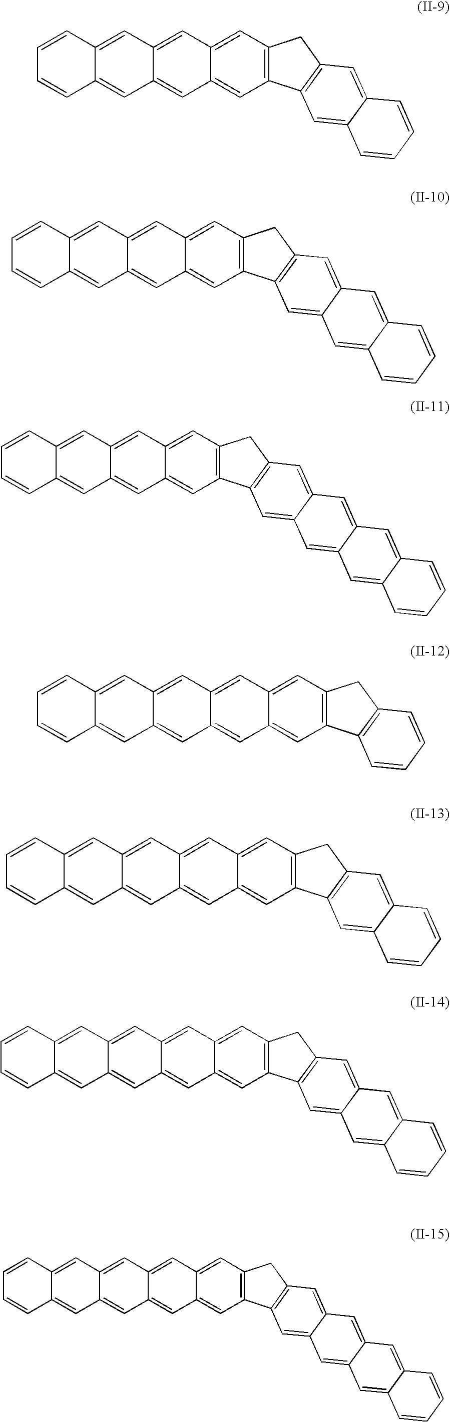

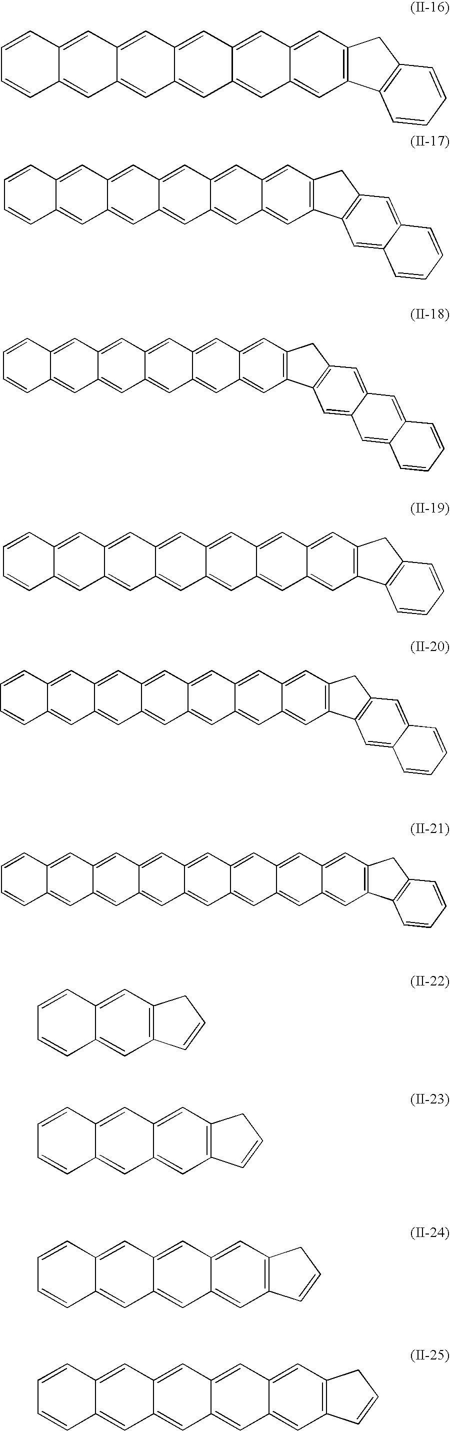

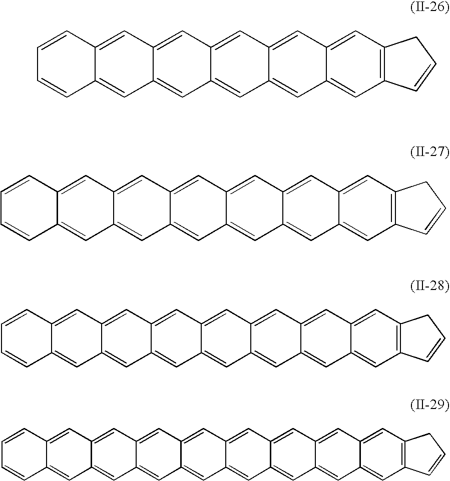

Examples of the fused polycyclic hydrocarbon compound represented by the general formula (III) include the following compounds.

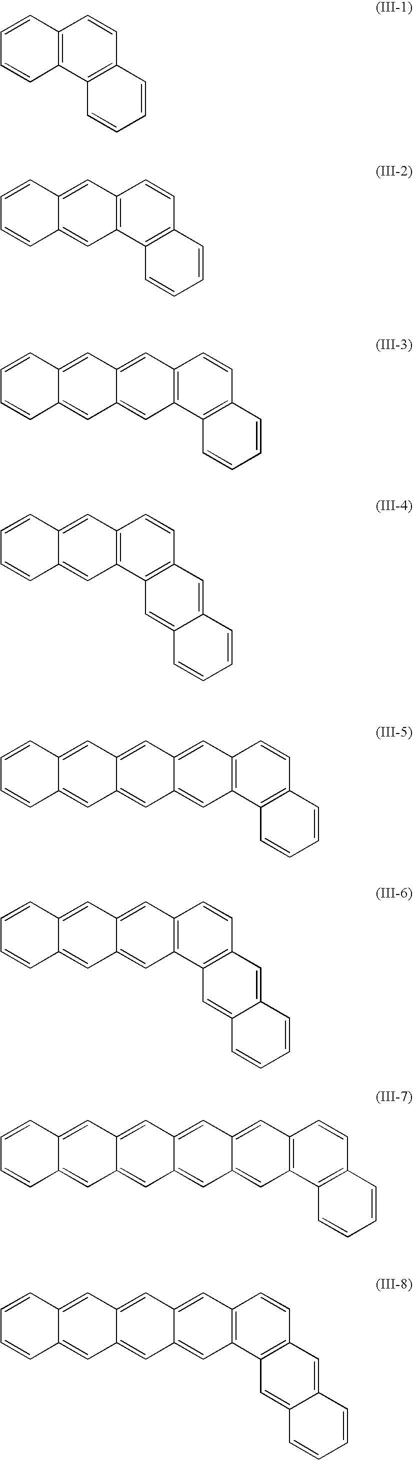

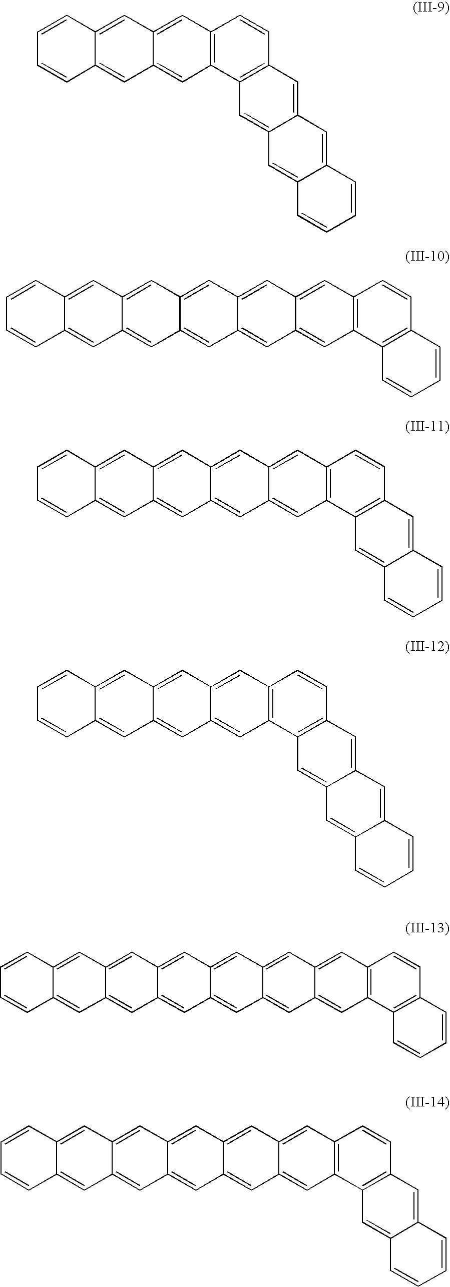

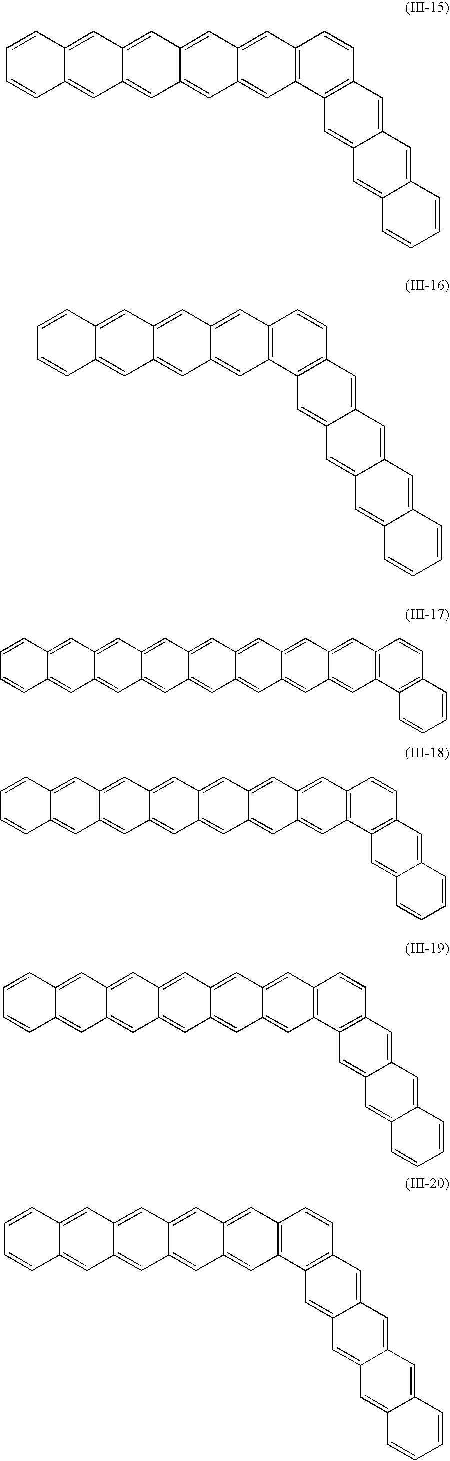

Examples of the fused polycyclic hydrocarbon compound represented by the general formula (IV) include the following compounds.

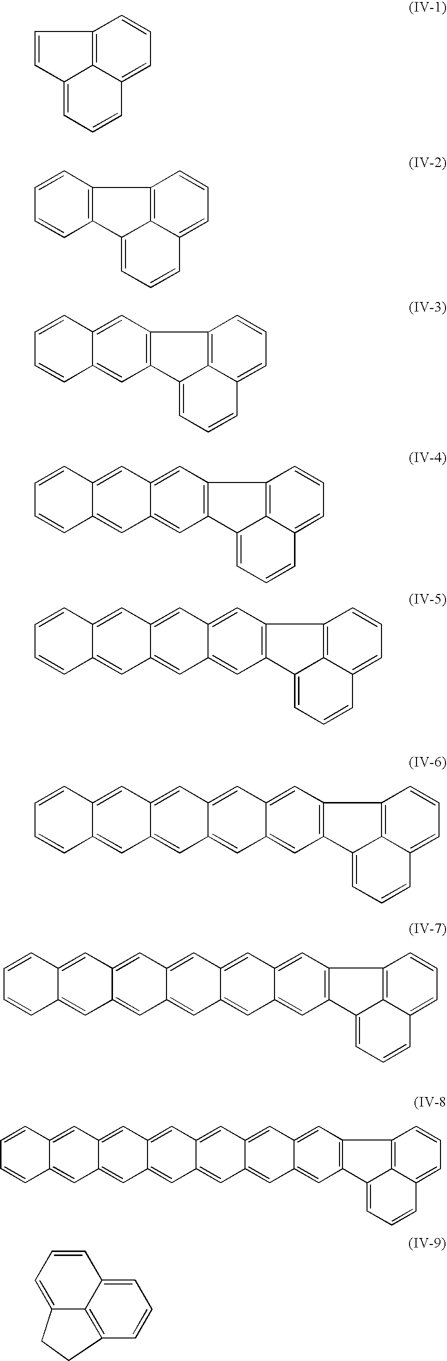

In the formula (a), k, when it is 2 or more, represents the number of organic groups T which are bound with a single bond. And, k is not particularly limited as far as it is an integer of 1 or more and, in view of a yield, k is an integer of 1 to 10, particularly preferably 1 to 5.

When k is 2 or more, positions of two hydrogen atoms which are removed for deriving the fused polycyclic hydrocarbon compound into a divalent organic group T, that is, positions of binding with other groups in the organic group T are not particularly limited, but when a compound molecule is generally linear, they are preferably both ends of the molecule. In addition, for example, when the compound molecule has linear symmetry, positions of binding such that a line binding two binding positions passes through an intermediate point of a central line as a standard of linear symmetry are preferable. In addition, for example, when the compound molecule has point symmetry, positions of binding such that a line binding two binding positions passes through a central point as a standard of point symmetry are preferable.

All organic groups T may be the same, or a part or all of them may be different.

In the present invention, it is preferable that the organic group T is a group derived from compounds represented by the general formulas (I) to (V).

In the formula (a), at least one group of X¹ to X³ possessed by the silyl group is the group which gives the hydroxy group by hydrolysis, or the halogen atom, and other groups are the group which does not react with the adjacent molecule. Firm bond (chemical bond) between the compound and a layer in which a layer containing the compound is formed is obtained, and durability of the resulting layer can be improved, because the silyl group has one or more of the group which gives the hydroxy group by hydrolysis or the halogen atom like this.

Examples of the group which gives the hydroxy group by hydrolysis include an alkoxy group of a carbon number of 1 to 4, preferably 1 to 3, particularly 1 to 2, and a linear alkoxy group is preferable. Examples include a methoxy group, an ethoxy group, a n-propoxy group, a 2-propoxy group, a n-butoxy group, a sec-butoxy group, a tert-butoxy group and the like. A part of hydrogens of the alkoxy group may be further substituted with another substituent, for example, a trialkylsilyl group (a carbon number of an alkyl group is 1 to 4), an alkoxy group (carbon number of 1 to 4) or the like.

Examples of the halogen atom include a fluorine atom, a chlorine atom, an iodine atom, a bromine atom and the like and, in view of reactivity, a chlorine atom is preferable.

When the silyl group has 2 or more groups which give the hydroxy group by hydrolysis, a part or all of those groups may be the same or different.

Examples of the group being not reactive with the adjacent molecule, which may be possessed by the silyl group include a substituted or unsubstituted alkyl group, a cycloalkyl group, an aryl group, a diarylamino group, a di- or triarylalkyl group and the like. Preferable is a substituted or unsubstituted alkyl group. From a viewpoint of reduction in intermolecular interaction, as the group which does not react with the adjacent molecule, when it is used in the organic EL device, a group having a relatively great molecular volume in such a range that a layer containing the group which gives the hydroxy group by hydrolysis and an organic silane compound does not inhibit binding with a layer to be formed on a surface is preferable, and a group which extends radially is more preferable. This is because when intermolecular interaction between adjacent molecules is reduced, when formulated into the organic thin film, the thin film becomes amorphous, and a light emitting efficiency of the organic EL device is further improved.

The alkyl group of a carbon number of 1 to 10 is preferable, particularly, 1 to 4 is preferable, and a branched alkyl group is more preferable. Examples include a methyl group, an ethyl group, a n-propyl group and a sec-propyl group, a n-butyl group, a sec-butyl group, a tert-butyl group, a pentyl group, a hexyl group, a heptyl group, an octyl group, a nonyl group, a decyl group and the like. Examples of the alkyl group of a carbon number of 1 to 4 include a methyl group, an ethyl group, a n-propyl group and a sec-propyl group, a n-butyl group, a sec-butyl group, and a tert-butyl group.

The cycloalkyl group of a carbon number of 4 to 8 is preferable, particularly 5 to 7 is preferable, and examples include a cyclopentyl group, a cyclohexyl group, and a cycloheptyl group.

It is preferable that the aryl group is a group composed of 1 to 3 aromatic groups of a carbon number of 5 to 18, particularly a carbon number of 6. As a hetero atom, a sulfur atom may be contained. In addition, the aryl group may have at least one alkyl group of a carbon number of 1 to 4 at any of an o-position, a m-position and a p-position. Examples of the alkyl group of a carbon number of 1 to 4 include a methyl group, an ethyl group, a propyl group, a sec-propyl group, a butyl group, a sec-butyl group, and a tert-butyl group. Examples of the aryl group include a phenyl group, a biphenylyl group, a naphthyl group, a terphenylyl group, a p-(tert-butyl)phenyl group, a m-diethylphenyl group, a p-propylbiphenylyl group and the like. Terphenylyl is a residue obtained by removing one hydrogen atom from terphenyl.

The diarylamino group is an amino group in which two hydrogen atoms are substituted with an aryl group, and an aryl group to be contained is the same as that describe above. Examples of the diarylamino group include a N,N-diphenylamino group, a N,N-di(biphenylyl)amino group, a N,N-di(terphenylyl)amino group, a N-phenyl N-biphenylylamino group, a N-phenyl N-terphenylylamino group, a N-biphenylyl N-tertphenylylamino group, a N,N-binaphthylamino group, a N-phenyl N-naphthylamino group, a N-biphenylyl N-naphthylamino group, a N-terphenylyl N-naphthylamino group, a N-methylphenyl-N-biphenylylamino group a N-methylphenyl-N-naphthylamino group, a N-methylphenyl-N-phenylamino group, a N,N-di(methylphenyl)amino group and the like.

The di- or triarylalkyl group is preferably a linear alkyl group of a carbon number of 1 to 4 in which 2 or 3 hydrogen atoms are substituted with an aryl group, and an aryl group to be contained is the same as that described above. Examples of the linear alkyl group of a carbon number of 1 to 4 include a methyl group, an ethyl group, a n-propyl group, and a n-butyl group, any part of these groups may have an aryl group and, in view of the steric effect, it is preferable that the aryl group is possessed at an end. Examples of the dialylalkyl group include a diphenylmethyl group, a di(biphenylyl)methyl group, a di(terphenylyl)methyl group, a phenylbiphenylylmethyl group, a phenylterphenylylmethyl group, a biphenylylterphenylylmethyl group, a dinaplhthylmethyl group, a phenylnaphthylmethyl group, a biphenylylnaphthylmethyl group, a terphenylylnaphthylmethyl group, a methylphenyl-biphenylylmethyl group, a methylphenyl-naphthylmethyl group, a methylphenyl-phenylmethyl group, a di(methylphenyl)methyl group, a diphenylethyl group, a di(biphenylyl)ethyl group, a di(terphenylyl)ethyl group, a phenylbiphenylylethyl group, a phenylterphenylylethyl group, a biphenylylterphenylylethyl group, a dinaphthylethyl group, a phenylnaphthylethyl group, a biphenylylnaphthylethyl group, a terphenylylnaphthylethyl group, a methylphenyl-biphenylylethyl group, a methylphenyl-naphthylethyl group, a methylphenyl-phenylethyl group, a di(methylphenyl)ethyl group, a diphenylpropyl group, a di(biphenylyl)propyl group, a di(terphenylyl)propyl group, a phenylbiphenylylpropyl group, a phenylterphenylylpropyl group, a biphenylylterphenylylpropyl group, a dinaphthylpropyl group, a phenylnaphthylpropyl group, a biphenylylnaphthylpropyl group, a terphenylylnaphthylpropyl group, a methylphenyl-biphenylylpropyl group, a methylphenyl-naphthylpropyl group, a methylphenyl-phenylpropyl group, a di(methylphenyl)propyl group, a diphenylbutyl group, a di(biphenylyl)butyl group, a di(terphenylyl)butyl group, a phenylbiphenylylbutyl group, a phenylterphenylylbutyl group, a biphenylylterphenylylbutyl group, a dinaphthylbutyl group, a phenylnaphthylbutyl group, a biphenylylnaphthylbutyl group, a terphenylylnaphthylbutyl group, a methylphenyl-biphenylylbutyl group, a methylphenyl-naphthylbutyl group, a methylphenyl-phenylbutyl group, a di(methylphenyl)butyl group and the like.

Examples of the triarylalkyl group include a trimethylmethyl group, a triphenylmethyl group, a tri(biphenylyl)methyl group, a tri(terphenylyl)methyl group, a phenyl-di(biphenylyl)methyl group, a di(phenyl)terphenylylmethyl group, a phenyldi(terphenylyl)methyl group, a trinaphthylmethyl group, a phenyldi(naphthyl)methyl group, a di(phenyl)naphthylmethyl group, a di(terphenylyl)naphthylmethyl group, a methylphenyl-di(phenyl)methyl group, a methylphenyl-di(naphthyl)methyl group, a methylphenyl-di(biphenylyl)methyl group, a tri(methylphenyl)methyl group, a triphenylethyl group, a tri(biphenylyl)ethyl group, a tri(terphenylyl)ethyl group, a phenyl-di(biphenylyl)ethyl group, a di(phenyl)terphenylylethyl group, a phenyldi(terphenylyl)ethyl group, a trinaphthylethyl group, a phenyldi(naphthyl)ethyl group, a di(phenyl)naphthylethyl group, a di(terphenylyl)naphthylethyl group, a methylphenyl-di(phenyl)ethyl group, a methylphenyl-di(naphthyl)ethyl group, a methylphenyl-di(biphenylyl)ethyl group, a tri(methylphenyl)ethyl group and the like.

When the silyl group has two aforementioned groups which do not react with the adjacent molecule, those groups may be the same or different.

Examples of the compound in which k is 2 or more are as follows.

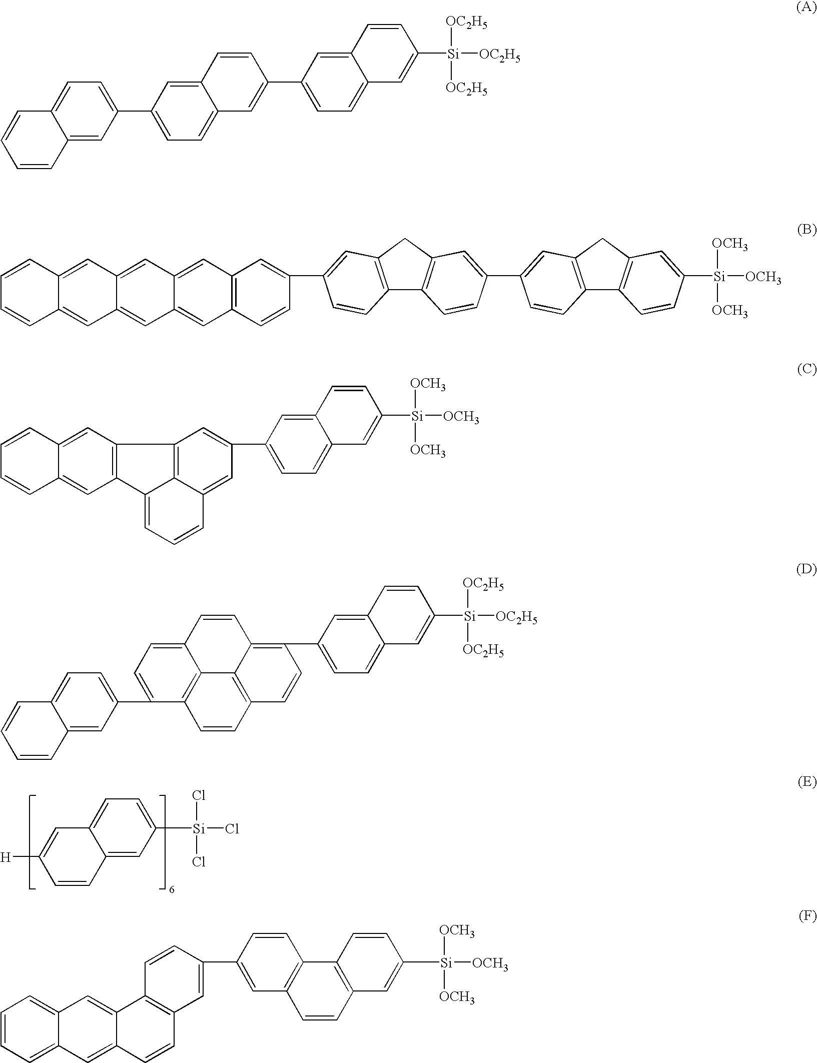

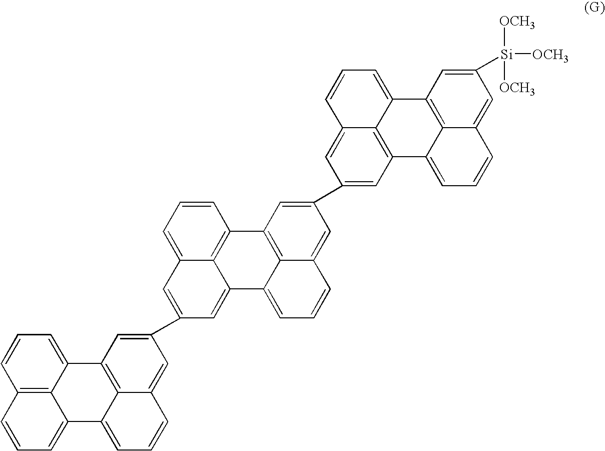

The organic silane compound of the present invention may have a functional group. The organic group may be made to have action of improving solubility in an organic solvent; action of reducing intermolecular interaction at formation of an organic thin film to form an amorphous film, action of attaining unstabilization at a HOMO level of a compound, or stabilization at a LUMO level, and action of improving intermolecular interaction at formation of the organic thin film to form a crystalline film.

Thereupon, it is preferable that the functional group is a group which does not react with the adjacent molecule from a viewpoint of reaction control.

(1) From a viewpoint of action of improving solubility in the organic solvent, it is preferable that the functional group has hydrophobicity.
(2) From a viewpoint of action of forming the amorphous film, it is preferable that the functional group has a great molecular volume of the group, and is bound to a position other than in a long axis direction of the π electron conjugation system molecule.
(3) From a viewpoint of action of attaining unstabilization at the HOMO level of a compound or stabilization at the LUMO level, it is preferable that the functional group is a group having electron donating property or electronattracting property.
(4) From a viewpoint of action of forming the crystalline film, the functional group which is bound to a position in a long axis direction of the organic group is preferable.

(2) and (3) are requirements which are desired in the functional group of the organic EL device, and (1) is requirement which is desired in organic TFT.

It is most preferable that the functional group satisfies conditions of (1) to (3) or (1) and (4), but the functional group is not limited to a group having hydrophobicity. When the functional group has electronattracting property, the electronattracting group is hydrophilic in many cases, and this is because even the compound (electron transporting substance) of the present invention having such the electronattracting group having hydrophilicity as a functional group can sufficiently maintain solubility in the organic solvent.

### Viewpoint of (1)

Examples of the functional group (hydrophobic group) which is introduced for improving solubility in a non-aqueous solvent, or improving surfactant activity of a molecule include an alkyl group, an oxyalkyl group, a fluoroalkyl group, a fluoro group and the like. A plurality of them may be bound in a branch manner. Particularly, a linear hydrocarbon group of a carbon number of 1 to 30 is preferable. In addition, a carbon number is preferably in a range of 1 to 30, further particularly preferably a carbon number of 1 to 8. In addition, in a range of a carbon number of 1 to 5, the group may be branched hydrocarbon. Examples of the linear hydrocarbon group include a methyl group, an ethyl group, a (linear or branched) propyl group, a (linear or branched) butyl group, a (linear or branched)pentyl group, a hexyl group, a heptyl group, an octyl group and the like.

In addition, a binding position of the functional group binding with the organic group in this viewpoint is not particularly limited. The number of the functional group for improving solubility is not particularly limited, but can be appropriately determined in view of solubility in the non-aqueous solvent. Specifically, one or two or more may be present.

### Viewpoint of (2) and (3)

Examples of the functional group include an alkyl group, an unsaturated alicyclic hydrocarbon group, a cycloalkyl group, an aryl group, an amino group, an alkoxy group, a nitrile group, a nitro group, an ester group, and an oxyaryl group, each being substituted or unsubstituted. A substituted or unsubstituted alkyl group, or a cycloalkyl group may be further bound to these groups via an ether bond, an ester bond or the like. Examples of a substituent of the functional group include a halogen atom (fluorine atom, chlorine atom, bromine atom, iodine atom), an alkyl group, and an alkyl group.

Preferable examples of the functional group include an unsubstituted alkyl group, a halogenated alkyl group, a di- or triarylalkyl group, an oxyalkyl group, a cycloalkyl group, an aryl group, a diarylamino group, an alkoxy group, a nitrile group, a nitro group, an ester group and the like. Among these functional groups, the organic silane compound having an electron donating group such as an alkyl group, a di- or triarylalkyl group, an oxyalkyl group, a cycloalkyl group, an aryl group, an alkoxy group and the like can be effectively used, for example, as an electron transporting substance of the organic EL device. In addition, the organic silane compound having an electronattracting group such as a halogenated alkyl group, a nitrile group, a nitro group, an ester group and the like can be effectively used, for example, as a hole transporting substance of the organic EL device. When the organic silane compound has 2 or more functional groups, from a viewpoint electrical conductivity, it is preferable that all functional groups are selected from the group consisting of one of an electron donating group and an electronattracting group. From a viewpoint of a size of a molecular volume, a more preferable functional group is an alkyl group, a diarylamino group, or a di- or triarylalkyl group. In addition, in view of stability of the functional group, a nitrile group or a nitro group is more preferable.

Examples of the unsubstituted alkyl group include a methyl group, an ethyl group, a n- or sec-propyl group, a n-, sec- or tert-butyl group, a pentyl group, a hexyl group, a heptyl group, an octyl group, a nonyl group, a decyl group, an undecyl group, a dodecyl group, a tridecyl group, a tetradecyl group, a pentadecyl group, a hexadecyl group, a heptadecyl group, an octadecyl group, a nonadecyl group, an eicosyl group, a heneicosyl group, a docosyl group, a tricosyl group, a tetracosyl group, a pentacosyl group, a hexacosyl group, a heptacosyl group, an octacosyl group, a nonacosyl group and a triacontyl group.

Examples of the substituted alkyl group include a halogenated alkyl group to which a halogen atom is bound, a diarylalkyl group to which two aryl groups are bound, and a triarylalkyl group to which three aryl groups are bound.

The halogenated alkyl group of a carbon number of 1 to 10 is preferable, particularly 1 to 4 is preferable, and examples include a monochloroethyl group, a trifluoroethyl group, a trichloroethyl group and the like.

Examples of the diarylalkyl group include a diphenylmethyl group, a di(biphenylyl)methyl group, a di(terphenylyl)methyl group, a phenylbiphenylylmethyl group, a phenylterphenylylmethyl group, a biphenylylterphenylylmethyl group, a dinaphthylmethyl group, a phenylnaphthylmethyl group, a biphenylylnaphthylmethyl group, a terphenylylnaphthylmethyl group, a methylphenyl-biphenylylmethyl group, a methylphenyl-naphthylmethyl group, a methylphenyl-phenylmethyl group, a di(methylphenyl)methyl group, a diphenylethyl group, a di(biphenylyl)ethyl group, a di(terphenylyl)ethyl group, a phenylbiphenylylethyl group, a phenylterphenylylethyl group, a biphenylylterphenylylethyl group, a dinaphthylethyl group, a phenylnaphthylethyl group, a biphenylylnaphthylethyl group, a terphenylylnaphthylethyl group, a methylphenyl-biphenylylethyl group, a methylphenyl-naphthylethyl group, a methylphenyl-phenylethyl group, a di(methylphenyl)ethyl group, a diphenylpropyl group, a di(biphenylyl)propyl group, a di(terphenylyl)propyl group, a phenylbiphenylylpropyl group, a phenylterphenylylpropyl group, a biphenylylterphenylylpropyl group, a dinaphthylpropyl group, a phenylnaphthylpropyl group, a biphenylylnaphthylpropyl group, a terphenylylnaphthypropyl group, a methylphenyl-biphenylylpropyl group, a methylphenyl-naphthylpropyl group, a methylphenyl-phenylpropyl group, a di(methylphenyl)propyl group, a diphenylbutyl group, a di(biphenylyl)butyl group, a di(terphenylyl)butyl group, a phenylbiphenylylbutyl group, a phenylterphenylylbutyl group, a biphenylylterphenylylbutyl group, a dinaphthylbutyl group, a phenylnaphthyl butyl group, a biphenylylnaphthylbutyl group, a terphenylylnaphthylbutyl group, a methylphenyl-biphenylylbutyl group, a methylphenyl-naphthylbutyl group, a methylphenyl-phenylbutyl group, a di(methylphenyl)butyl group and the like.

Examples of the triarylalkyl group include a trimethylmethyl group, a triphenylmethyl group, a tri(biphenylyl)methyl group, a tri(terphenylyl)methyl group, a phenyl-di(biphenylyl)methyl group, a di(phenyl)terphenylylmethyl group, a phenyldi(terphenylyl)methyl group, a trinaphthylmethyl group, a phenyldi(naphthyl)methyl group, a di(phenyl)naphthylmethyl group, a di(terphenylyl)naphthylmethyl group, a methylphenyl-di(phenyl)methyl group, a methylphenyl-di(naphthyl)methyl group, a methylphenyl-di(biphenylyl)methyl group, a tri(methylphenyl)methyl group, a triphenylethyl group, a tri(biphenylyl)ethyl group, a tri(terphenylyl)ethyl group, a phenyl-di(biphenylyl)ethyl group, a di(phenyl)terphenylylethyl group, a phenyldi(terphenylyl)ethyl group, a trinaphthylethyl group, a phenyldi(naphthyl)ethyl group, a di(phenyl)naphthylethyl group, a di(terphenylyl)naphthylethyl group, a methylphenyl-di(phenyl)ethyl group, a methylphenyl-di(naphthyl)ethyl group, a methylphenyl-di(biphenylyl)ethyl group, a tri(methylphenyl)ethyl group and the like.

Examples of the unsaturated alicyclic hydrocarbon group include a compound in which any carbon-carbon bond of the substituted or unsubstituted alkyl group is unsaturated.

The unsaturated cycloalyl group of a carbon number of 4 to 8 is preferable, particularly 5 to 7 is preferable, and examples include a cyclopentyl group, a cyclohexyl group, and a cycloheptyl group. Examples of the substituted cycloalkyl group include a group in which a halogen atom, an alkyl group, an aryl group or the like is bound to an arbitrary position of an unsaturated cycloalkyl group.

It is preferable that the unsaturated aryl group is a group composed of 1 to 3 aromatic rings of a carbon number of 5 to 18, particularly a carbon number of 6. As a hetero atom, a sulfur atom may be contained. In addition, the substituted aryl group may have at least one alkyl group of a carbon number of 1 to 4 at any of an o-position, a m-position and a p-position. Examples of the alkyl group of a carbon number of 1 to 4 include a methyl group, an ethyl group, a propyl group, a sec-propyl group, a butyl group, a sec-butyl group, and a tert-butyl group. Examples of the aryl group include an unsaturated aryl group such as a phenyl group, a biphenylyl group, a naphthyl group, terphenylyl and the like, and a substituted aryl group such as a p-(tert-butyl)phenyl group, a m-diethylphenyl group, a p-propylbiphenylyl group.

Examples of the amino group include, in addition to an unsubstituted amino group, a substituted amino group such as a N,N-diphenylamino group, a N,N-di(biphenylyl)amino group, a N,N-di(terphenylyl)amino group, a N-phenyl N-biphenylylamino group, a N-phenyl N-terphenylylamino group, a N-biphenylyl N-terphenylylamino group, a N,N-dinaphthyl amino group, a N-phenyl N-naphthylamino group, a N-biphenylyl N-naphthylamino group, a N-terphenylyl N-naphthylamino group, a N-methylphenyl-N-biphenylylamino group, a N-methylphenyl-N-naphthylamino group, a N-methylphenyl-N-phenylamino group, a N,N-di(methylphenyl)amino group and the like.

The alkoxy group of a carbon number of 1 to 6 is preferable, particularly 3 to 4 is preferable, and the alkoxy group may be either linear or branched, more preferably branched. Preferable examples include a 2-propyloxy group, a sec-butyloxy group, a tert-butyloxy group and the like.

The ester group is a group represented by —COOR′ or —OCOR′ (R′ is an alkyl group or an aryl group, and they are the same as the alkyl group or the aryl group as the “group which does not react with the adjacent molecule”, respectively). Examples include —COOCH₃, —COOCH₂CH₃, —COO(CH₂)₂CH₃, —COOCH(CH₄)₂, —COO(CH₂)₃CH₃, —COOCH(CH₃)CH₂CH₃, —COOC(CH₃)₃, —COOPh, —COO(Ph)₂, —COO(Ph)₃, —OCOCH₃, —OCOCH₂CH₃, —OCO(CH₂)₂CH₃, —OCOCH(CH₃)₂, —OCO(CH₂)₃CH₃, —OCOCH(CH₃)CH₂CH₃, —OCOC(CH₃)₃, —OCOPh, —OCO(Ph)₂, —OCO(Ph)₃ (Ph is phenyl group) and the like.

The oxyaryl group is a group in which a hydrogen atom of a hydroxy group is substituted with an aryl group, and an aryl group to be contained is the same as that described above. Examples of the oxyaryl group include a phenyloxy group, a biphenylyloxy group, a naphthyloxy group and the like.

Examples of the fused polycyclic hydrocarbon compound substituted with a specific functional group include:

alkyl, cycloalkyl, aryl or aminonaphthalene,

alkyl, cycloalkyl, aryl or aminoanthracene,

alkyl, cycloalkyl, aryl or aminotetracene,

alkyl, cycloalkyl, aryl or aminopentacene,

alkyl, cycloalkyl, aryl or aminohexacene,

alkyl, cycloalkyl, aryl or aminoheptacene,

alkyl, cycloalkyl, aryl or aminooctacene,

alkyl, cycloalkyl, aryl or aminoacenaphthene,

alkyl, cycloalkyl, aryl or aminophenalene,

alkyl, cycloalkyl, aryl or aminoperylene,

alkyl, cycloalkyl, aryl or aminofluoranthene,

alkyl, cycloalkyl, aryl or aminocoronene,

alkyl, cycloalkyl, aryl or aminoovalene,

alkyl, cycloalkyl, aryl or aminofluorene,

alkyl, cycloalkyl, aryl or aminodibenzofuran,

alkyl, cycloalkyl, aryl or aminodibenzothiophene,

alkyl, cycloalkyl, aryl or aminocarbazole,

alkyl, cycloalkyl, aryl or aminophenanthrene,

alkyl, cycloalkyl, aryl or aminochrysene,

alkyl, cycloalkyl, aryl or aminotetraphene,

alkyl, cycloalkyl, aryl or aminopentaphene,

alkyl, cycloalkyl, aryl or aminohexaphene,

alkyl, cycloalkyl, aryl or aminoheptaphene,

alkyl, cycloalkyl, aryl or aminooctaphene and the like.

In addition, it is preferable that a position of the functional group binding to the fused polycyclic hydrocarbon compound in this viewpoint is a position other than in a long axis direction of this compound. In addition, as far as the functional group is bound to the position than in the long axis direction, the group may be bound in the long axis direction. The number of functional groups in this viewpoint is not particularly limited, but can be appropriately determined in view of a molecular volume of the functional group. Specifically, one or two or more may be present.

### Viewpoint of (4)

When used in organic TFT, the functional group is preferably a substituted or unsubstituted linear alkyl group, among the group, an alkyl group of a carbon number of 1 to 30 is more preferable, and an alkyl group of a carbon number of 1 to 4 or 12 to 30 is further preferable. A hydrophobic group of a carbon number of 1 to 4 is preferable because the functional group itself has not crystallizability, but has little influence on reduction in orienting property of the resulting film. In addition, the functional group of a carbon number of 12 to 30 itself has intermolecular orienting property, and can pack the resulting film firm, being preferable.

Examples of a particularly preferable functional group for organic TFT include a methyl group, an ethyl group, a propyl group, a butyl group, a pentyl group, a hexyl group, a heptyl group, an octyl group, a nonyl group, a decyl group, an undecyl group, a dodecyl group, a tridecyl group, a tetradecyl group, a pentadecyl group, a hexadecyl group, a heptadecyl group, an octadecyl group, a nonadecyl group, an eicosyl group, a heneicosyl group, a docosyl group, a tricosyl group, a tetracosyl group, a pentacosyl group, a hexacosyl group, a heptacosyl group, an octacosyl group, a nonacosyl group and a triacontyl group, and one or more hydrogen atoms of these hydrophobic groups may be substituted with a halogen atom.

In addition, it is preferable that a position of the functional group binding to the fused polycyclic hydrocarbon compound in this viewpoint is a position in the long axis direction of this compound. In addition, it is preferable that the functional group is not bound to a position other than a position in the long axis direction. The number of functional groups in this viewpoint is not particularly limited, but can be appropriately determined in view of orienting property of the functional group. Specifically, one or two or more may be present.

### (Process of Production)

The organic compound (a) of the present invention can be produced by Subjecting to the Grignard reaction of a compound represented by the general formula (b);

(T)ₖ-MgL¹ (b)

wherein T and k are as defined in the general formula (a); L¹ is a halogen atom, with a compound represented by the general formula (c);

L2-SiX¹X²X³ (c)

wherein L2 is a hydrogen atom, a halogen atom or an alkoxy group of a carbon number of 1 to 4; X¹ to X³ are as defined in the general formula (a), respectively.

A reaction temperature is, for example, preferably −100 to 150° C., more preferably −20 to 100° C. A reaction time is, for example, around 0.1 to 48 hours. The reaction is usually performed in an organic solvent having no influence on the reaction. Examples of the organic solvent having no adverse influence on the reaction include aliphatic or aromatic hydrocarbons such as hexane, pentane, benzene, toluene and the like, ether solvents such as diethyl ether, dipropyl ether, dioxane, tetrahydrofuran (THF) and the like, and halogenated hydrocarbons such as carbon tetrachloride, methylene chloride and the like, these may be used alone or as a mixed solution. Among them, diethyl ether, THF and carbon tetrachloride are preferable. In the reaction, a catalyst may be arbitrarily used. As the catalyst, the known catalyst such as a platinum catalyst, a palladium catalyst, a nickel catalyst and the like can be used.

The thus obtained organic silane compound (a) can be isolated or purified from the reaction solution by the known means, for example, elution, concentration, solvent extraction, fractionation, crystallization, recrystallization, chromatography or the like.

The compound represented by the general formula (b) (hereinafter, referred to as compound (b); Grignard reagent) can be obtained by reacting a compound represented by the general formula (b-1);

(T)ₖ-L¹ (b-1)

wherein T, k and L¹ are as defined in the general formula (b), respectively, with a metal magnesium in the same organic solvent as that described above.

The compound (b-1) can be obtained by halogenating a compound represented by the general formula (b-2);

(T)ₖ-H (b-2)

wherein T and k are as defined in the general formula (b), respectively, at a prescribed position using N-chlorosuccinimide (NCS), N-bromosuccinimide (NBS) or the like in a solvent such as carbon tetrachloride and the like.

The compound (b-2) can be obtained by linking the fused polycyclic hydrocarbon compound inducing T by a Grignard reaction. For example, a compound represented by the general formula (b-3);

Ta-Tb-H (b-3)

wherein Ta and Tb are the same as T in the general formula (b), and may be the same or different, can be obtained by preparing a Grignard reagent using one of a compound represented by the general formula (b-4) and a compound represented by the general formula (b-5), and reacting the Grignard reagent and a halide of other compound.

Ta-H (b-4)

wherein Ta is as defined in the general formula (b-3),

Tb-1H (b-5)

wherein Tb is as defined in the general formula (b-1).

For example, when Grignard is prepared using the compound (b-4), generally, a prescribed position of the compound is halogenated, and a metal such as magnesium and the like is acted on the halogen atom to prepare a Grignard reagent. The Grignard reagent may be reacted with a halide of the compound (b-5). In this case, particularly, when a Grignard reagent prepared by dihalogenating both ends of the compound (b-4) and acting a metal such as magnesium and the like on both halogen atoms, is reacted with a monohalide of the compound (b-5), a compound corresponding to the compound (b) can be obtained.

By appropriately repeating the aforementioned Grignard reaction using newly a desired fused polycyclic hydrocarbon compound, a compound (b-2) in which k is 3 or more can be obtained.

The fused polycyclic hydrocarbon compound corresponding to the compound (b-4) and the compound (b-5), and a halide thereof may be obtained as a commercially available product, or may be synthesized.

For example, 2-bromonaphthalene is the known substance registered as CAS.No. 90-11-9, and can be obtained as a commercially available product.

In addition, for example, 2,7-dibromofluorene is the known substance registered as CAS.No. 16433-88-8, and can be obtained as a commercially available product.

In addition, for example, 2-bromofluorene is the known substance registered as CAS.No. 1133-80-8, and can be obtained as a commercially available product.

In addition, for example, benzo[k]fluoranthene is the known substance registered as CAS.No. 207-08-9, and can be obtained as a commercially available product.

In addition, for example, 1-bromopyrene is the known substance registered as CAS.No. 1714-29-0, and can be obtained as a commercially available product.

In addition, for example, perylene is the known substance registered as CAS.No. 198-55-0, and can be obtained as a commercially available product having a purity of 99% from Kishida Chemical Co., Ltd.

In addition, for example, 1-benzanthracene is the known substance registered as CAS.No. 56-55-3, and can be obtained as a commercially available product.

In addition, for example, phenanthrene is the known substance registered as CAS.No. 85-01-8, and can be obtained as a commercially available product.

In addition, for example, tetracene can be obtained at a purity of 97% or higher from Tokyo Kasei Kogyo Co., Ltd.

More specific process of production is described below.

The fused polycyclic hydrocarbon compound can be obtained as a commercially available product, but can be synthesized, for example, by (A) a procedure of inserting a triflate group into a prescribed position of a raw material, reacting this with a furan derivative and, subsequently, oxidizing it (see route A1-A5), and (B) a route of adding an acetylene derivative to a prescribed position of a raw material, and ring-closing reacting acetylene groups (see route B1-BS). Particularly, when the procedure (A) is adopted, by introducing the functional group into a furan derivative or the raw material in advance, the fused polycyclic hydrocarbon compound can be synthesized and, at the same time, the functional group can be introduced into this compound (see route A1-A5). In addition, when the procedure (B) is adopted, by introducing the functional group into the raw material in advance, the fused polycyclic hydrocarbon compound can be synthesized and, at the same time, the functional group can be introduced into this compound (see route B1). One example of a route of synthesizing the fused polycyclic hydrocarbon compound using these procedures is shown below.

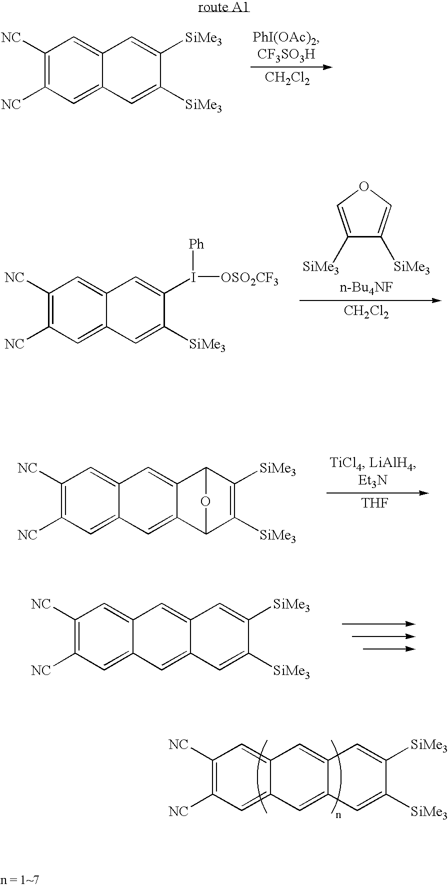

In addition, the method (1) is a method of increasing a benzene ring of the acene skeleton one by one. Therefor, for example, even when the functional group having small reactivity or a protecting group is contained in a prescribed part of a raw material compound, the organic silane compound can be synthesized similarly. An example of this case is shown below.

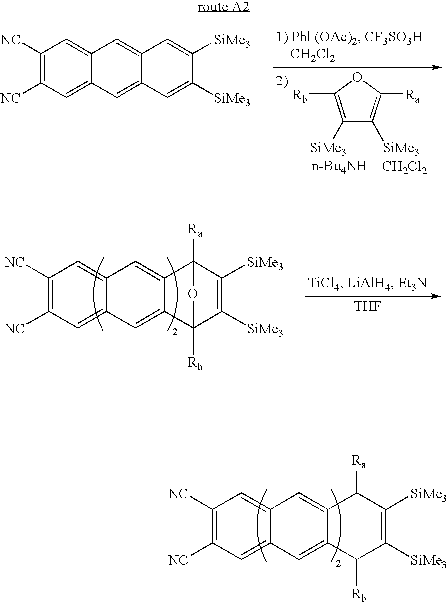

In addition, it is preferable that Rₐ or R_{b} is the functional group having small reactivity such as a hydrocarbon group and an ether group, or a protecting group.

Alternatively, in the reaction formula of the method (2), a starting compound having two acetonitrile groups and trimethylsilyl groups may be changed to a compound in which these groups are all a trimethylsilyl group. In addition, in the reaction formula, after a reaction using a furan derivative, by refluxing the reaction product under lithium iodide and DBU (1,8-diazabicyclo[5.4.0]undec-7-ene), a compound having one more benzene rings than the starting compound, and two substituted hydroxyl groups can be obtained. Further, when the hydroxyl group of this compound is brominated by the known method, and subjecting a bromo group to a Grignard reaction, a functional group can be introduced into a position of a bromo group.

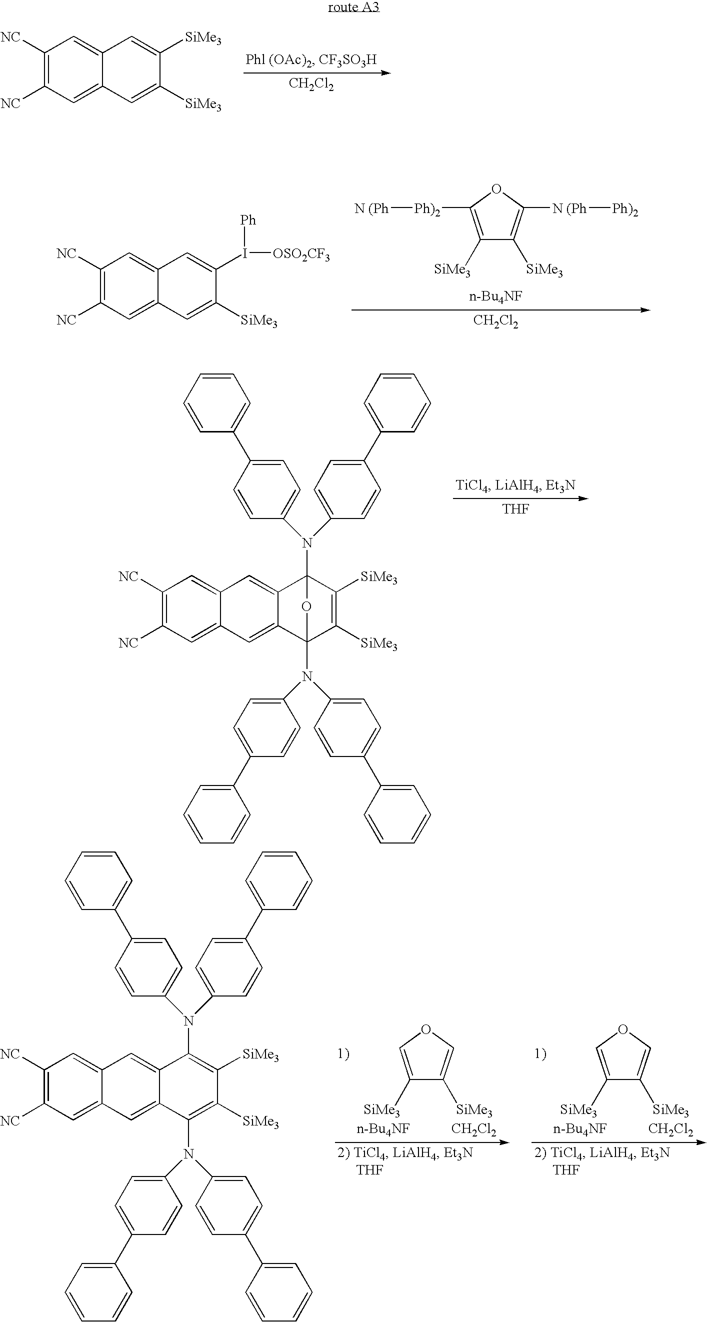

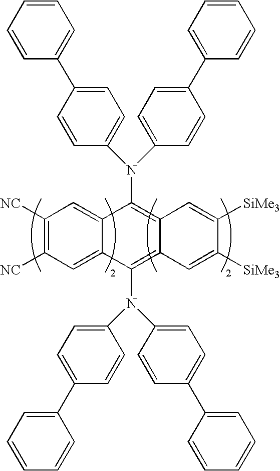

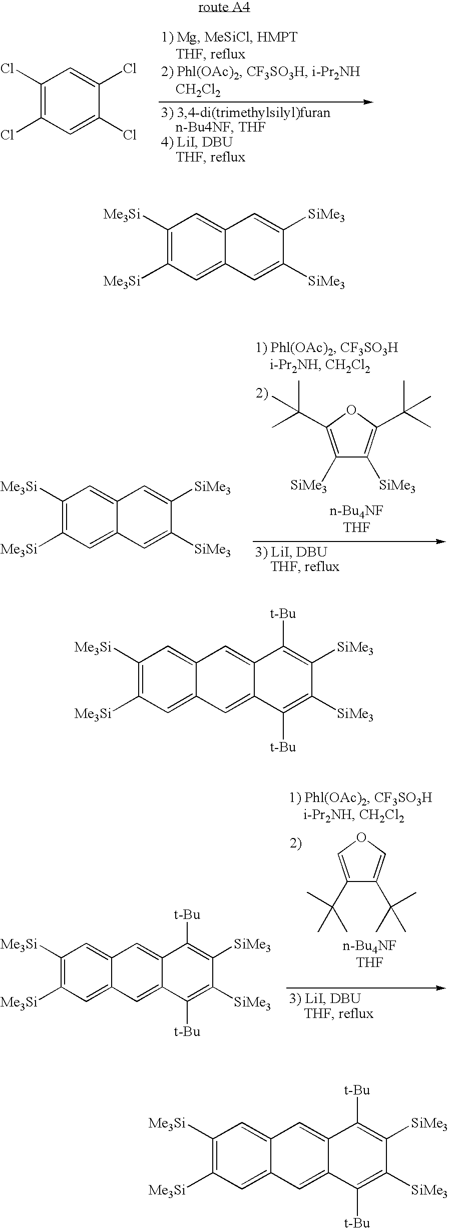

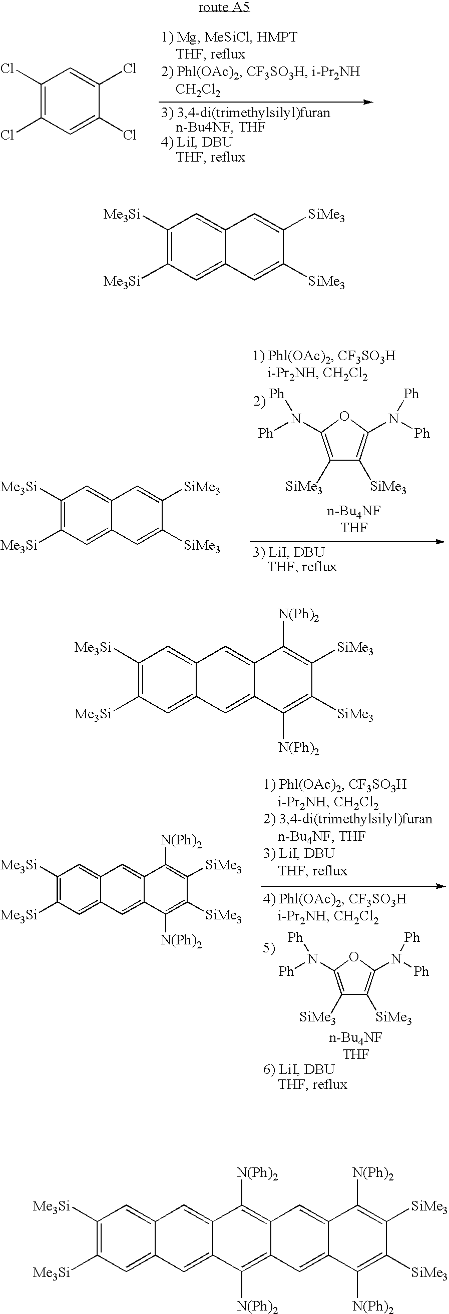

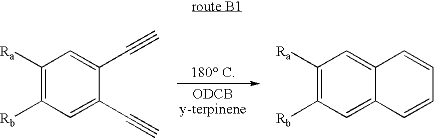

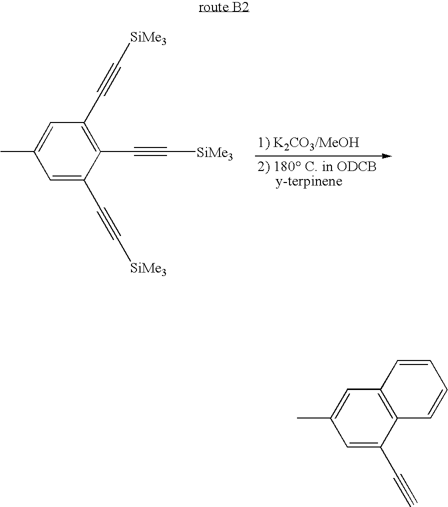

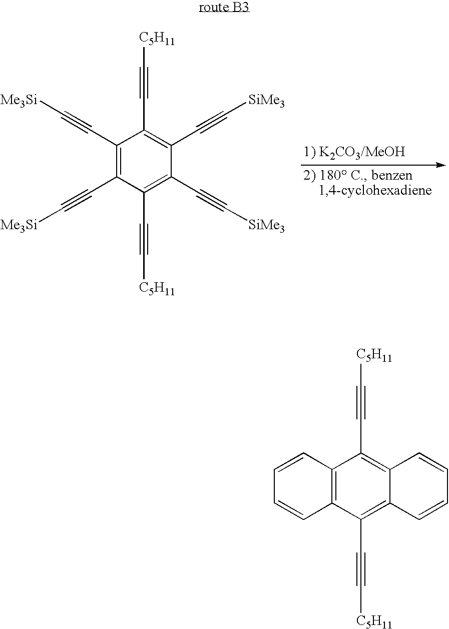

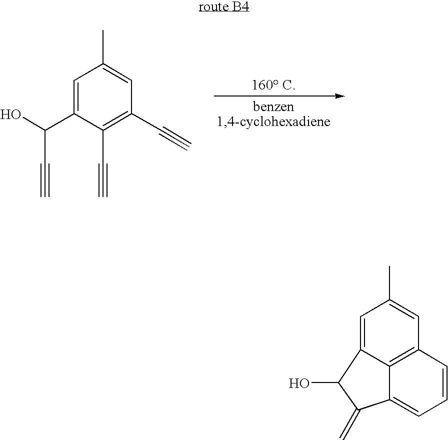

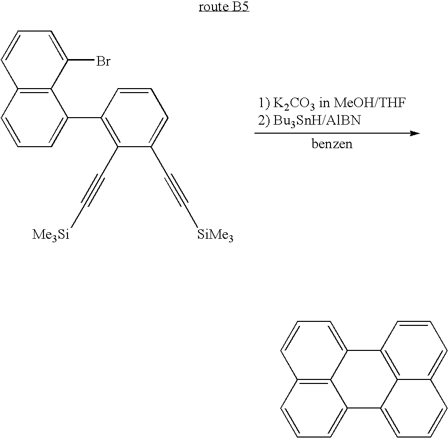

wherein Rₐ and R_{b} are each independently are as defined in the functional group.

The functional group can be introduced by optionally halogenating a prescribed site of the fused polycyclic hydrocarbon compound, and reacting this with a functional group-containing compound. When the functional group has been already introduced, introduction is not necessary.

The functional group-containing compound can introduce the functional group into a halogenated site by a reaction with the halogenated site of the fused polycyclic hydrocarbon compound.

Specifically, for example, when the functional group is an alkyl group, a cycloalkyl group, an aryl group, or a di or triarylalkyl group, the Grignard reagent having the functional group can be used. In addition, for example, when the functional group is a diarylamino group, diarylamine can be used. In addition, for example, when the functional group is an alkoxy group, or an oxyaryl group, an alcohol having those groups can be used. In addition, for example, when the functional group is a halogenated alkyl group, a Grignard reagent having the functional group can be used. In addition, for example, when the functional group is a nitrile group, a nitro group or an ester group, a procedure of adding the group in a process of synthesis from a raw material compound and, thereafter, adopting a mild route of a reaction route can be used. When the mild reaction route cannot be selected, a protecting/deprotecting reaction can be utilized before and after the reaction. Examples of the protecting group used in a protecting/deprotecting reaction include a trimethoxysilyl group.

The reaction condition at introduction of a functional group is not particularly limited as far as the functional group can be introduced. Usually, the group can be introduced by refluxing for 1 to 48 hours in an organic solvent having no influence on the reaction. As the organic solvent having no influence on the reaction, the same organic solvent as that described later can be used.

A silyl group can be introduced by optionally halogenating a prescribed site of the fused polycyclic hydrocarbon compound, and reacting this with a silane derivative represented by the general formula;

X⁴—SiX¹X²X³

wherein X¹ to X³ are as defined above; X⁴ is a hydrogen atom or a halogen atom, for example, a fluorine atom, a chlorine atom, a bromine atom, or an iodine atom, preferably a hydrogen atom or a chlorine atom. It is not necessary that the prescribed site has already been halogenated.

Preferable examples of the silane derivative include triethoxysilane, di(t-butyl)monomethoxysilane, and tetrachlorosilane.

The reaction condition at introduction of a silyl group is not particularly limited as far as a silyl group can be introduced. Specifically, a reaction temperature is, for example, −100 to 150° C., preferably −20 to 100° C. A reaction time is, for example, around 0.1 to 48 hours. The reaction is usually performed in an organic solvent which does not influence on the reaction. Examples of the organic solvent which does not influence on the reaction include aliphatic hydrocarbons such as hexane, pentane and the like, ethers such as diethyl ether, dipropyl ether, dioxane, tetrahydrofuran (THF) and the like, aromatic hydrocarbons such as benzene, toluene, nitrobenzene and the like, chlorinated hydrocarbons such as methylene chloride, chloroform, carbon tetrachloride and the like. These can be used alone, or as a mixed solution. Inter alia, ethers, chlorinated hydrocarbons, and aromatic hydrocarbons are preferable and, particularly, THF, diether ether, chloroform, nitrobenzene, and toluene are preferable. In the reaction, a catalyst may be used arbitrarily. As the catalyst, the known catalyst can be used, and examples include a copper catalyst, a platinum catalyst, a palladium catalyst, a nickel catalyst and the like.

For example, the organic silane compound having two hydrophobic groups as the functional group can be synthesized by the following method.

By a first step of first reacting a naphthalene derivative represented by the formula (1-1)

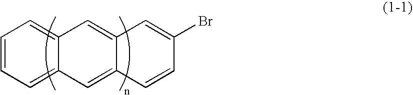

wherein n is 0 to 10,
with R³—Br (R³ is a hydrophobic group) using a Grignard reaction to form an intermediate represented by the formula (1-2);

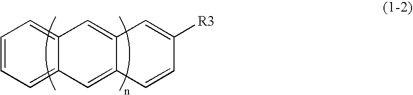

wherein N and R³ are as defined above,

a second step of brominating an α carbon of R³ of the intermediate, and Subjecting to the Grignard reaction of this with R⁴—Br (R⁴ is a hydrophobic group) to form the formula (1-3);

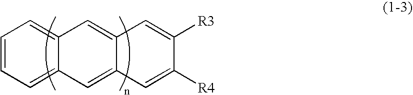

wherein n, R³ and R⁴ are as defined above,

a third step of brominating the intermediate represented by the formula (1-3) to obtain an intermediate represented by the formula (1-4);

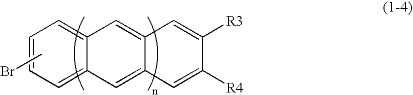

wherein n, R³ and R⁴— are as defined above
or the formula (1-5);

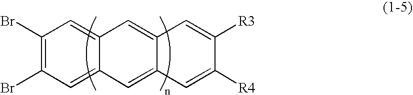

wherein n, R³ and R⁴ are as defined above, which has been obtained by brominating the intermediate represented by the formula (1-3), and

a fourth step of reacting the intermediate represented by the formula (1-4) or (1-5) with a silicon compound represented by H—SiX¹X²X³ (provided that X¹ to X³ are the same or different, and are an alkoxy group represented by O(CH₂)ₘCH₃ (m=0 to 9), or a halogen atom),

an organic silane compound corresponding to the following formula (I)′ can be synthesized.

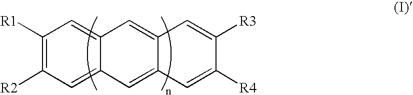

wherein n, R¹, R², and X¹ to X³ are as defined above.

When a residue such as a trimethylsilyl group or the like is present at the prescribed site of the fused polycyclic hydrocarbon compound, and halogenation is difficult to occur, a silyl group may be introduced based on a reaction shown below. A starting substance of the following reaction is the fused polycyclic hydrocarbon compound synthesized by Route A1.

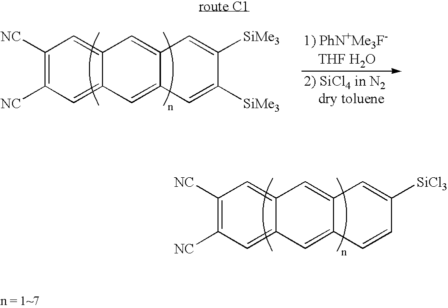

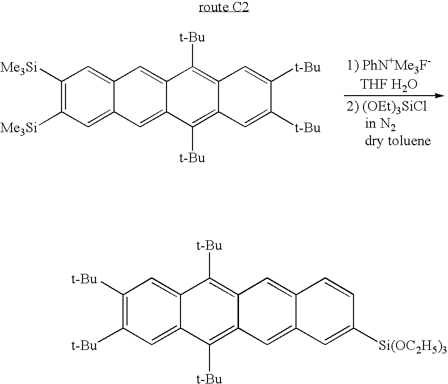

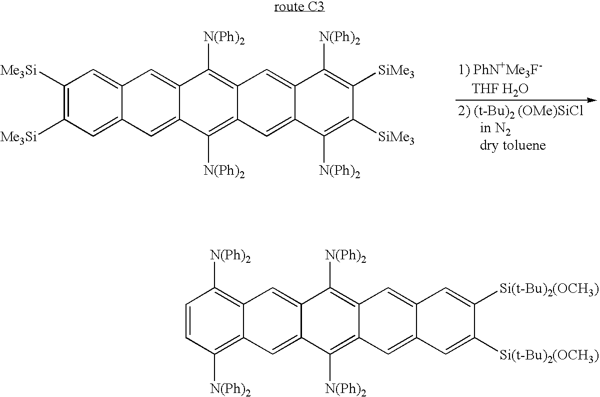

One example of a route for introducing the functional group and the silyl group is shown below.

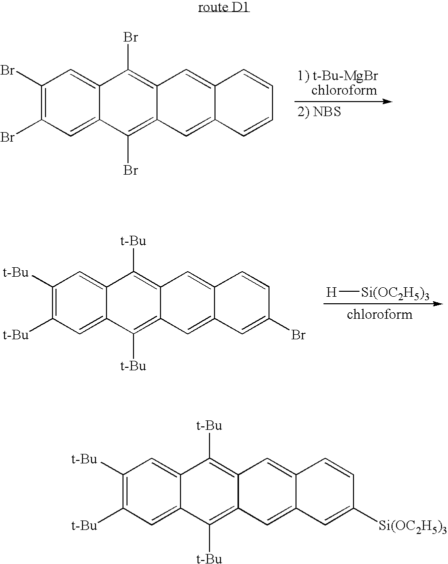

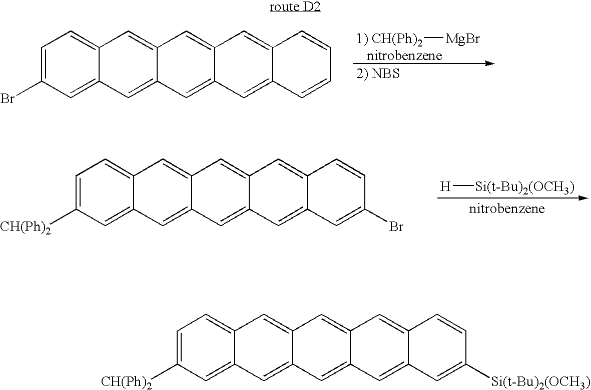

In addition, examples of a procedure of inserting a secondary amino group in which a nitrogen atom is substituted with two aromatic ring groups, as a side chain, into the perylene skeleton include a procedure for halogenating an insertion part of a side chain in advance, and coupling the secondary amino group in the presence of a metal catalyst. For example, in the case of the perylene skeleton, the secondary amino group can be inserted, for example, by the following procedure.

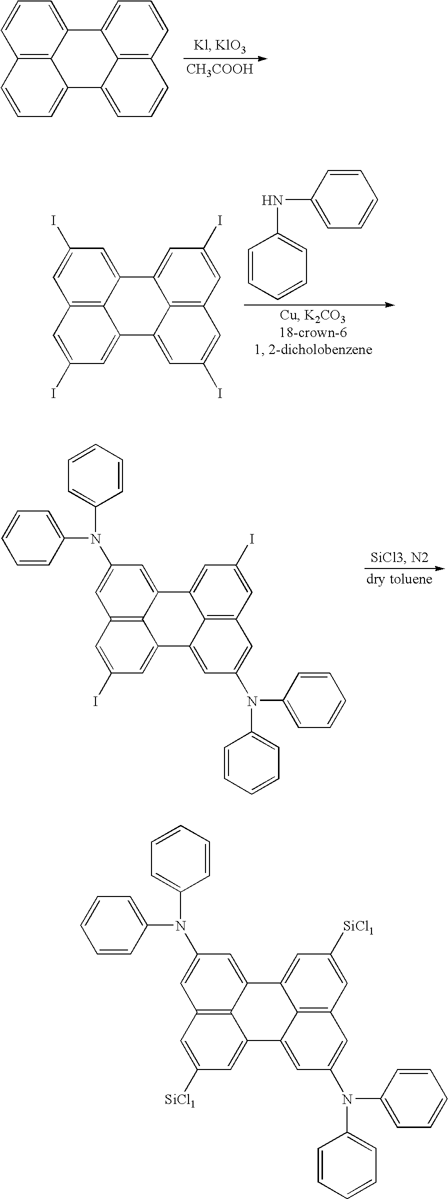

The organic silane compound of the present invention obtained by such the method can be isolated and purified from the reaction solution by the known means, for example, elution, concentration, solvent extraction, fractionation, recrystallization, chromatography or the like.

### (Material for Organic EL Device)

Among the organic silane compound of the general formula (a), the organic silane compound having the acene skeleton suitable in a material for the organic EL device will be described below.

The organic silane compound of the present invention having the acene skeleton is represented by the general formula (1);

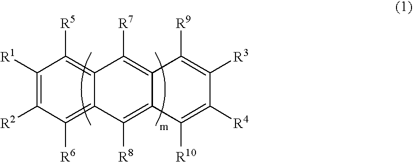

The compound is referred to as an organic silane compound (1) hereinafter.

In the formula (1), m is an integer of 0 to 10 and, from a viewpoint of a yield, an integer of 2 to 8 is preferable, particularly 2 to 4 is preferable.

At least one group, preferably 1 or 2 groups, particularly two groups of R¹ to R¹⁰ are a silyl group represented by the general formula (i);

—SiX¹X²X³ (i)

(hereinafter, simply referred to as silyl group), and at least one group is the functional group, and other groups are a hydrogen atom. When m is 2 or more, all of R⁷ and R⁸ may be the same or different.

In the organic silane compound (1), any group may be a silyl group as far as at least one group of R¹ to R¹⁰ is a silyl group and, in view of electrical conductivity, it is preferable that at least one of R¹ to R⁴ is a silyl group.

When the organic silane compound (1) of the present invention has two or more silyl groups, a part or all of those groups may be the same or different.

In the organic silane compound (1), any group may be the functional group as far as at least one group of R¹ to R¹⁰ is the functional group and, in view of a method of synthesizing a compound, and a yield, it is preferable that 1 to 6, particularly 1 to 4 groups of R³ to R¹⁰ are a functional group. That is, when the functional group is not possessed, solubility of the compound in the organic solvent is remarkably low. On the other hand, when the number of functional groups is more than 6, it is difficult to introduce such the number of functional groups into the fused polycyclic hydrocarbon compound due to the steric effect of the functional group.

When the organic silane compound (1) of the present invention has two or more functional groups, a part or all of those groups may be the same or different.

For example, when the organic silane compound (1) is contained in a light emitting layer, the organic silane compound (1) is not particularly limited as far as it is in the aforementioned range, but it is preferable to use the compound in which the functional group is a substituted or unsubstituted alkyl group, a diarylamino group, or a di- or triarylalkyl group among the aforementioned groups. Thereupon, the silyl group is not particularly limited, but may be the same as that described above. For example, when the organic silane compound in which m is in the aforementioned range in the general formula (1) is mixed with Alq3 to form an organic thin film, light emission of m=4 (575 nm), m=5 (620 nm), m=6 (625 nm), m=7 (630 nm), and m=8 (635 nm) is possible, respectively.

In addition, for example, when the organic silane compound (1) is contained in an electron transporting layer, the organic silane compound (1) in which the functional group is a group having electron donating property (a substituent constant s based on Hammett rule is 0 or more), for example, an alkyl group, a cycloalkyl group, an aryl group, a diarylamino group, a di- or triarylalkyl group, an alkoxy group, an oxyaryl group or the like among the aforementioned groups, is used. Thereupon, the silyl group is not particularly limited, but may be the same as that described above.

In addition, for example, when the organic silane compound (1) is contained in a hole transporting layer, the organic silane compound (1) in which the functional group is a group having electronattracting property (a substituent constant s based on Hammett rule is 0 or less), for example, a halogenated alkyl group, a nitrile group, a nitro group, an ester group or the like, is used. Thereupon, the silyl group is not particularly limited, but may be the same as that described above.

When the organic silane compound (1) is contained in any layer of the light emitting layer, the electron transporting layer and the hole transporting layer, in view of a light emitting efficiency and crystallizability control, it is preferable that a structure of the compound has symmetry particularly linear symmetry. That is, it is preferable that, in the general formula (1), R¹ and R², R³ and R⁴, R⁵ and R⁶, R⁷ and R⁸, and R⁹ and R¹⁰ are the same substituent, respectively. It is particularly preferable that R³ and R⁴, R⁵ and R⁶, R⁷ and R⁸, and R⁹ and R¹⁰ are the same substituent.

Examples of the organic silane compound (1) of the present invention are shown below.

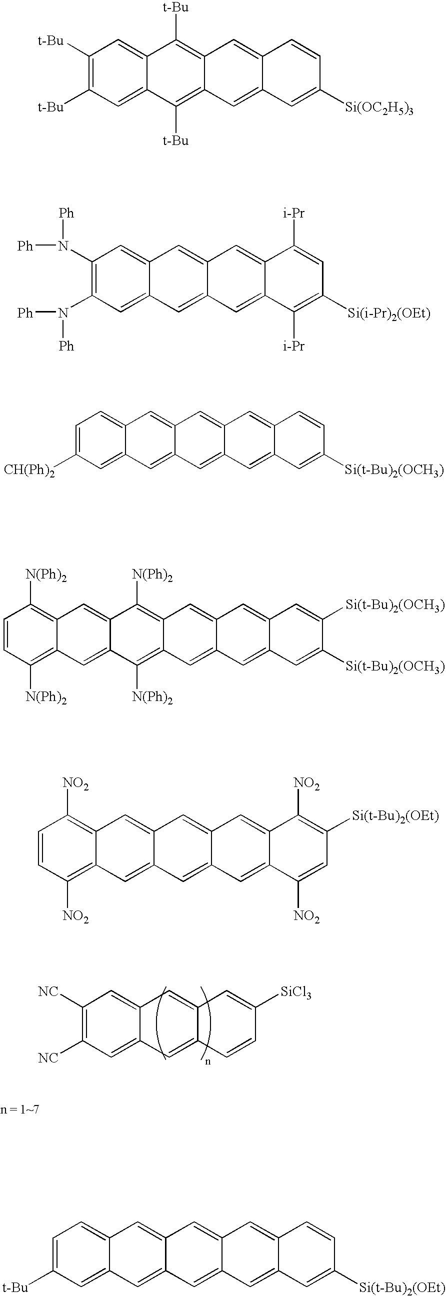

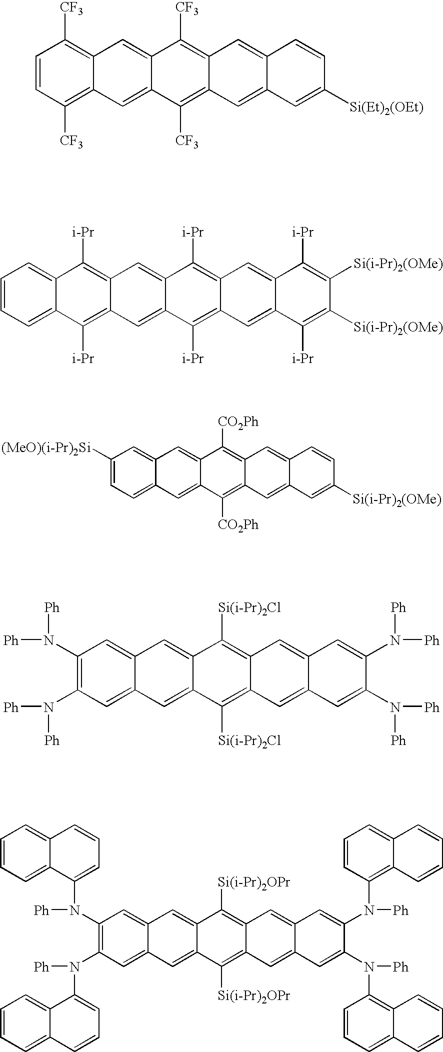

The organic silane compound of the present invention having a different acene skeleton from that described above is represented by the general formula (2)

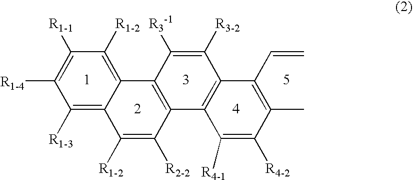

and the general formula (3):

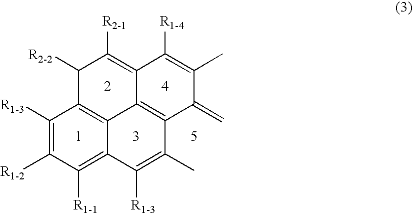

Hereinafter, the compound of the general formula (2) is referred to as organic silane compound (2), and a compound of the general formula (3) is referred to as organic silane compound (3). Skeletons possessed by the organic silane compounds (2) and (3) are all the acene skeleton in which benzene rings are zigzag bound. For convenience, the number of benzene ring units is designated in the form shown in the above general formula. In addition, a binding position and a kind of a substituent are designated as Rn-m. In any of the organic silane compounds (2) and (3) of the present invention, a total unit number n of benzene rings is preferably 3 to 7.

Preferable examples of an acene skeleton of the general formula (2) include a phenanthrene skeleton, a chrysene skeleton, a picene skeleton and the like.

Preferable examples of the acene skeleton of the general formula (3) include a pyrene skeleton, an anthoanthrene skeleton and the like.

In the formulas (2) and (3), among all groups represented by Rn-m, at least one group is the silyl group, at least one, preferably 1 to 4 groups are the functional groups, and other groups are all a hydrogen atom. The silyl group and the functional group are the same as the silyl group and the functional group in the formula (1), respectively.

The organic silane compound of the present invention having the perylene skeleton is represented by the general formula (4);

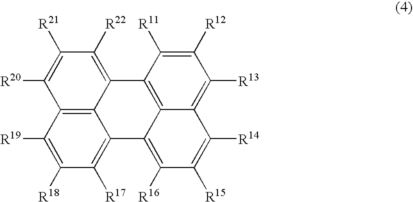

Hereinafter, the compound is referred to as organic silane compound (4)

In the formula (4), at least one group, preferably 1 to 2 groups of R¹¹ to R²² are the silyl group, at least one group, preferably 1 to 4 groups are functional groups, and other groups are a hydrogen atom. In the formula (4), the silyl group and the functional group are the same as the silyl group and functional group in the formula (1), respectively.

When the organic silane compound (4) of the present invention has two or more silyl groups, a part or all of those groups may be the same or different.

When the organic silane compound (4) of the present invention has two or more functional groups, or a part or all of those groups may be the same or different.

In addition, when the organic silane compound (4) is used as a material for the organic EL device, in view of a light emitting efficiency, it is preferable that a structure of the compound has symmetry, particularly point symmetry. That is, it is preferable that, in the general formula (4), R¹¹ and R¹⁷, R¹² and R¹⁸, R¹³ and R¹⁹, R¹⁴ and R²⁰, R¹⁵ and R²¹, and R¹⁶ and R²² are the same substituent, respectively.

Examples of the organic silane compound (4) of the present invention are shown below.

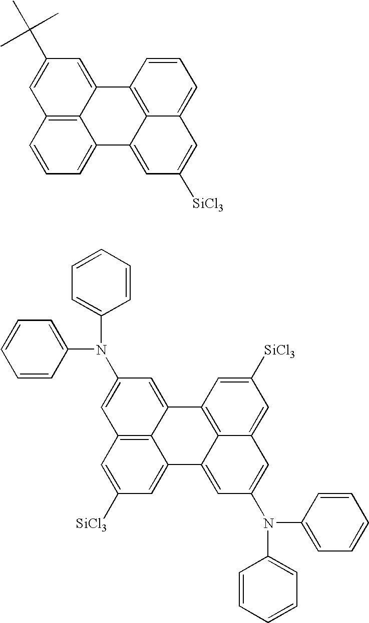

In the organic silane compound having the functional group in the organic group derived from the fused polycyclic hydrocarbon compound, a film excellent in electrical conductivity is obtained. In addition, solubility in the organic solvent is enhanced, and it becomes possible to apply to a coating method using the organic solvent. Further, when the functional group is an organic residue having high hydrophobicity, solubility in the organic solvent is further enhanced. For this reason, general-use is remarkably improved. Further, the organic silane compound of the present invention becomes possible to bind to a substrate firm via a chemical bond, because it has the silyl group. Further, by the silyl group being hydrophilic, and an organic residue being hydrophobic, surface activity of the organic silane compound of the present invention is improved. For this reason, the silyl group interacts with a substrate at formation of the film, and the compound molecules are aligned regularly and effectively in the same direction. Further, due to the presence of the functional group having a great molecular volume, interaction between adjacent molecules is reduced, and the film becomes amorphous. As a result, electrical conductivity of the compound is further improved, and a film forming time can be further shortened.

When the silyl group is not possessed, binding with the substrate is weakened, and durability of the resulting film is reduced. When only a group having a small molecular volume as the functional group is possessed, the formation of an amorphous film becomes impossible, because the crystallizability is enhanced.

### (Construction of Organic EL Device)

The organic EL device of the present invention has organic thin films comprising one or more organic thin films derived from the general formula (a) between an anode and a cathode.

As the anode and the cathode, any electrodes which have previously been used in the field of the organic EL device can be used. Particularly, as the anode, usually, a thin film having high light transmittance and high hole injecting property is used and, for example, a metal oxide or a mixed metal oxide such as indium tin oxide (ITO), SnO₂, indium tin oxide, zinc oxide, indium zinc oxide and the like can be used. And, examples include a metal having a high work function such as gold, and a conductive polymer in which a dopant such as an electrolyte and the like is added to a polymer such as PEDOT (poly[3,4-(ethylene-1,2-dioxy)thiophene]), polyaniline, polypyrrole, polythiophene and the like. As the cathode, usually, a thin film having high electron injecting property is used, and examples include an alloy such as a lithium-aluminum alloy, a magnesium silver alloy and the like, magnesium, calcium, and an electrode having a bilayer structure such as lithium fluoride (LiF)/aluminum, lithium oxide (Li₂O)/aluminum and the like.

The organic thin film is used by combining one or more organic thin films selected from the group consisting of, for example, an electron transporting layer, a hole transporting layer, and a light emitting layer, Examples of construction of the organic EL device of the present invention using such the organic thin film are as follows.

Construction (1); anode-light emitting layer-cathode,

Construction (2); anode-hole transporting layer-light emitting layer-cathode,

Construction (3); anode-light emitting layer-electron transporting layer-cathode, and

Construction (4); anode-hole transporting layer-light emitting layer-electron transporting layer-cathode.

In the organic EL device of the present invention, when it has any construction, the organic silane compound is contained in at least one organic thin film, for example, at least one organic thin film selected from the electron transporting layer, the hole transporting layer, and the light emitting layer. When the organic silane compound is contained, the organic silane compound, and a layer on which the organic silane compound-containing layer is formed, for example, the anode, the cathode or other organic thin film are reacted to chemically bind them and, as a result, the organic silane compound-containing layer and a layer on which the layer is formed are bound firm with a chemical bond. For this reason, injection and transparence of a carrier such as a hole and an electron occur effectively at an interface between those layers, and a light emitting efficiency as a whole is improved, and a driving voltage can be effectively reduced. Therefore, it is preferable in respect of carrier injection that the organic silane compound is contained in all organic thin films, and a bond by a chemical bond is formed at all interfaces of an organic EL device, but from a viewpoint that light emitting property of the light emitting layer itself is increased by using a material having a better quantum yield in the light emitting layer, it is more preferable that only an electrode and a transporting layer are bound with a chemical bond. Further, in respect of an efficiency of manufacturing the organic EL device, it is most preferable that only the transporting layer nearer a substrate, and an electrode are bound with a chemical bond and, also in this construction, a hole/electron transporting efficiency can be improved. That is, in view of that, usually, the anode, the desired organic thin film and the cathode are sequentially laminated on a transparent substrate, it is more preferable that the hole transporting layer and the anode are bound with a chemical bond.

For example, when the organic EL device has the construction (1), the organic thin film is only the light emitting layer, and the organic silane compound is contained in the light emitting layer. In this case, the light emitting layer is bound to at least a lower electrode (e.g. anode) via a chemical bond. Such the light emitting layer may be constructed of the organic silane compound alone, or may be constructed of a mixture of the organic silane compound and other light emitting substance. Other light emitting substance is not particularly limited as far as it is a substance which has previously been used as a light emitting substance for the organic EL device, and examples include tris(8-quinolilito)aluminum (Alq3), a styryl compound (dimerized styryl compound), a benzoxazole derivative and a metal complex thereof, a benzimidazole derivative and a metal complex thereof, a polymer such as poly(p-phenylenevinylene), and a derivative or a derivative in a copolymer form thereof, polyfluorene and a derivative thereof, and the like.

In addition, for example, when the organic EL device has the construction (2), the organic silane compound is contained in at least one layer of the hole transporting layer and the light emitting layer, preferably only in the hole transporting layer. When the organic silane compound is contained in the hole transporting layer, the hole transporting layer is bound to the anode via a chemical bond. Such the hole transporting layer may be constructed of the organic silane compound alone, or may be constructed of a mixture of the organic silane compound and other hole transporting substance. Other hole transporting substance is not particularly limited as far as it is a substance which has previously been used as a hole transporting substance for the organic EL device, and examples include a triphenyldiamine compound such as N,N′-diphenyl-N,N′-bis(4′-methylphenyl)-4,4′-diamine (TPD) and the like, a phenylenediamine compound such as N,N,N′,N′-tetra-(m-toluoyl)-m-phenylenediamine and the like, a diphenoquinone compound such as 3,5-dimethyl-3′,5′-ditertiarybutyl-4,4′-diphenoquinone and the like, and an oxadiazole compound such as 2-(4-biphenyl)-5-(4-tertiary butylphenyl)-1,3,4-oxadiazole and the like. As a ratio of mixing the organic silane compound and other hole transporting substance, they may be mixed in such a range that a ratio of the organic silane compound is 1 weight % to 100 weight %, but it is preferable to adjust a mixing amount so that suitable injection is obtained, because an amount of a hole to be injected is changed depending on a mixing ratio. Inter alia, when the organic silane compound and other hole transporting substance have different energy levels and mobilities to a hole, it is desirable to regulate a hole concentration optimal for a structure of an organic EL device by selecting a compound, and finding out an optimal mixing ratio. The hole transporting layer, when the organic silane compound is not contained in the hole transporting layer, may be constructed of the aforementioned other hole transporting substance.

When the organic silane compound is contained in the light emitting layer, the light emitting layer is bound to the hole transporting layer via a chemical bond. A light emitting layer constituting material in such the case is the same as that of the light emitting layer of the construction (1). The light emitting layer, when the organic silane compound is not contained in the light emitting layer, may be constructed of other light emitting substance of the construction (1).

In addition, for example, when the organic EL device has the construction (3), the organic silane compound is contained in at least one layer of the electron transporting layer and the light emitting layer, preferably only in the electron transporting layer. When the organic silane compound is contained in the electron transporting layer, the electron transporting layer is bound to the light emitting layer via a chemical bond. Such the electron transporting layer may be constructed of the organic silane compound alone, or may be constructed of a mixture of the organic silane compound and other electron transporting substance. Other electron transporting substance is not particularly limited as far as it is a substance which has previously been used as the electron transporting substance of the organic EL device. In addition, if the light emitting layer has a nature of light emission and, at the same time, a nature of capable of transferring an electron like Alq3, an electron transporting layer may not be formed. A representative example of the electron transporting substance is Alq3, and a phthalocyanine copper complex compound may be used. As a ratio of mixing the organic silane compound and other electron transporting substance, they may be mixed in such a range that a ratio of the organic silane compound is 1 weight % to 100 weight %, but it is preferable to adjust a mixing amount so that suitable injection is obtained, because an amount of an electron to be injected is changed depending on a mixing ratio. Inter alia, when an organic silane compound and other electron transporting substance have different energy levels and mobilities to an electron, it is desirable to regulate an electron concentration optimal for a structure of a light emitting device by selecting a compound, and finding out an optimal mixing ratio. The electron transporting layer, when the organic silane compound is not contained in the electron transporting layer, may be constructed of the aforementioned other electron transporting substance.

When the organic silane compound is contained in the light emitting layer, the light emitting layer is bound to the anode via a chemical bond. The light emitting layer constituting material in such the case is the same as that of the light emitting layer of the construction (1). The light emitting layer, when the organic silane compound is not contained in the light emitting layer, may be constructed of other light emitting substance of the construction (1).

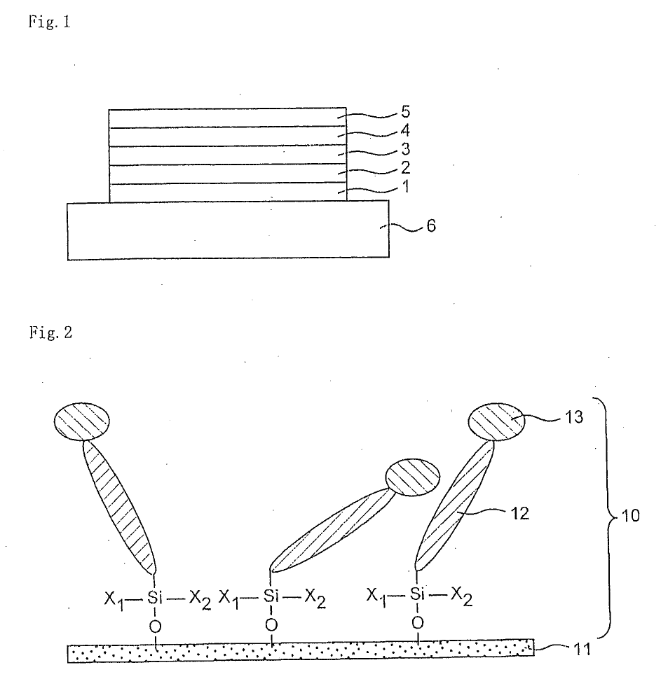

In addition, for example, when the organic EL device has the construction (4), as shown in FIG. 1, the device is such that the hole transporting layer 2, the light emitting layer 3, the electron transporting layer 4 and the cathode 5 are sequentially laminated on the anode 1. In addition, from a viewpoint of a manufacturing efficiency, the anode 1 is usually formed on the substrate 6 in advance. In this case, the organic silane compound is contained in at least one layer of the hole transporting layer, the electron transporting layer and the light emitting layer, preferably in one layer of the hole transporting layer and the electron transporting layer, particularly only in the electron transporting layer.

When the organic silane compound is contained in the electron transporting layer, the electron transporting layer is bound to the light emitting layer via a chemical bond. The electron transporting layer constituting material in such the case is the same as that of an electron transporting layer of the construction (3). The electron-transporting layer, when the organic silane compound is not contained in the electron transporting layer, may be constructed of other electron transporting substance of the construction (3).

When the organic silane compound is contained in the hole transporting layer, the hole transporting layer is bound to the anode via a chemical bond. The hole transporting layer constituting material in such the case is the same as that of the hole transporting layer of the construction (2). The hole transporting layer, when the organic silane compound is not contained in the hole transporting layer, may be constructed of other hole transporting substance of the construction (2).

When the organic silane compound is contained in the light emitting layer, the light emitting layer is bound to the hole transporting layer via a chemical bond. The light emitting layer in such the case is the same as the light emitting layer of the construction (1). The light emitting layer, when the organic silane compound is not contained in the light emitting layer, may be constructed of other light emitting substance of the construction (1).

### (Process for Manufacturing Organic EL Device)

The organic EL device of the present invention is usually such that the anode, each organic thin film and the cathode are sequentially laminated on the substrate.

A substrate material is not particularly limited, but in view of that emitted light is taken out from a substrate side, a transparent or translucent material is preferable. Therefore, for example, it is preferable to use a glass or a plastic having an amorphous nature and, depending on utility, the substrate having suitable mechanical strength and surface planarity such as a metal and a wafer can be used.

The anode and the cathode can be formed by adopting a deposition method such as a vacuum deposition method, a molecular beam deposition method and the like, a vapor method such as a RF sputtering method and the like. A thickness of the anode and the cathode is not particularly limited, but usually may be independently 50 to 500 nm.

The organic thin film containing no organic silane compound, in the case of any layer of the light emitting layer, the electron transporting layer and the hole transporting layer, can be formed by adopting the same method as the method of forming the anode and the cathode using prescribed substances.

Whether the organic silane compound is contained or not, a thickness of the light emitting layer, the electron transporting layer and the hole transporting layer is not particularly limited, but usually may be independently 1 to 500 nm.

The organic thin film containing the organic silane compound can be formed by the following method using prescribed substances.

(Organic Thin Film Containing Organic Silane Compound and Method of Forming the Same)

The organic thin film containing the organic silane compound, in the case of any layer of the light emitting layer, the electron transporting layer and the hole transporting layer, can be formed as an amorphous film by a method including a solution process, while being bond to a layer on which a layer is to be formed via a chemical bond. The layer on which the layer is to be formed means a layer on which the organic silane compound-containing layer should be formed. For example, when the organic silane compound is contained in the light emitting layer in the construction (1), the layer on which the layer is to be formed refers to the anode. In addition, for example, when the organic silane compound is contained in the hole transporting layer in the construction (2), the layer on which the layer is to be formed refers to the anode. In addition, for example, when the organic silane compound is contained in the electron transporting layer in the constructions (3) and (4), the layer on which the layer is to be formed refers to the light emitting layer.

As the method of forming the thin film including a solution process, the known method such as a chemical adsorption method, a LB method (Langmuir Blodget method), a dipping method, a spin coating method, a casting method and the like can be adopted. The thin film construction when the organic thin film is formed using the organic silane compound, and a method of forming the same will be described below.

FIG. 2 is one example of an outline construction view of the organic thin film formed using the organic silane compound. In FIG. 2, for example, it is shown that when the organic silane compound in one of R¹ to R² is a silyl group, and at least one group of R³ to R⁴ and R⁹ to R¹⁰ is the functional group 13 in the general formula (1) is used, an amorphous organic thin film 10 is formed on the layer 11 on which the layer is to be formed 11 while being bound via a silanol bond (—Si—O—). That is, an alkoxy group or a halogen atom possessed by the silyl group is consequently converted into an ether bond (—O—) and, by the ether bond, the organic silane compound, therefore, the organic thin film 10 containing the compound is bound on the layer 11 on which the layer is to be formed. In addition, intermolecular interaction between adjacent molecules (van der Waals interaction) becomes small, because an intermolecular distance between adjacent molecules is increased due to steric hindrance of the functional group 13. Therefore, the compound molecules are suitably randomly oriented while regularly aligned and without crystallization as shown in FIG. 2, and the organic thin film 10 excellent in electrical conductivity can be obtained.

In FIG. 2, the thin film has a monomolecular layer structure, and such the structure can be formed, for example, by a chemical binding method. More particularly, the organic silane compound is dissolved in an organic solvent. By immersing the substrate containing the layer on which the layer is to be formed, containing a hydroxy group on a surface in the resulting solution for a constant time, the organic silane compound is bound to the layer on which the layer is to be formed. Details of a mechanism thereupon are generally thought that following mechanisms A1 and B1 contribute complexly.

Mechanism A2; The alkoxy group or the halogen atom possessed by the organic silane compound (silyl group) is hydrolyzed by a water molecule contained in an organic solvent at a slight amount to be converted into a hydroxy group, and a dehydration reaction occurs between the hydroxy group and a hydroxy group of the layer on which the layer is to be formed.

Mechanism B1; dealcoholization reaction or a dehydrohalogenation reaction occurs between the alkoxy group or the halogen atom possessed by the organic silane compound (silyl group) and the hydroxy group of the layer on which the layer is to be formed, respectively.

It is thought that, as a result, a silicone atom of the silyl group and the layer on which the layer is to be formed are chemically bound via an ether bond (—O—).

Film formation by such the mechanism can be easily attained not only by a chemical binding method but also other solution process such as a spin coating method, a dipping method and the like.

In addition, the monomolecular layer structure in FIG. 2 can be easily formed also by a LB method. More particularly, the organic silane compound is dissolved in the organic solvent. The resulting solution is added dropwise to a water surface to form a thin film on a water surface. In that state, a pressure is applied to the water surface, and the substrate containing the layer on which the layer is to be formed, having the hydroxy group on the surface is pulled up, thereby, the organic silane compound is bound to the layer on which the layer is to be formed. It is generally thought that the following mechanism C1 as well as the aforementioned mechanisms A1 and B1 complexly contribute to details of a mechanism thereupon.

Mechanism C1; The alkoxy group or the halogen atom possessed by the organic silane compound (silyl group) is hydrolyzed by water derived from addition of a solution to be converted into a hydroxy group, and a dehydration reaction occurs between the hydroxy group and the hydroxy group of the layer on which the layer is to be formed.

It is thought that, as a result, a silicon atom of the silyl group and the substrate are chemically bound via an ether bond (—O—).

As another binding aspect, for example, when the layer on which the layer is to be formed has a carboxyl group on a surface, it is generally thought that the following mechanisms A2, B2 and C2 complexly contribute to details of a mechanisms thereupon.

Mechanism A2; The alkoxy group or the halogen atom possessed by the organic silane compound (silyl group) is hydrolyzed by a water molecule contained in an organic solvent at a minor amount to be converted into a hydroxy group, and a dehydration reaction occurs between the hydroxy group and the carboxyl group of the layer on which the layer is to be formed.

Mechanism B2; A dealcholization or a de-hydrogen halide reaction occurs between the alkoxy group or the halogen atom possessed by the organic silane compound (silyl group) and the carboxyl group of the layer on which the layer is to be formed, respectively.

Mechanism C2 (the case by LB method); The alkoxy group or the halogen atom possessed by the organic silane compound (silyl group) is hydrolyzed by water derived from addition of a solution to be converted into a hydroxy group, and a dehydration reaction occurs between the hydroxy group and the carboxyl group of the layer on which the layer is to be formed.

It is thought that, as a result, a silicon atom of the silyl group and the layer on which the layer is to be formed are chemically bond via an ester bond [silicon atom side: —O—C(═O)—: substrate side]. In addition, an ether bond (—O—) is structurally contained in an ester bond. Therefor, in the present invention, binding of the organic silane compound with the layer on which the layer is to be formed via the ether bond include the case of binding via the ester bond.

When the layer on which the layer is to be formed has no active hydrogen-containing group such as the hydroxy group and the carboxyl group on a surface, the active hydrogen-contained group can be imparted to a surface of the layer by hydrophobilization treatment. Hydrophobilization treatment can be performed, for example, by immersing the layer on which the layer is to be formed in a mixed solution of hydrogen peroxide and concentrated sulfuric acid.

In the present invention, the aforementioned various forms of bindings may occur complexly between the organic silane compound-containing layer and the layer on which the layer is to be formed.

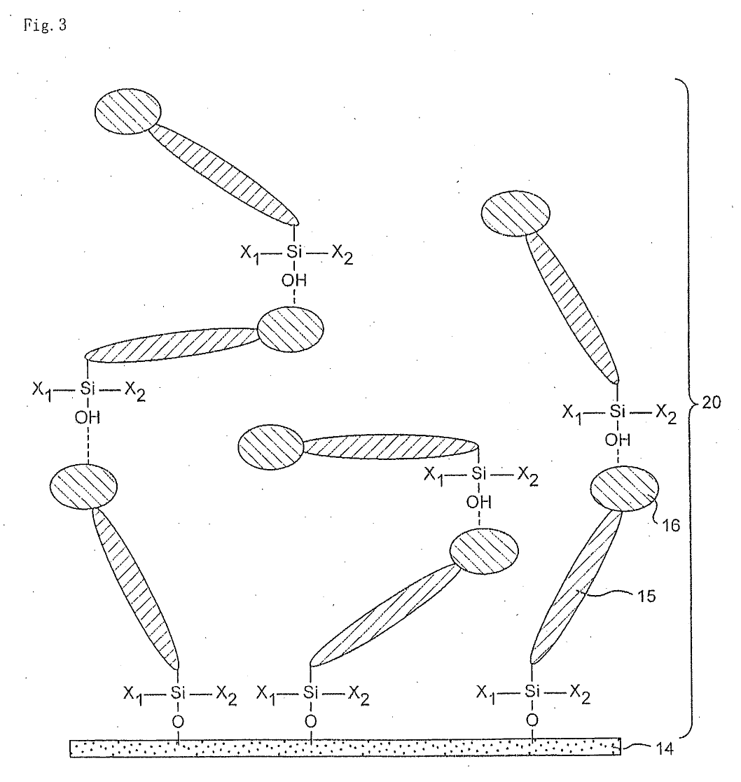

FIG. 3 is another example of an outline construction view of the organic thin film formed using the organic silane compound. In FIG. 3, it is shown that, for example, when the organic silane compound in which one of R¹ to R² is a silyl group, and at least one group of R³ to R⁴ and R⁹ to R¹⁰ is the functional group 16 having a nitrogen atom or an oxygen atom (e.g. diarylamino group, an alkoxy group or an oxyaryl group etc.) in the general formula (1) is used, not only the organic group 15 is bound to the layer 14 on which the layer is to be formed firm via a silanol bond, but also an amorphous organic thin film 20 is formed into a multimolecular layer structure by interaction (hydrogen bond) (shown by dotted line in FIG. 3) between the functional group 16 and a silanol group. That is, at an interface between the layer 14 on which the layer is to be formed, the alkoxy group or the halogen atom possessed by a silyl group is consequently converted into an ether bond (—O—), and the organic silane compound, therefore, the organic thin film 20 containing the compound is bound to the layer 14 on which the layer is to be formed via the ether bond. On the other hand, the organic silane compound bound on the layer 14 on which the layer is to be formed via the ether bond interacts with a hydroxy group of a silyl group possessed by another organic silane compound at its upper functional group 16, forming a multimolecular layer structure. Thereupon, when at least one of X¹ and X² in the silyl group is a substituent which does not react with an adjacent molecule, the effect of steric hindrance between silyl groups becomes further greater, and a better quality amorphous film can be obtained, but when a molecular volume of the substituent is too great, in view of that reactivity with the layer on which the layer is to be formed is reduced, it is preferable that the substituent is a substituent smaller than a molecular volume of the organic group 15.

Further, thereupon, when at least one of X¹ and X² in the silyl group is an alkoxy group or a halogen atom and, consequently, a silyl group has 2 to 3 silanol groups, a binding part in one compound molecule with the substrate becomes 2 to 3 places, and adherability with the layer on which the layer is to be formed can be further enhanced. In this case, by making a binding part with the layer on which the layer is to be formed 2 to 3 places, it is possible to contain many structures in which the organic group stands vertical to the layer on which the layer is to be formed. Like this, by possession of a structure in which the organic group stands vertical to the layer on which the layer is to be formed, in suitable random orientation of the organic group, electrical conductivity of the organic thin film can be further enhanced, because π-π interaction of the adjacent molecule becomes suitably strong. Therefore, electrical conductivity of the organic thin film becomes further greater and, as a result, high device property having the organic thin film which can effectively transport a hole or an electron can be realized.

The organic thin film having a multimolecular layer structure shown in FIG. 3 can be easily formed, for example, by a clipping method, a spin coating method, a casting method or the like.

More particularly, the organic silane compound is dissolved in the organic solvent. The substrate containing the layer on which the layer is to be formed, having the hydroxyl group or the carboxyl group on the surface is immersed in the resulting solution, and is pulled out. Alternatively, the resulting solution is coated on the surface of the layer on which the layer is to be formed. Thereafter, this is washed with an organic solvent, washed with water, and dried by allowing to stand or heating, to fix the thin film. This thin film may be further subjected to treatment such as electrolysis polymerization and the like.

The organic solvent which can dissolve the organic silane compound upon formation of the organic thin film is different depending on the functional group and a silyl group possessed by the compound, and examples include non-aqueous organic solvents such as hexane, n-hexadecane, methanol, ethanol, IPA, chloroform, dichlormethane, carbon tetrachloride, 1,1-dichloroethane, 1,2-dichloroethane, THF, dimethyl ether, diethyl ether, DMSO, toluene, xylene, benzene and the like.

The above description does not prevent from adopting the method which has previously been adopted as a method of forming the organic silane compound-containing layer, such as a vacuum deposition method, a molecular beam deposition method, a sputtering method and the like in the present invention.

### [Material for Organic TFT]

A material for the organic TFT of the present invention is a compound selected from the general formula (a), and the thin film can be obtained by binding the compound to a substrate via a siloxane bond.

Among the compound represented by the general formula (a), the following organic silane compound having a hydrophobic group in a long axis direction of the organic group is more preferable.

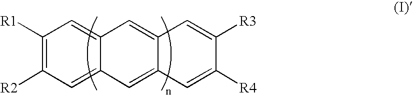

wherein n is 0 to 10, R¹ and R² are the same or different, and are a silyl group represented by SiX¹X²X³ or a hydrogen atom (provided that the case where R¹ and R² are a hydrogen atom at the same time is not included), X¹ to X³ are the same or different, and are an alkoxy group represented by O(CH₂)ₘCH₃ (m=0 to 9), or a halogen atom, and R³ and R⁴ are hydrophobic groups, or a hydrophobic group and a hydrogen atom

In the above formula, as the silyl group and the hydrophobic group, groups already explained above can be used, respectively.

The number of benzene rings constituting an organic silane compound of the formula (I)′ is 2 to 12. Particularly, in view of the number of the steps of synthesis and a yield of a product, naphthalene, anthracene, tetracene, pentacene, hexacene, heptacene, octacene, and nonacene having the number of benzene rings of 2 to 9 are particularly preferable.

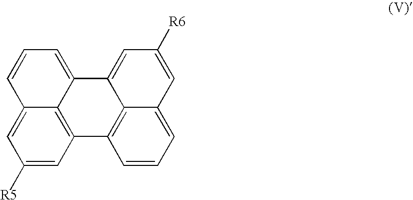

wherein R⁵ is a silyl group represented by SiX¹X²X³, X¹ to X³ are the same or different, and are an alkoxy group represented by O(CH₂)ₘCH₃ (m=0 to 9), or a halogen atom, and R⁶ is a hydrophobic group

In the above formula, as the silyl group and the hydrophobic group, groups already explained above can be used, respectively.

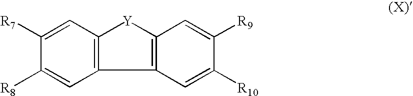

wherein R⁷ and R⁸ are the same or different, and are a silyl group represented by SiX¹X²X³ or a hydrogen atom (provided that the case where R⁷ and R⁸ are a hydrogen atom at the same time is not included), Y is selected from C(R¹¹)₂, NR¹², O and S (herein R¹¹ and R¹² are a hydrogen atom, but may be directly bind to other functional group), X¹ to X³ are the same or different, and are an alkoxy group represented by O(CH₂)ₘCH₃ (m=0 to 9) or a halogen atom, and R⁹ and R¹⁰ are a hydrophobic group or a hydrogen atom (provided that the case where R⁹ and R¹⁰ are a hydrogen atom at the same time is not included)

In the above formula, as the silyl group and the hydrophobic group, groups already explained above can be used, respectively.

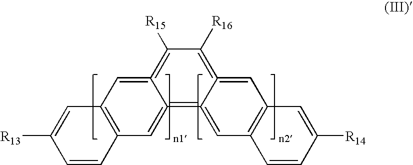

wherein R¹³ is a silyl group represented by SiX¹X²X³, R¹⁴ to R¹⁶ are the same or different, and are a hydrophobic group or a hydrogen atom (provided that the case where R¹¹ to R¹⁶ are the hydrogen atom at the same time is not included), n^{1′} and n^{2′} are integers in which a sum of them is 0 to 8, and X¹ to X³ are the same or different, and are an alkoxy group represented by O(CH₂)ₘCH₃ (m=0 to 9), or a halogen atom

In the above formula, as the silyl group and the hydrophobic group, groups already explained above can be used, respectively.

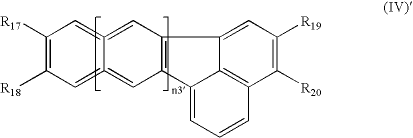

wherein R¹⁷ to R²⁰ satisfy any of the following two conditions:

condition 1; R¹⁷ and R¹⁸ are the same or different, and are a silyl group represented by SiX¹X²X³ or a hydrogen atom (provided that the case where R¹⁷ and R¹⁸ are a hydrogen atom at the same time is not include), R¹⁹ and R²⁰ are the same or different, and are a hydrogen atom or a hydrophobic group (provided that the case where R¹⁹ and R²⁰ are a hydrogen atom at the same time is not included), and X¹ to X³ are the same or different, and are an alkoxy group represented by O(CH₂)ₘCH₃ (m=0 to 9) or a halogen atom;

condition 2; R¹⁹ and R²⁰ are the same or different, and are a silyl group represented by SiX¹X²X³ or a hydrogen atom (provided that the case where R¹⁹ and R²⁰ are a hydrogen atom at the same time is not included), R¹⁷ and R¹⁸ are the same or different, and are a hydrogen atom or a hydrophobic group (provided that the case where R¹⁷ and R¹⁸ are a hydrogen atom at the same time is not included), and X¹ to X³ are the same or different, and are an alkoxy group represented by O(CH₂)ₘCH₃ (m=0 to 9) or a halogen atom)

The above compound may be substituted with the known substituent such as an alkyl group, an alkoxy group, an aryl group, an amino group and the like, or a halogen atom.

### (Construction of Organic TFT)

The organic TFT of the present invention has a functional organic thin film comprising the organic silane compound as a semiconductor layer. Among it, the functional organic thin film derived from a compound having the acene skeleton can be represented by the following formula (I)″.

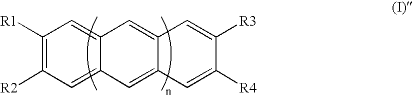

wherein n is 0 to 10, at least one of R¹ and R² constitutes a network constructed of the following siloxane bond:

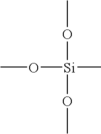

and is bound to a substrate via a siloxane bond (provided that the case where R¹ and R² are a hydrogen atom at the same time is not included), and R³ and R⁴ are a hydrophobic group, or a hydrophobic group and a hydrogen atom)

The number of benzene rings constituting the acene skeleton of the formula (I)″ is 2 to 12. Particularly, in view of the number of steps of synthesis and a yield of a product, naphthalene, anthracene, tetracene, pentacene, hexacene, heptacene, octacene, and nonacene having the number of benzene rings of 2 to 9 are particularly preferable. In addition, in the formula (I′), a molecule in which benzene rings are linearly fused is nominally shown, but a molecule in which benzene rings are fused non-linearly such as phenanthrene, chrysene, picene, pentaphene, hexaphene, heptaphene, benzanthracene, dibenzophenanthrene, anthranaphthacene and the like is included in the acene skeleton of the formula (I)′.

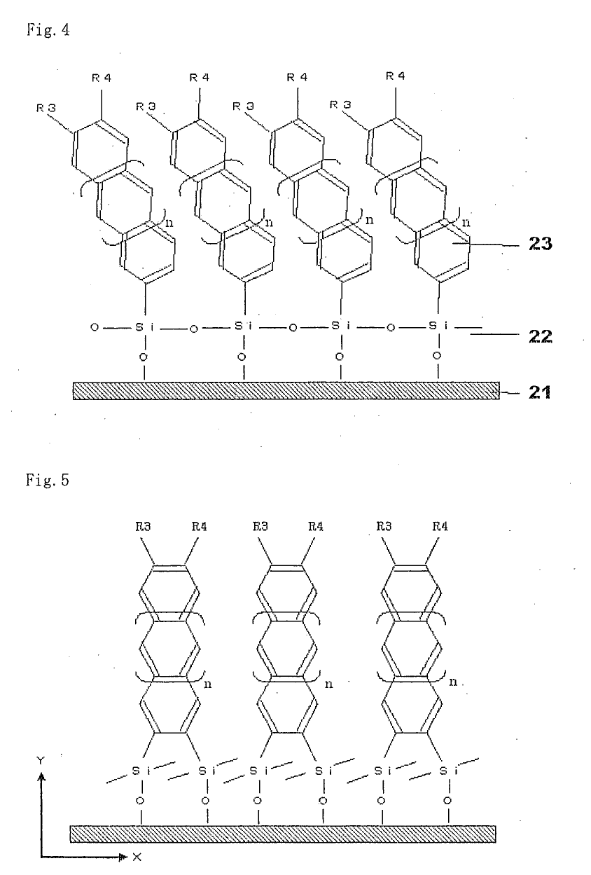

In the functional organic thin film of the present invention, the organic group is bound to the substrate via the siloxane bond (—Si—O—). Specifically, as shown in FIG. 4, in the thin film, the network 22 constructed of a silicon atom and an oxygen atom is bound to a substrate 21, and the acene skeleton (organic group) 23 is bound to the network 22. Like this, the thin film using the organic silane compound of the present invention has the aforementioned network constructed of the silicon atom and the oxygen atom, and has the acene skeleton having high intermolecular interaction (van der Waals interaction) at its upper part. For this reason, by interaction between the network and the acene skeleton, the thin film having high orientating property is obtained. In addition, high electrical conductivity through the acene skeleton can be realized, because a distance between adjacent acene skeletons is retained small, when the thin film is formed as described above. Moreover, adjacent acene skeletons have no bond. Therefor, it is possible to suppress electrical conductivity in the normal state low, and retain high electrical conductivity only when a light-excited or electric field-excited carrier is injected into this thin film.

The thin film, when it is the functional organic thin film in which one acene skeleton shown in FIG. 5 is bound to the substrate with two siloxane bonds, can afford the great effect (high orienting property, and high electrical conductivity). That is, by the functional organic thin film binding to the substrate at two places, the acene skeleton becomes vertical to the substrate surface. Electrical conductivity of the thin film is increased, because electrical conductivity of the thin film depends on a magnitude of π-π interaction between adjacent acene skeletons, as the acene skeleton is nearer vertical to the substrate. Therefore, this functional organic thin film has particularly great electrical conductivity. For this reason, this functional organic thin film can be suitably used in a device such as a solar cell, a fuel cell, a sensor and the like in addition to the organic thin film transistor, as an electrically conductive material.

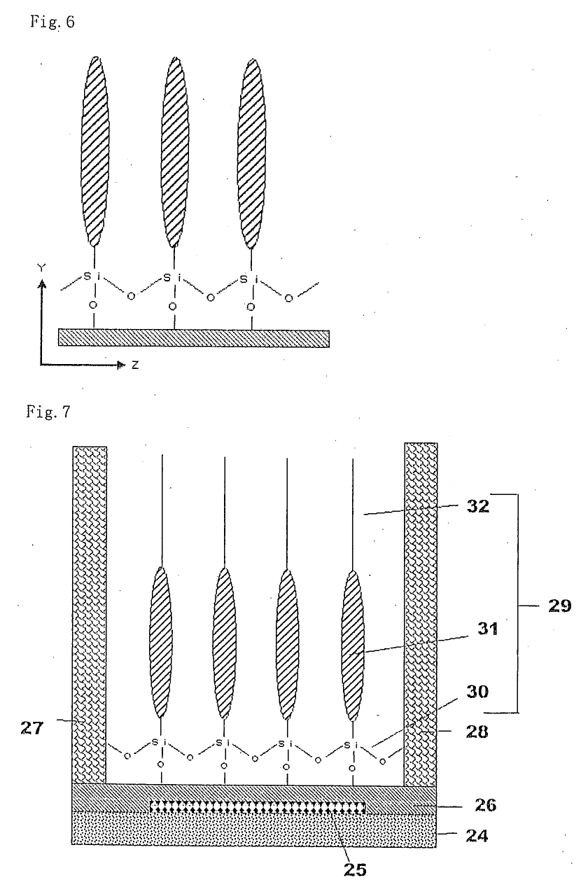

An outline view of the functional organic thin film in which one acene skeleton is bound to the substrate with two siloxane bonds like this is shown in FIG. 5 and FIG. 6. FIG. 6 is a view in which FIG. 5 is seen from another angle. By making the binding part of the functional organic thin film of the present invention with the substrate two places like FIG. 5 and FIG. 6, the acene skeleton can be vertical to the substrate. For this reason, by enhancement of π-π interaction between adjacent organic groups, the thin film having great electrical conductivity which can be suitably used in the device can be formed.

In the above explanation of the thin film, the functional organic thin film having the acene skeleton, the explanations is also true in the case of the functional organic thin film having an acenenaphthene skeleton, a perylene skeleton and a fused polycyclic hydrocarbon skeleton other than these skeletons.

Herein, examples of the substrate on which the thin film is formed include a monolayer and a laminated layer of semiconductors such as an element semiconductor such as silicon, germanium and the like, and a compound semiconductor such as GaAs, InGaAs, ZnSe and the like; a so-called SOI substrate, a multilayer SOI substrate, a SOS substrate and the like; mica; glass, quartz glass; insulating bodies such as a polymer film of polyimide, PET, PEN, PES, Teflon (registered trade mark) and the like; stainless steel (SUS); metals such as gold, platinum, silver, copper, aluminum and the like; high melting point metals such as titanium, tantalum, tungsten and the like; silicide, polycide etc. with the high melting point metal; insulating bodies such as a silicon oxide film (thermally oxidized film, low temperature oxidized film: high temperature oxidized film such as LTO film etc.: HTO film), silicon nitride film, SOG film, PSG film, BSG film, BPSC film and the like; PZT, PLZT, ferroelectric or antiferromagnetic; low dielectrics such as SiOF-based film, SiOC-based film or CF-based film, HSQ (hydrogen silsesquioxane)-based film (inorganic type) formed by coating, MSQ (methyl silsesquioxane)-based film, PAE (polyarylene ether)-based film, BCB-based film, porous-film or CF-based film, or a porous film and the like.

Further, in view of that more organic groups are oriented on substrate, among these substrates, the silicon substrate, the quartz substrate, and the mica substrate which are the substrate in which active hydrogen of a hydroxyl group, a carboxyl group or the like can be protruded on a surface, or a substrate in which active hydrogen can be protruded by hydrophilization treatment are particularly preferable. In addition, hydrophilization can be performed, for example, by immersing in a mixed solution of hydrogen peroxide and concentrated sulfuric acid.

A construction of the organic thin film transistor of the present invention provided with the aforementioned functional organic thin film will be explained below more specifically.

A construction of the organic TFT of the present invention will be described. In the organic TFT of the present invention, the aforementioned functional organic thin film is used. The organic TFT of the present invention comprises, for example, the functional organic thin film formed directly or indirectly on the substrate, a gate electrode formed indirectly or directly on the substrate, a source electrode•a drain electrode formed on one surface side or other surface side of the functional organic thin film, and a gate insulating film formed between the gate electrode and the source electrode•drain electrode. TFT can take various forms of a stagger-type, a reverse stagger-type or modification of them.

For example, in the case of the stagger-type, examples include a form in which an organic semiconductor layer comprising the functional organic thin film is formed on the substrate, the gate electrode is arranged thereon via the gate insulating film, and source/drain electrodes separated from the gate electrode and contact with the organic semiconductor layer is arranged on both sides of the gate electrode. Alternatively, this may be a form of the reverse stagger-type in which the gate electrode is formed on the substrate, the organic semiconductor layer is formed on the gate electrode via the gate insulating film, and source/drain electrodes contacting with the organic semiconductor layer is arranged on the organic semiconductor layer so as not to overlap with the gate electrode.

One example of a reverse stagger-type organic TFT is shown in FIG. 7. FIG. 7 is such that the organic semiconductor layer 29 comprising the functional organic thin film is provided on an upper part of the substrate 24 via the electrode 25, and the source electrode 27 and the drain electrode 28 are provided on both sides thereof. In the figure, 30 means the network constructed of the silicon atom and the oxygen atom, 31 means the organic group, and 32 means the linear hydrocarbon group.

In addition, examples of the gate electrode and the source/drain electrode include a layer usually comprising an electrical conductive material used in TFT or the like. Examples include a monolayer and a laminated layer of metals such as gold, platinum, silver, copper, aluminum and the like; a high melting point metals such as titanium, tantalum, tungsten and the like; silicide, polycide etc. with the high melting point metal. Thereupon, a film thickness is not particularly limited, but can be appropriately adjusted to a film thickness usually used in a transistor.

Examples of the gate insulating film include a film comprising an insulating material usually used in TFT. Examples include a silicon oxide film, a silicon nitride film and the like.

The organic TFT of the present invention can be widely applied, for example, as a semiconductor device such as a memory, a logic element and a logic circuit, to various utilities, for examples, electronic equipments such as data processing system of personal computer, note, laptop, personal•assistant/transmitter, minicomputer, work station, main frame, multiprocessor•computer or other all-type computer systems; electronic parts constituting a data processing system such as CPU, memory, data memorizing device and the like; communicating equipments such as telephone, PHS, modem, router and the like; image displaying equipments such as display panel, projector and the like; office equipments such as printer, scanner, copying machine and the like; sensor; photographing equipments such as video camera, digital camera; leisure equipments such as game machine, music player and the like; information equipments such as potable information terminal, clock, electronic dictionary and the like; automobile-carrying equipments such as car navigation system, car audio and the like; AV equipments for recording or reproducing information such as moving image, static image, music and the like; electronic appliances such as washing machine, microwave oven, refrigerator, rice cooker, dish washer, cleaner, air conditioner and the like; health administering equipments such as massage equipments, weigh device, tonometer and the like; potable-type recoding devices such as IC card, memory card and the like.

A process for manufacturing organic TFT include, for example, following four steps. That is, they are (A) a step of forming the functional organic thin film directly or indirectly on the substrate, (B) a step of forming the gate electrode indirectly or directly on the substrate, (C) a step of forming the source electrode/the drain electrode on one surface side or other surface side of the functional organic thin film, and (D) a step of forming the gate insulating film between the gate electrode and the source electrode•drain electrode. Herein, the step (A) is a step including a second step of binding the organic silane compound comprising the electron conjugation system molecule having the hydrophobic group on the substrate via a net-like structure formed of the silicon atom and the oxygen atom. The steps (A), (B), (C) and (D) are not limited to this order, but an order of steps can be freely changed depending on a transistor structure of an intended form.

(Process for Manufacturing Functional Organic Thin Film Constituting organic TFT)

Subsequently, a process for manufacturing the functional organic thin film of the present invention will be described. The functional film of the present invention can be formed by the known method such as a vacuum deposition method, a molecular beam deposition method, and a coating method such as a dipping method (chemical binding method), a LB method, a spin coating method, a casting method, a bar coating method, a roll coating method and the like of a solution dissolved in a solvent. As one example of the manufacturing process, a process for manufacturing the functional organic thin film of the present invention by the chemical binding method and the LB method will be shown below.

The chemical binding method can be performed as follows.

First, the organic silane compound is dissolved in a non-aqueous method such as a hexane, chloroform, carbon tetrachloride and the like. In the resulting solution, the substrate on which the thin film is to be formed (preferably the substrate having active hydrogen of a hydroxyl group, a carboxyl group etc.) is immersed, and pulled out therefrom. Alternatively, the resulting solution may be coated on a substrate surface. Thereafter, this is washed with the non-aqueous solvent, washed with water, and dried by allowing to stand or heating, to fix the thin film. This thin film may be used directly as an electric material, or may be used by further subjecting to treatment such as electrolysis polymerization and the like. By using this material, the thin film in which the network of Si—O—Si is formed, a distance between adjacent organic groups is small, and the material is a highly ordered (crystallized), is obtained. In addition, when the organic group is linear, a distance between adjacent organic groups can be further decreased, because adjacent organic groups are not bound. As a result, a more highly crystallized thin film can be obtained.

Alternatively, the organic silane compound of the present invention can be also made into the thin film, for example, using a LB method. Herein, the LB method is a method of forming the thin film by forming the thin film (L film) on an aqueous solution surface by spreading a non-aqueous solution containing a material on the aqueous solution surface, and transferring the thin film onto the substrate.

First, the organic silane compound of the present invention is dissolved in the non-aqueous solvent such as hexane, chloroform, carbon tetrachloride and the like. The organic silane compound, when a hydrophobic group is bound to the organic group, has higher solubility in the non-aqueous solvent. As a result, the compound can be relatively easily dissolved in the non-aqueous solvent. Subsequently, the resulting non-aqueous solution is added to the aqueous solution surface. This organic silane compound has the hydrophobic group (silyl group) and the hydrophobic group, when spread on a water surface. Therefore, the compound can be oriented with the hydrophilic group towards the water surface. In addition, by intermolecular interaction between adjacent compounds, the thin film comprising the organic silane compound can be made to have particularly high orienting property on the water surface. Thereafter, the thin film can be formed by pulling up the substrate while a surface pressured is applied to the water surface.

Herein, the organic silane compound has at least one silyl group for forming the siloxane bond. For example, in the formula (I)′, the silyl group is formed at a position of R¹ and/or R².

In addition, usually, many compounds containing the organic group derived from the fused polycyclic hydrocarbon compound exhibit hard solubility even in the non-aqueous solvent. To the contrary, the thin film can be formed by a solution process, because the organic silane compound, when it contains the hydrophobic group at an end, can enhance solubility in the non-aqueous solvent. In addition, surface activity of a whole compound is improved, because it contains the silyl group as the hydrophilic group. Therefore, when the thin film comprising the organic silane compound of the present invention is formed on a hydrophilic substrate, by interaction between the silyl group and the substrate, all molecules are aligned in the same direction, and are effectively adsorbed onto the substrate. For this reason, shortening of a reaction time and orienting property of the thin film can be improved.

### EXAMPLES

The present invention will be explained in detail below by way of Examples, but the present invention is not limited to following Examples.

### Example 1

### Synthesis of Organic Silane Compound Represented by the Structural Formula (A)

First, 100 mM NBS and AIBS were added to a carbon tetrachloride solution containing 50 mM 2-bromonaphthalene (CAS no. 90-11-9), and this was reacted at 60° C. for 2 hours under the N₂ atmosphere to synthesize 2,6-dibromonaphthalene. Subsequently, 40 mM 2-bromonaphthalene was dissolved in THF, a metal magnesium was added, this was reacted at 60° C. for 1 hour under the N₂ atmosphere to synthesize a Grignard reagent, the Grignard reagent was added to the THF solution containing 20 mM 2,6-dibromonaphthalene, and this was reacted at 20° C. for 9 hours to synthesize [2,2′;6′,2″]ternaphthalene. Thereafter, 20 mM NBS and AIBM were added to a carbon tetrachloride solution containing 10 mM [2,2′;6′,2″]ternaphthalene, this was reacted at 60° C. for 2 hours under the N₂ atmosphere to form 6-bromo-[2,2′;6′,2″]ternaphthalene, a metal magnesium was added, this was reacted at 60° C. for 1 hour under the N₂ atmosphere to synthesize a Grignard reagent, 10 mM of chlorotriethoxysilane was further added, and this was reacted at 60° C. for 2 hours to obtain the title compound at a yield of 40%.

Regarding the resulting compound, an infrared adsorption spectrum was measured, absorption derived from SiC was observed at 1090 cm⁻¹, and it was confirmed that the compound has a SiC bond.

Further, nuclear magnetic resonance (NMR) of the compound was measured.

7.9 ppm (m) (4H aromatic)

7.6 ppm (m) (8H aromatic)

7.5 ppm (m) (4H aromatic)

7.3 ppm (m) (3H aromatic)

7.6 ppm (m6) (6H ethoxy group, methylene group)

1.5 ppm (m) (9H ethoxy group, methyl group)

From this result, it was confirmed that the resulting compound is a compound shown by the structural formula (A).

### Preparation Example 1

### Synthesis of 2-bromopentacene

2-Bromopentacene to be used in Example 2 was synthesized by the following procedure. First, 100 mM pentacene and NBS dissolved in 50 mL of carbon tetrachloride were added to a 100 ml egg plant flask equipped with a stirrer, a refluxing condenser, a thermometer, and an addition funnel, the mixture was reacted for 1.5 hours in the presence of AIBN. Unreacted materials and HBr were removed by filtration, and an accumulated material in which only one place was brominated was taken out using column chromatography to obtain the title 2-bromopentacene.

### Example 2

### Synthesis of Organic Silane Compound Represented by the Structural Formula (B)

First, 50 mM 2,7-dibromofluorene (CASNO. 16433-88-8) was dissolved in a TI-IF solution, a metal magnesium was added, and this was reacted at 60° C. for 8 hours to form the following Grignard reagent 1.

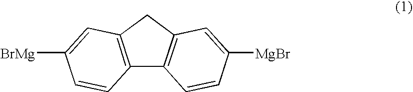

Subsequently, the Grignard reagent 1 was added to a THF solution containing 25 mM 2-bromopentacene formed in Preparation Example 1, and this was reacted at 20° C. for 2 hours to form the following Grignard reagent 2.

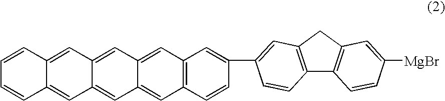

Further, 25 mM 2-bromofluorene (CASNO. 1133-80-8) was added, and this was reacted at 20° C. for 3 hours to synthesize 7-pentacene-2-yl-9H,9′H-[2,2′]bifluorenyl. Thereafter, a metal magnesium was added, this was reacted at 60° C. for 1 hour under the N₂ atmosphere to synthesize the following Grignard reagent 3 and, further, 10 mM chlorotrimethoxysilane was added, and this was reacted at 60° C. for 2 hours to obtain the title compound at a yield of 25%.

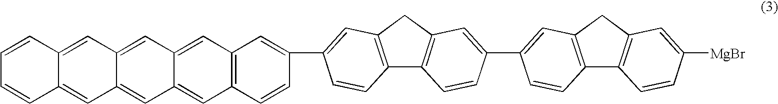

Regarding the resulting compound, an infrared absorption spectrum was measured, absorption derived from SiC was observed at 1080 cm⁻¹, and it was confirmed that the compound has a SiC bond.

Further, nuclear magnetic resonance (NMR) of the compound was measured.

8.2 ppm (m) (2H pentacene)

8.0 ppm (m) (2H pentacene)

7.9 ppm (m) (9H pentacene and fluorene)

7.8 ppm (m) (4H pentacene and fluorene)

7.6 ppm (m) (5H pentacene and fluorene)

7.4 ppm (in) (3H pentacene and fluorene)

3.9 ppm (m) (4H fluorene)

3.6 ppm (m) (9H methoxy group, methyl group)

From this result, it was confirmed that the resulting compound is a compound shown by the structural formula (B).

### Example 3

### Synthesis of Organic Silane Compound Represented by the Structural Formula (C)

First, 50 mM 2,6-dibromonaphthalene which is an intermediate of Example 1 was dissolved in a THF solution, a metal magnesium was added, and this was reacted at 60° C. for 8 hours to form the following Grignard reagent.

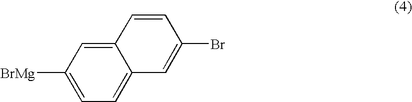

On the other hand, 100 mM of MBS and AIBN were added to a carbon tetrachloride solution containing 50 mM benzo[k]fluoranthene (CASNO. 207-08-9), this was reacted at 60° C. for 2 hours under the N₂ atmosphere, unreacted materials were removed by filtration, and by using column chromatography, an accumulated material in which only one place was brominated was taken out to synthesize 2-bromo-benzo[k]fluoranthene. Subsequently, 20 mM 2-bromo-benzo[k]fluoranthene was added to a THF solution containing 20 mM Grignard reagent, and this was reacted at 20° C. for 4 hours to synthesize 2-(6-bromo-naphthalen-2-yl)-benzo[k]fluoranthene. Further, a metal magnesium was added to a carbon tetrachloride solution containing 10 mM 2-(6-bromo-naphthalen-2-yl)-benzo[k]fluoranthene, this was reacted at 60° C. for 1 hour, a Grignard reagent 2 was synthesized, 10 mM chlorotrimethoxysilane was added as in Example 2, and this was reacted at 60° C. for 2 hours to obtain the title compound at a yield of 30%.

Regarding the resulting compound, an infrared absorption spectrum was measured, absorption derived from SiC was observed at 1080 cm⁻¹, and it was confirmed that the compound has a SiC bond.

Further, nuclear magnetic resonance (NMR) of the compound was measured.

8.1 ppm (m) (1H benzofluoranthene)

8.0 ppm (m) (1H benzofluoranthene)

7.9 ppm (m) (2H benzofluoranthene and naphthalene)

7.8 ppm (m) (1H benzofluoranthene)

7.7 ppm (m) (7H benzofluoranthene and naphthalene)

7.6 ppm (m) (1H benzofluoranthene)

7.5 ppm (m) (1H naphthalene)

7.3 ppm (m) (3H benzofluoranthene and naphthalene)

3.6 ppm (m) (9H methoxy group, methyl group)

From this result, it was confirmed that the resulting compound is a compound shown by the structural formula (C).

### Example 4

### Synthesis of Organic Silane Compound Represented by the Structural Formula (D)

First, 50 mM NBS and AIBN were added to a carbon tetrachloride solution containing 50 mM 1-bromopyrene (CASNO. 1714-29-0), and this was reacted at 60° C. for 2 hours under the N₂ atmosphere to synthesize 1,6-dibromopyrene. Subsequently, a metal magnesium was added to a THF solution containing 100 mM 1-bromonaphthalene, and this was reacted at 60° C. for 2 hours to form a Grignard reagent. Further, 25 mM 1,6-dibromopyrene was added to a THF solution containing 50 mM Grignard reagent, and this was reacted at 20° C. for 4 hours to synthesize 1,6-di-naphthalen-2-yl-pyrene. Thereafter, 50 mM NBS and AIBN were added to a carbon tetrachloride solution containing 20 mM 1,6-di-naphthalen-2-yl-pyrene, this was reacted at 60° C. for 2 hours under the N₂ atmosphere to brominate this, a metal magnesium was added to a carbon tetrachloride solution containing 10 mM brominated material, and this was reacted at 60° C. for 1 hour to synthesize a Grignard reagent. Thereafter, 10 mM chlorotriethoxysilane was added as in Example 1, and this was reacted at 60° C. for 2 hours to obtain of the title compound at a yield of 25%.

Regarding the resulting compound, an infrared absorption spectrum was measured, absorption derived from SiC was observed at 1080 cm⁻¹, and it was confirmed that the compound has a SiC bond.

Further, nuclear magnetic resonance (NMR) of the compound was measured.

8.2 ppm (m) (1H pyrene)

8.0 ppm (m) (2H pyrene)

7.9 ppm (m) (3H pyrene and naphthalene)

7.7 ppm (m) (10H pyrene and naphthalene)

7.5 ppm (m) (2H naphthalene)

7.3 ppm (m) (3H naphthalene),

3.6 ppm (m) (6H ethoxy group, methylene group)

1.5 ppm (m) (9H ethoxy group, methyl group)

From this result, it was confirmed that the resulting compound is a compound represented by the structural formula (D)

### Example 5

### Synthesis of Organic Silane Compound Represented by the Structural Formula (E)

First, a metal magnesium was added to a THF solution containing 20 mM 6-bromo-[2,2′;6′,2″]ternaphthalene which is an intermediate of Example 1, and this was reacted at 60° C. for 1 hour under the N₂ atmosphere to form a Grignard reagent. Subsequently, 20 mM Grignard reagent was added to a THF solution containing 20 mM 6-bromo-[2,2′;6′,2″]ternaphthalene, and this was reacted at 20° C. for 3 hours to synthesize the following intermediate.

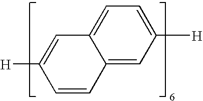

Further, 20 mM NBS and AIBN were added to a carbon tetrachloride solution containing 10 mM intermediate, this was reacted at 60° C. for 2 hours under the N₂ atmosphere to synthesize a compound in which an end was brominated, a metal magnesium was further added, this was reacted at 60° C. for 1 hour to synthesize a Grignard reagent, 10 mM tetrachlorosilane was added, and this was reacted at 60° C. for 2 hours to obtain the title compound at a yield of 25%.

Regarding the resulting compound, an infrared absorption spectrum was measured, absorption derived from SiC was observed at 1095 cm⁻¹, and it was confirmed that the compound has a SiC bond.

Further, nuclear magnetic resonance (MNR) of the compound was measured. Direct measurement of NMR of the resulting compound is impossible due to high reactivity of the compound. Therefor, the compound was reacted with ethanol (generation of hydrogen chloride was confirmed) to convert chlorine at an end into an ethoxy group, followed by measurement.

7.9 ppm (m) (10H aromatic)

7.7 ppm (m) (14H aromatic)

7.5 ppm (m) (10H aromatic)

7.3 ppm (m) (3H aromatic)

3.7 ppm (m) (6H ethoxy group, methylene group)

1.4 ppm (m) (9H ethoxy group, methyl group)

From this result, it was confirmed that the resulting compound is a compound represented by the structural formula (E).

### Example 6

### Synthesis of Organic Silane Compound Represented by the Structural Formula (F)

First, 100 mM NBS and AIBN were added to a carbon tetrachloride solution containing 50 mM 1-benzanthracene (CASNO. 56-55-3), and this was reacted at 60° C. for 2 hours under the N₂ atmosphere to synthesize 3-bromo-benz[a]anthracene. Subsequently, a metal magnesium was added to a THF solution containing 20 mM 3-bromo-benzo[a]anthracene, and this was reacted at 65° C. for 2 hours to synthesize a Grignard reagent. In addition, 100 mM NBS and AIBN were added to a carbon tetrachloride solution containing 50 mM phenanthrene (CASNO. 85-01-8), and this was reacted at 60° C. for 3 hours under the N₂ atmosphere to synthesize 2,7-dibromo-phenanthrene. Subsequently, 5 mM Grignard reagent was added to a THF solution containing 5 mM 2,7-dibromo-phenanthorene, and this was reacted at 60° C. for 2 hours to synthesize 3-(7-bromo-phenantheren-2-yl)-benzo[a]anthracene. Further, 10 mM NBS and AIBN were added to a carbon tetrachloride solution containing 1 mM 3-(7-bromo-phenanthren-2-yl)-banzo[a]anthracene, this was reacted at 60° C. for 2 hours under the N₂ atmosphere, a metal magnesium was added, this was reacted at 60° C. for 1 hour to synthesize a Grignard reagent, 2 mM chlorotrimethoxysilane was added, and this was reacted at 60° C. for 2 hours to obtain the title compound at a yield of 10%.

Regarding the resulting compound, an infrared absorption spectrum was measured, absorption derived from SiC was observed at 1075 cm⁻¹, and it was confirmed that the compound has a SiC bond.

Further, a nuclear magnetic resonance (NMR) of the compound was measured.

8.5 ppm (m) (3H aromatic)

8.3 ppm (m) (4H aromatic)

8.1 ppm (m) (31-1 aromatic)

7.9 ppm (m) (4H aromatic)

7.7 ppm (m) (2H aromatic)

7.4 ppm (m) (3H aromatic)

3.7 ppm (m) (9H methoxy group, methyl group)

From this result, it was confirmed that the resulting compound is a compound represented by the structural formula (F).

### Preparation Example 2

2,3,6,7-Tetra(trimethylsilyl)naphthalene to be used in Example 7 and Example 9 was synthesized by the following method according to a first reaction formula of Route A4 or Route A5.

More specifically, first, 0.4M magnesium, 100 mL of HMPT (hexamethyl phosphorus triamide), 20 mL THF, 12 (catalyst), and 0.1M 1,2,4,5-tetrachlorobenzene (e.g. which can be purchased from KISHIDA CHEMICAL Co., Ltd. at a purity of 99%) were added to a 200 ml glass flask equipped with a stirrer, a refluxing condenser, a thermometer, and an addition funnel, 0.4M chlorotrimethylsilane was added dropwise at a temperature of 80° C., and this was stirred for 30 minutes, and refluxed at 130° C. for 4 days to synthesize 1,2,4,5-tetra(trimethylsilyl)benzene. Subsequently, 20 mM i-Pr₂NH, 50 mM pHI(OAc)₂[(diacetoxyiodo)benzene], and 50 mL of dichloromethane were added to a 200 mL egg plant flask, 50 mM CF₃CO₂H (TfOH) was added dropwise at 0° C., and this was stirred for 2 hours. Subsequently, 10 mL of a dichloromethane solution containing 50 mM 1,2,4,5-tetra(trimethoxysilyl)benzene was added dropwise at 0° C., and this was stirred at room temperature for 2 hours to synthesize phenyl[2,4,5-tris(trimethylsilyl)phenyl]iodonium triflate. Further, subsequently, a THF solution of 2.0M Bu₄NF was charged into a 50 mL egg plant flask, 10 mL of a dichloromethane solution containing 5 mM phenyl[2,4,5-tris(trimethylsilyl)phenyl]iodonium triflate and 10 mM 3,4-di(trimethylsilyl)furan was added dropwise at 0° C., and this was stirred for 30-minutes to progress the reaction. After completion of the reaction, extraction was performed with dichloromethane and water, and the extract was purified by column chromatography to synthesize a 1,4-dihydro-1,4-epoxynaphthalene derivative. Thereafter, the 1,4-dihydro-1,4-epoxynaphthalene derivative, and 10 mL of a THF solution containing 1 mM lithium iodide and 10 mM DBU (1,8-diazabicyclo[5.4.0]undec-7-ene) were charged into a 50 ml glass flask equipped with a stirrer, a refluxing condenser, a thermometer, and an addition funnel, 1 mM 1,4-dihydro-1,4-epoxynaphthalene derivative was added, and this was refluxed for 3 hours under the nitrogen atmosphere to progress a reaction. After completion of the reaction, extraction and removal of water with MgSO₄ were performed to synthesize the title 2,3,6,7-tetra(trimethylsilyl)naphthalene.

### Example 7

### Synthesis of 3-triethoxysilyl-6,8,9,11-tetra-t-butyltetracene

3-Triethoxysilyl-6,8,9,11-tetra-t-butyltetracene was synthesized by synthesizing 2,3,7,8-tetra(trimethylsilyl)-6,9-(tert-butyl)-anthracene according to RouteA4, then, deprotecting a trimethylsilyl group with quaternary ammonium according to RouteC2, and reacting this with a silane compound.

More specifically, the compound was synthesized according to the following procedure. First, 2,3,6,7-tetra(trimethylsilyl)naphthalene synthesized in Preparation Example 2 was used as a starting raw material, and 2,3,7,8-tetra(trimethylsilyl)-6,9-(tert-butyl)-anthracene was synthesized according to the same procedure as the procedure for synthesizing 2,3,6,7-tetra(trimethylsilyl)naphthalene from 1,2,4,5-tetra(trimethylsilyl)benzene of Preparation Example 2 except that 2,5-(tert-butyl)-3,4-di(trimethylsilyl)furan was used in place of 3,4-di(trimethylsilyl)furan as a synthesizing procedure. Further, 2,3-di(trimethylsilyl)-6,8,9,11-tetra(tert-butyl)tetracene was represented by the following structural formula was synthesized by applying the same procedure as the procedure for synthesizing 2,3,7,8-tetra(trimethylsilyl)-6,9-(tert-butyl)-anthracene from 2,3,6,7-tetra(trimethylsilyl)naphathalene of the present Example except that 3,4-(tert-butyl)furan was used in place of 2,5-(tert-butyl)-3,4-di(trimethylsilyl)furan.

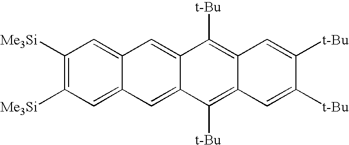

Subsequently, 1 mM 2,3-di(trimethylsilyl)-6,8,9,11-tetra(tert-butyl)tetracene was dissolved in a THF solvent containing a small amount of water and PhNMe₃F, and this was stirred to synthesize 6,8,9,11-tetra(tert-butyl)tetracene. Further, under the nitrogen atmosphere, 5 ml of dry THF, 5 mM 6,8,9,11-tetra(tert-butyl)tetracene, and magnesium were added to a 200 ml egg plant flask, this was stirred for 1 hour to form a Grignard reagent, 5 mM chlorotriethoxysilane and 30 ml of THF were charged into a 100 ml egg plant flask equipped with a stirrer, a refluxing condenser, a thermometer and an addition funnel, this was ice-cooled, the Grignard reagent was added, and this was aged at 30° C. for 1 hour. Then, the reaction solution was filtered under reduced pressure, magnesium chloride was removed, and THF and unreacted chlorotriethoxysilane were stripped from the filtrate to obtain the title compound at a yield of 15%.

Regarding the resulting compound, infrared absorption was measured, and absorption of Si—O—C was seen at a wavelength of 1035 cm⁻¹. From this, it was confirmed that the resulting compound contains a silyl group. An ultraviolet-visible absorption spectrum of a chloroform solution containing the compound was measured, and absorption was observed at a wavelength of 493 nm. This absorption was based on π→π* transition of a tetracene skeleton contained in the molecule, and it was confirmed that the compound contains a tetracene skeleton.

Further, nuclear magnetic resonance (NMR) of the compound was measured.

8.0 ppm to 7.3 ppm (m) (7H; derived from tetracene skeleton)
(3.9 ppm to 3.7 ppm) (m) (6H; derived from ethyl group of silyl group)
(1.6 ppm to 1.1 ppm) (m) (45H; derived from t-butyl group and methyl group of silyl group)

From these result, it was confirmed that this compound is 3-triethoxysilyl-6,8,9,11-tetra-t-butyltetracene.

### Example 8

### Synthesis of 3-di-t-butylmethxysilyl-9-diphenylmethylpentacene and formation of organic thin film using the compound

3-Di-t-butylmethoxysilyl-9-diphentylmethylpentacene was synthesized by a procedure of Route D2. That is, 9-diphenylmethylpentacene was synthesized by reacting chlorodiphenylmethane and an equivalent amount of magnesium to form a Grignard reagent and gradually adding the Grignard reagent to nitrobenzene containing bromopentacene. Subsequently, NBS was used to form 3-bromo-9-diphenylmethylpentacene, and this was reacted with H—Si(C(CH₃)₃)₂OCH₃ dissolved in nitrobenzene to synthesize 3-di-t-butylmethoxysilyl-9-diphenylmethylpentacene.

More particularly, first, magnesium was added to, for example, a chloroform solution containing a prescribed amount of chlorodiphenylmethane to form a Grignard reagent. Subsequently, a chloroform solution of 9-bromopentacene was slowly added to form 9-diphenylmethylpentacene. Subsequently, for example, NBS was used to brominate the 9-diphenylmethylpentacene, and a compound in which positions other than a 3-position were brominated was removed by extraction, to obtain 3-bromo-9-diphenylmethylpentacene. Further, chlorodi(tert-butyl)methoxysilane was dissolved in chloroform, and the solution was added to a chloroform solution containing the 3-bromo-9-diphenylmethylpentacene to react, to synthesize the title compound (yield 10%).

Regarding the resulting compound, infrared absorption was measured, and absorption of Si—O—C was seen at a wavelength of 1020 cm⁻¹. An ultraviolet visible absorption spectrum of a chloroform solution containing the compound was measured, and absorption was observed at a wavelengths of 605 nm.

Further, nuclear magnetic resonance (NMR) of the compound was measured.

(8.4 ppm to 8.2 ppm) (m) (2H: derived from pentacene skeleton)
(7.9 ppm to 7.5 ppm) (m) (20H: derived from pentacene skeleton and benzene ring of dially alkyl group)
(5.4 ppm to 5.3 ppm) (m) (1H: derived from ethyl group of diphenylethyl group)
(3.6 ppm to 3.5 ppm) (m) (3H: derived from methyl group of silyl group)
(1.5 ppm to 1.2 ppm) (m) (18H: derived from t-Bu group of silyl group)

From these results, it was confirmed that this compound is 3-di-t-butylmethoxysilyl-9-dimethylphenylpentacene.

Subsequently, formation of the organic thin film of the compound using a LB method is described. First, 3-di-t-butylmethoxysilyl-9-diphenylmethylpentacene was dissolved in a chloroform solvent, to make a 2 mM sample solution. Subsequently, a prescribed amount (100 μl) of a sample solution was added to a water surface in a trough, to form a monomolecular film (L film) of the compound. In this state, a pressure was applied to a water surface to adjust to a prescribed surface pressure (30 mN/cm²), and a substrate was pulled up at a constant rate to form a LB film.

Result of absorption measurement of the formed 3-di-t-butylmethoxysilyl-9-diphenylmethylpentacene organic thin film was confirmed that a pentacene skeleton is contained in the formed organic thin film, because it was consistent with absorption measurement of the compound. In addition, by ellipsometry measurement and AFM measurement, it was confirmed that a film thickness is average of about 2.0 nm. A molecular length of 3-di-t-butylmethoxysilyl-9-diphenylmethylpentacene is 2.3 nm. Therefor, it was confirmed that the formed organic thin film is a monomolecular layer, and has a tilt structure. In addition, it was confirmed by AFM measurement that a periodic component was not seen in the formed organic thin film. From this, it was confirmed that molecules are randomly oriented in the organic thin film.

### Example 9

### Synthesis of 2,3-di(di-t-butylmethoxysilyl)-6,8,11,13-tetra(N,N-diphenylamino)pentacene and formation of organic thin film using the compound

2,3-Di(di-t-butylmethoxysilyl)-6,8,11,13-tetra(N,N-diphenylamino)pentacene was synthesized by the following procedure. First, 1,2,4,5-tetrachlorobenzene was used as a starting raw material to synthesize the following intermediate according to the Route A5.

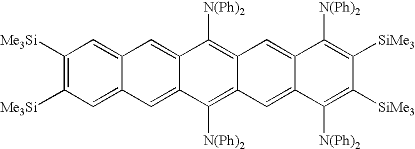

Then, according to the Route C3, a trimethylsilyl group was deprotected with quaternary ammonium, and this was synthesized with a silane compound to form 2,3-di(di-t-butylmethoxylsilyl)-6,8,11,13-tetra(N,N-diphenylamino)pentacene

More particularly, the compound was synthesized according to the following procedure as in Example 7. First, 2,3,6,7-tetra(trimethylsilyl)naphthalene synthesized in Preparation Example 2 was used as a starting raw material, and 2,3,7,8-tetra(trimethylsilyl)-6,9-(N,N-diphenylamino)-anthracene was synthesized according to the same procedure as the procedure for synthesizing 2,3,6,7-tetra(trimethylsilyl)naphthalene from 1,2,4,5-tetra(trimethylsilyl)benzene of Preparation Example 2 except that 2,5-(N,N-diphenylamino)-3,4-di(trimethylsilyl)furan was used in place of 3,4-di(trimethylsilyl)furan as a synthesizing procedure. Further, 2,3-di(trimethylsilyl)-6,9-(N,N-diphenylamino)tetracene was synthesized by applying the same procedure as the procedure for synthesizing 2,3,7,8-tetra(trimethylsilyl)-6,9-(N,N-diphenylamino)-anthracene from 2,3,6,7-tetra(trimethylsilyl)naphthalene of the present Example except that furan was used in place of 2,5-(N,N-diphenylamino)-3,4-di(trimethylsilyl)furan and, further, the same procedure as the procedure for synthesizing 2,3,7,8-tetra(trimethylsilyl)-6,9-(N,N-diphenylamino)-anthracene from 2,3,6,7-tetra(trimethylsilyl)naphthalene of the Present Example was applied again to synthesize 2,3,9,10-tetra(trimethylsilyl)-6,8,11,13-tetra(N,N-diphenylamino)pentacene represented by the structural formula. Subsequently, 1 mM 2,3,9,10-tetra(trimethylsilyl)-6,8,11,13-tetra(N,N-diphenylamino)pentacene was dissolved in a THF solvent containing a small amount of water and PhNMe₃F, and this was stirred to synthesize 6,8,11,13-tetra(N,N-diphenylamino)pentacene. Further, 5 ml of dry THF, 5 mM 6,8,11,13-tetra(N,N-diphenylamino)pentacene, and magnesium were added to a 200 ml egg plant flask under the nitrogen atmosphere, this was stirred for 1 hour to form a Grignard reagent, 5 mM chloro-di(tert-butyl)methoxysilane, and 30 ml of THF were charged into a 100 ml egg plant flask equipped with a stirrer, a refluxing condenser, a thermometer, and an addition funnel, this was ice-cooled, the Grignard reagent was added, and this was aged at 30° C. for 1 hour. Then, the reaction solution was filtered under reduced pressure to remove magnesium chloride, and THF and unreacted chlorodi(tert-butyl)methoxysilane were stripped from the filtrate to obtain the title compound at a yield of 10%.

Regarding the resulting compound, infrared absorption was measured, and absorption of Si—O—C was seen at a wavelength of 1025 cm⁻¹. An ultraviolet visible absorption spectrum of a chloroform solution containing the compound was measured, and absorption was observed at a wavelength of 615 nm.

Further, nuclear magnetic resonance (NMR) of the compound was measured.

(8.2 ppm) (s) (2H: derived from pentacene)

(8.0 ppm to 7.9 ppm) (m) (6H: derived from pentacene)

(7.2 ppm to 7.0 ppm) (m) (16H: derived from diphenylamino group)

(6.8 ppm to 6.3 ppm) (m) (24H: derived from pentacene)

(3.6 ppm to 3.5 ppm) (in) (6H: derived from methoxy group of silyl group)

(1.4 ppm to 1.3 ppm) (m) (36H: derived from t-Bu group of silyl group)

From these results, it was confirmed that this compound is 2,3-di(di-t-butylmethoxysilyl)-6,8,11,13-tetra(N,N-diphenylamino)pentacene.

Subsequently, Manufacturing Example of an organic thin film using the compound will be shown below. First, a quartz substrate was immersed in a mixed solution of hydrogen peroxide and concentrate sulfuric acid (mixing ratio 3:7) for 1 hour to hydrophilization-treat a surface of the quartz substrate. Thereafter, the resulting substrate was immersed in a 10 mM 2,3-di(di-t-butylmethoxysilyl)-6,8,11,13-tetra(N,N-diphenylamino)pentacene solution obtained by dissolving 2,3-di(di-t-butylmethoxysilyl)-6,8,11,13-tetra(N,N-diphenylamino)pentacene in a non-aqueous solvent (n-hexadecane) for 5 minutes under the inert atmosphere, slowly pulled up, and washed with a solvent to form a film on the quartz substrate.

The quartz substrate on which the film was formed was measured with an ultraviolet visible absorption spectrophotometer, and 610 nm resulting from an absorption wavelength of a pentacene skeleton which is a π electron conjugation system molecule was detected. From this, it was confirmed that the organic thin film containing a pentacene skeleton is formed in the formed organic thin film. In addition, by assessment of a film thickness by ellipsometry, 21.2 nm was obtained as the film thickness of the formed organic thin film. This is greater than a molecular length of the compound of the present invention. That is, when the organic thin film is formed using the compound by a chemical binding method, by formation of a hydrogen bond between a diphenylamino group and a hydroxyl group derived from a methoxy group, a multimolecular layer can be formed. In addition, it was confirmed by AFM measurement that a periodic component is not seen in the formed organic thin film. From this, it was confirmed that molecules are randomly oriented in the organic thin film.

### Example 10

### Synthesis of 2,8-(N,N-diphenylamino)5,11-di-trichlorosilyl-perylene and formation of organic thin film using the compound

2,8-(N,N-diphenylamino) 5,11-di-trichlorosilylperylene was synthesized by a procedure of the Route D4. That is, first, a prescribed amount of perylene was dissolved in an acetic acid solvent, and 2, 5, 8 and 11 positions were iodized with KI/KIO₃. Subsequently, after reacted with diphenylamino in 1,2-dichlorobenzene in the presence of copper, and this was further reacted with tetrachlorosilane to synthesize the compound.

More particularly, first, 50 mL of an acetic acid solution containing KI and KIO₃ was charged into a 100 mL egg plant flask, 50 mL perylene (e.g which can be purchased from KISHIDA CHEMICAL Co., Ltd at a purity of 99%) was added, and this was stirred for 3 hours, thereby, 2,5,8,11-tetraiodoperylene was synthesized. Subsequently, 10 mM anhydrous K₂CO₃, 0.5 mM copper (catalyst), and 18-crown-6 (1 mM) were charged into a 100 ml glass flask equipped with a stirrer, a refluxing condenser, a thermometer and an addition funnel, 20 mL of a dichloro benzene solution containing 10 mM 2,5,8,11-tetraiodoperylene and 20 mM phenylamine was added, and this was refluxed for 32 hours to progress a reaction. After the reaction, a catalyst and unreacted materials were removed by filtration, and distilled under reduced pressure to synthesize 2,8-(N,N-diphenylamino) 5,8-iodoperylene. Subsequently, 5 ml of dry THF, 5 mM 2,8-(N,N-diphenylamino)5,8-iodoperylene, and magnesium were added to a 200 ml egg plant flask under the nitrogen atmosphere, to form a Grignard reagent, 5 mM of tetrachlorosilane and 30 ml of THF were charged into a 100 ml egg plans flask equipped with a stirrer, a refluxing condenser, a thermometer, and an addition funnel, this was ice-cooled, the Grignard reagent was added, and this was aged at 30° C. for 2 hours. Then, the reaction solution was filtered under reduced pressure to remove magnesium chloride, and TH F and unreacted chloride(tert-butyl)trichlorosilane were stripped from the filtrate to obtain the title compound at a yield of 25%.

Regarding the formed 2,8-(N,N-diphenylamino) 5,11-di-trichlorosilyl-perylene, infrared absorption measurement, ultraviolet-visible absorption spectrum measurement, and NMR measurement were performed. Direct measurement of the resulting compound is impossible due to high reactivity of a compound. Therefor, the compound was reacted with ethanol (generation of hydrogen chloride was confirmed), chlorine at an end was converted into an ethoxy group, and measurement was performed. As a result, by infrared absorption measurement, absorption of Si—O—C was seen at a wavelength of 1030 cm⁻¹. In addition, from measurement of an ultraviolet-visible absorption spectrum, π→π* transition absorption was obtained at a wavelength 380 nm. Regarding results of NMR measurement, the followings results were obtained.

(8.0 ppm to 7.8 ppm) (m) (2H: derived from perylene skeleton)

(7.5 ppm to 7.3 ppm) (m) (8H: derived from perylene skeleton)

(7.1 ppm to 6.9 ppm) (m) (8H: derived from diphenylamino group)

(6.7 ppm to 6.3 ppm) (m) (12H: derived from diphenylamino group)

(3.8 ppm to 3.6 ppm) (m) (12H: derived from ethyl group of silyl group)

(1.5 to 1.4 ppm) (m) (18H: derived from methyl group of silyl group)

From these results, it was confirmed that this compound is 2,8-(N,N-diphenylamino) 5,11-di-trichlorosilyl-perylene.

Subsequently, an example of manufacturing an organic thin film using the compound will be shown below. First, a mica substrate was immersed in a mixed solution of hydrogen peroxide and concentrated sulfuric acid (mixing ratio 1:4) for 15 minutes, to hydrophilization-treat a surface of the mica substrate. Thereafter, the resulting substrate was immersed in a 1 mM 2,8-(N,N-diphenylamino)5,11-di-trichlorosilyl-perylene solution obtained by dissolving 2,8-(N,N-diphenylamino)5,11-di-trichlorosilyl-perylene in a non-aqueous solvent (N-hexadecane) for 10 minutes under the inert atmosphere, slowly pulled up, and washed with a solvent to form the film on the mica substrate.

The quartz substrate on which the film was formed was measured with an ultraviolet visible absorption spectrophotometer, and 380 nm resulting from an absorption wavelength of a perylene skeleton which is a π electron conjugation system molecule was detected. From this, it was confirmed that the organic thin film containing a perylene skeleton is formed on the formed organic thin film. In addition, the film thickness measured by ellipsometry was 10 nm. Thereby, it was confirmed that the organic thin film has a multimolecular layer structure. Further, also, it was confirmed by AFM measurement that a periodic component is not seen in the formed organic thin film. Thereby, it was confirmed that molecules are randomly oriented in the organic thin film.

### Comparative Example 1

Using 6,8,11,13-tetra(N,N-diphenylamino)pentacene obtained in Example 9, an organic thin film having a thickness of 10 nm was formed by a sputtering method.

(Solubility)

Solubility of organic silane compounds synthesized in Examples 7 to 10, and 6,8,11,13-tetra(N,N-diphenylamino)pentacene of Comparative Example 1 in an organic solvent was assessed. More particularly, 1 μml of each compound was added to 1 ml of the following organic solvent, and this was mixed for 15 minutes.

### Examples 7 to 8

### Chloroform

### Examples 9 to 10 and Comparative Example 1

### Toluene

Each of organic silane compounds of Examples 7 to 10 was dissolved in an organic solvent to obtain a transparent solution. A compound of Comparative Example 1 was only dispersed and not dissolved in an organic solvent, and a white cloudy solution was obtained.

(Binding to Substrate)

Organic thin films obtained in Examples 8 to 10 and Comparative Example 1 were tested by the following method.

Method; First, the organic thin film formed on the quartz substrate was immersed in an aqueous solution, and ultrasound washing was performed for 10 minutes. Subsequently, an ultraviolet-visible absorption spectrum of the organic thin film was measured, and the presence or the absence of a π→π* transition absorption wavelength inherent to a π electron conjugation system molecule was confirmed.

In organic thin films of Examples 8 to 10, it was confirmed that there is π→π* transition absorption at the same position before and after ultrasound washing. On the other hand, in the organic thin film of Comparative Example 1, it was confirmed that π→π* transition absorption confirmed before ultrasound washing is lost after ultrasound washing. Thereby, it was confirmed that durability of the organic silyl compound of the present invention is improved.

From Examples 7 to 10, the following items were made clear. Since the organic silane compound of the present invention has relatively high solubility, and has characteristic that it has high general-use in thin film formation utilizing a solution system, because it has the functional group and the silyl group. In addition, the organic silane compound of the present invention is chemically bound to the substrate firm, and it allows the thin film excellent in durability to be formed, because it has the silyl group. In addition, intermolecular interaction between adjacent molecules is reduced, because the organic silane compound of the present invention has a relatively great molecular volume of the functional group. As a result, crystallization does not occur, an amorphous film is formed. Therefore, for example, when utilized as an organic EL device, a high light emitting efficiency can be accompanied.

### Example 11

1,4,8-11-Tetranitro-2-di-t-butylethoxysilyl-pentacene was synthesized by the following procedure. That is, first, from 1, 2, 4, 5-tetrachlorobenzene, 2,3-di(trichlorosilyl) 6,7-dinitronaphthalene was synthesized, a protecting group such as a trimethylsilyl group was reacted with a nitro group, the number of acene skeletons was sequentially increased and, thereafter, the protecting group was deprotected to synthesize the title compound.

More particularly, 0.4M magnesium, 100 mL of HMPT (hexamethyl phosphorous triamide), 20 mL of THF, 12 (catalyst), and 0.1M 1,2,4,5-tetrabenzene (e.g. which can be purchased from KISHIDA CHEMICAL Co., Ltd. at a purity of 99%) were added to a 200 ml glass flask equipped with a stirrer, a refluxing condenser, a thermometer and an addition funnel, 0.4M chlorotrimethylsilane was added dropwise at a temperature of 80° C., and this was stirred for 30 minutes, and refluxed at 130° C. for 4 days to synthesize 1,2,4,5-tetra(trimethylsilyl)benzene. Subsequently, 20 mM i-PrNH, 50 mM PhI(OAc)((diacetoxyiodo)benzene), and 50 mL of dichloromethane were added to a 200 mL egg plant flask, 50 mM CF₃CO₂H(TfOH) was added dropwise at 0° C., and this was stirred for 2 hours. Subsequently, 10 mL of a dichloromethane solution containing 50 mM 1,2,4,5-tetra(trimethylsilyl)benzene was added dropwise at 0° C., and this was stirred at room temperature for 2 hours to synthesize phenyl [2,4,5-tris(trimethylsilyl)phenyl]iodonium triflate. Further, subsequently, a THF solution of 2.0M Bu₄NF was charged into a 50 mL egg plant flask, 10 mL of a dichloromethane solution containing 5 mM phenyl[2,4,5-tris(trimethylsilyl)phenyl]iodonium triflate and 10 mM 3,4-dinitrofurane was added dropwise at 0° C., and this was stirred for 30 minutes to progress the reaction. After completion of the reaction, the reaction was extracted with dichloromethane and water, and purified by column chromatography to synthesize a 1,4-dihydro-1,4-epoxynaphthalene derivative. Thereafter, 10 mL of a THF solution containing 1 mM lithium iodide, and 10 mM DBU (1,8-dizerbicyclo[5.4.0]undec-7-ene) was charged into a 50 ml glass flask equipped with a stirrer, a refluxing condenser, a thermometer and an addition funnel, 1 mM 1,4-dihydro-1,4-epoxynaphthalene derivative was added, and this was refluxed for 3 hours under the nitrogen atmosphere to progress the reaction. After completion of the reaction, extraction and water removal with MgSO₄ were performed to synthesize 2,3-di(trichlorosilyl) 6,7-dinitronaphthalene. Subsequently, 2,3-(trimethylsilyl)7,10-dinitrotetracene was synthesized by applying two times the same procedure as the procedure for synthesizing 2,3-di(trimethylsilyl) 6,7-dinitronaphthalene from 1,2,4,5-tetra(trimethylsilyl)benzene except that 3,4-di(trimethylsilyl)furan was used in place of 3,4-dinitrofuran. Further, subsequently, 2-(oxytrimethylsilyl) 3-(trimethylsilyl) 1,4,8,11-tetranitropentathene was synthesized by applying one time the same procedure as the procedure for synthesizing 2,3-di(trimethylsilyl) 6,7-dinitronaphthalene from 1,2,4,5-tetra(trimethylsilyl)benzene except that 3-(trimethylsilyl)4-(oxytrimethylsilyl)furan was used in place of 3,4-dinitrofuran, 1 mM 2-(oxytrimethylsilyl)3-(trimethylsilyl) 1,4,8,11-tetranitrobenzene was dissolved in a THF solvent containing a small amount of water and PhNMe₃F, and this was stirred to synthesize 2-hydroxy 1,4,8,11-tetranitropentacene. Further, 5 mM di(tert-butyl)ethoxysilane hydride and 30 ml of THF were charged into a 100 ml egg plant flask equipped with a stirrer, a refluxing condenser, a thermometer and an addition funnel under the nitrogen atmosphere, this was ice-cooled, 5 ml of dry THF, and 5 mM 2-hydroxyl,4,8,11-tetranitropentacene were added, and this was aged at 30° C. for 1 hour to synthesize 1,4,8,11-tetranitro-2-di-t-butylethoxysilyl-pentacene.

Regarding the resulting compound, infrared absorption was measured, and absorption of Si—O—C was seen at a wavelength of 1035 cm⁻¹. An ultraviolet-visible absorption spectrum of a chloroform solution containing the compound was measured, and absorption was observed at a wavelength of 605 nm.

Further, nuclear magnetic resonance (NMR) of the compound was measured.

(8.1 ppm to 8.0 ppm) (S) (1H: derived from pentacene)

(7.9 ppm to 7.8 ppm) (M) (8H: derived from pentacene)

(3.6 ppm to 3.5 ppm) (M) (6H: derived from ethyl of silyl group)

(1.4 ppm to 1.3 ppm) (M) (27H: derived from t-Bu group of silyl group and methyl group)

From these results, it was confirmed that this compound is 1,4,8,11-tetranitro-2-di-t-butylethoxysilyl-pentacene.

### Example 12

First, a glass substrate was ultrasound-washed in an organic solvent (e.g. acetone and isopropyl alcohol), and plasma ashing was performed at 100 W for 5 minutes. Subsequently, an ITO transparent electrode thin film was formed on this substrate at a thickness of 150 nm by a RF sputtering method, and this was patterned. In this state, this was introduced into a vacuum deposition apparatus, a pressure in a tank was reduced to 5.0×10⁻⁶ Torr, TPD as a hole transporting layer was deposited on the ITO transparent electrode at a thickness of 50 nm and, further, Alq3 as a light emitting layer was deposited on the hole transporting layer at a thickness of 50 nm. Subsequently, the substrate was immersed in a solution of hydrogen peroxide:sulfuric acid=1:4 for 15 minutes to hydrophilization-treat a surface. On the other hand, 3-di-t-butylmethoxysilyl-9-diphenylmethylpentacene obtained in Example 8 was dissolved in a chloroform solvent to make a 2 mM sample solution, subsequently, a prescribed amount (100 μl) of the sample solution was added dropwise to a water surface in a trough, to form a monomolecular film (L film) of the compound on the water surface. In this state, a pressure was applied to the water surface to obtain a prescribed surface pressure (30 mN/cm²), and a substrate on which the light emitting layer was laminated, and which had been pre-set was pulled up at a constant rate to form an electron transporting layer on the light emitting layer. Further, MgAg as a cathode was deposited on the electron transporting layer at a thickness of 200 nm to prepare an organic EL device.

In the thus constructed organic EL device, an electron transporting efficiency is high, because an interface between the light emitting layer and the electron transporting layer is bound firm via a chemical bond and, therefore, a driving voltage can be reduced. In the constructed organic EL device, maximum release of 3500 cd/m² was confirmed at an application voltage of 11.5V.

### Example 13

First, a glass substrate was ultrasound-washed in an organic solvent (e.g. acetone or isopropyl alcohol), and plasma ashing was performed at 100 W for 5 minutes. Subsequently, an ITO transparent electrode film was formed on this substrate at a thickness of 150 nm by a RF sputtering method, and patterned. Subsequently, the substrate was immersed in a solution of hydrogen peroxide:sulfuric acid=7:3 for 15 minutes to hydrophilization-treat a surface. On the other hand, 1,4,8,11-tetranitro-2-di-t-butylethoxysilyl-pentacene obtained in Example 11 was dissolved in a chloroform solvent to prepare a 2 mM sample solution, and the substrate on which an anode had been laminated was immersed to form a hole transporting layer on an anode. In this state, this was introduced into a vacuum deposition apparatus, a pressure in the interior of a tank was reduced to 7.0×10⁻⁶ Torr, and Alq3 as a light emitting layer was deposited on the hole transporting layer at a thickness of 50 nm. Further, MgAg as a cathode was deposited on the hole transporting layer at a thickness of 200 nm to manufacture an organic EL device.

In the thus constructed organic EL device, a hole transporting efficiency or an electron transporting efficiency is high, because particularly an interface between the anode and the hole transporting layer is bound firm via a chemical bond and, therefore, a driving voltage can be reduced. It was confirmed that the constructed organic EL device has maximum release of 3300 cd/m² at an application voltage of 12.0 V.

### Example 14

First, a glass substrate was ultrasound-washed in an organic solvent (e.g. acetone or isopropyl alcohol), and plasma ashing was performed at 100 W for 5 minutes. Subsequently, an ITO transparent electrode film was formed on this substrate at a thickness of 100 nm by a RF sputtering method, and this was patterned. In this state, this was introduced into a vacuum deposition apparatus, a pressure in the interior of a tank was reduced to 5.0×10⁻⁶ Torr, TPD as a hole transporting layer was deposited on the ITO transparent electrode at a thickness of 50 nm and, further, Alq3 as a light emitting layer was deposited on the hole transporting layer. Subsequently, the substrate was immersed in a solution of hydrogen peroxide:sulfuric acid=1:4 for 15 minutes to hydrophilization-treat a surface. On the other hand, 2,3-di(di-t-butylmethoxysilyl)-6,8,11,13-tetra(N,N-diphenylamine)pentacene obtained in Example 9 was dissolved in a chloroform solvent to make a 2 mM sample solution, subsequently, a prescribed amount (100 μl) of the sample solution was added dropwise to a water surface in a trough to form a monomolecular film (L film) of the compound on the water surface. In this state, a pressure was applied to the water surface to obtain a prescribed surface pressure (25 mN/cm²), and a substrate on which the light emitting layer had been laminated, and which had been pre-set was pulled up at a constant rate, to form an electron transporting layer on the light emitting layer. Further, MgAg as a cathode was deposited on the electron transporting layer at a thickness of 100 nm to manufacture an organic EL device.

In the thus constructed organic EL device, an electron transporting efficiency is high, because particularly an interface between the light emitting layer and the electron transporting layer is bound firm via a chemical bond and, therefore, a driving voltage can be reduced. It was confirmed that the constructed organic EL device has maximum release of 4500 cd/m² at an application voltage of 10.5V.

### Comparative Example 2

First, a glass substrate was ultrasound-washed in an organic solvent (e.g. acetone or isopropyl alcohol), and plasma ashing was performed at 100 W for 5 minutes. Subsequently, an ITO transparent electrode film was formed on this substrate at a thickness of 100 nm by a RF sputtering method, and this was patterned. In this state, this was introduced into a vacuum deposition apparatus, a pressure in a tank was reduced to 5.0×10⁻⁶ Torr, TPD as a hole transporting layer was deposited on the ITO transparent electrode at a thickness of 50 nm and, further, Alq3 as a light emitting layer was deposited on the hole transporting layer at a thickness of 50 nm. Subsequently, 6,8,11,13-tetra(N,N-diphenylamino)pentacene which is an intermediate of Example 9 was formed on the light emitting layer as the electron transporting layer at a thickness of 10 nm by a vacuum deposition method. Further, MgAg as a cathode was deposited on an electron transporting layer at a thickness of 100 nm to manufacture an organic EL device.

In the thus constructed organic EL device, light emission of 1000 Cd or more could not be confirmed in a range to an application voltage of 15.0V.

In the present Comparative Example, the light emitting layer and the electron transporting layer are bound via physical adsorption, and a cause is ineffective electron transparence. That is, when layers are chemically bound as in the organic EL device of the present invention, it was confirmed that a high light emitting efficiency is obtained at a low application voltage.

### Example 15

In the following Examples, a linear alkyl unit is expressed by its carbon number. For example, an octadecyl group is indicated as C18. In addition, the compound of the formula (1) is indicated as R¹[R²]Pn[R³]R⁴. In addition, for describing a name of an intermediate, the number of each reaction site of pentacene is as in the following formula. Therefore, for example, Si(OCH₃)₃[H]P5[H]C18 is described as 2-(trimethoxysilano)-14-octadecyl-pentacene.

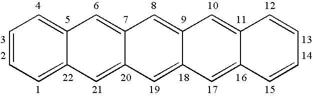

First, a method of synthesizing a brominated material which is a precursor of organic silane compounds to be synthesized in Examples 15-1 to 15-5 will be shown below.

### Synthesis Example 1

### Synthesis of 9-bromotetracene, 9,10-dibromopentacene

9-Bromotetracene was synthesized by the following procedure. First, 1 mM tetracene and NBS dissolved in 50 mL of carbon tetrachloride were added to a 100 ml egg plant flask equipped with a stirrer, a refluxing condenser, a thermometer and an addition funnel, and this was reacted for 1.5 hours in the presence of AIBN. Unreacted materials and HBr were removed by filtration, and an accumulated material in which only one place was brominated was taken out using column chromatography to obtain the title 9-bromotetracene.

### Synthesis Example 2

### 9,10-Dibromopentacene

9,10-Dibromopentacene was synthesized by the following procedure. First, dissolved 1 mM tetracene and NCS were added to a 100 ml egg plant flask equipped with a stirrer, a refluxing condenser, a thermometer and an addition funnel, and this was reacted for 10 hours in the presence of AIBN. Unreacted materials and HBr were removed by filtration, and an accumulated material in which four places were chlorinated was taken out using column chromatography to obtain 2,3,9,10-tetrachlorotetracene.

Subsequently, 0.4M magnesium, 100 mL of HMPT (hexamethyl phosphorous triamide), 20 mL of THF, 12 (catalyst), and 0.1M 2,3,9,10-tetrachlorotetracene were added to a 200 ml glass flask equipped with a stirrer, a refluxing condenser, a thermometer and an addition funnel, 0.4M chloromethylsilane was added dropwise at a temperature of 80° C., and this was stirred for 30 minutes, and refluxed at 130° C. for 4 days to synthesize 2,3,9,10-tetra(trimethylsilyl)tetracene.

Subsequently, 20 mM i-PrNH, 50 mM PhI(OAc)₂((diacetoxyiodo)benzene), and 50 mL of dichloromethane were added to a 200 mL egg plant flask, 50 mM CF₃CO₂H(TfOH) was added dropwise at 0° C., and this was stirred for 2 hours. Subsequently, 10 mL of a dichloromethane solution containing 50 mM 2,3,9,10-tetra(trimethylsilyl)tetracene was added dropwise at 0° C., and this was stirred at room temperature for 2 hours to synthesize phenyl[2,3,9-tris(trimethylsilyl)tetracenyl]iodonium triflate. Further, subsequently, a THF solution of 2.0M Bu₄NF was charged into a 50 mL egg plant flask, 10 mL of a dichloromethane solution containing 5 mM phenyl[2,3,9-tris(trimethylsilyl) tetracenyl]iodonium triflate and 10 mM 3,4-di(oxitrimethylsilyl)furan was added dropwise at 0° C., and this was stirred for 30 minutes to progress the reaction. After completion of the reaction, the reaction was extracted with dichloromethane and water, and purified by column chromatography to synthesize a 1,4-dihydro-1,4-epoxypentacene derivative. Thereafter, 10 mL of a THF solution containing 1 mM lithium iodide, and 10 mM DBU (1,8-diazabicyclo[5.4.0]undec-7-ene) was charged into a 50 ml glass flask equipped with a stirrer, a refluxing condenser, a thermometer and an addition funnel, 1 mM 1,4-dihydro-1,4-epoxypentathene derivative was added, and this was refluxed for 3 hours under the nitrogen atmosphere to progress the reaction. After completion of the reaction, extraction and water removal with MgSO₄ were performed to synthesize 9,10-dihydropentacene. Further, 0.1 mM 9,10-dihydroxypentacene and NBS were charged into a 50 ml glass flask equipped with a stirrer, a refluxing condenser, a thermometer and an addition funnel, AIBN was added, and this was stirred for 2 hours to synthesize the title 9,10-dibromopentacene.

### Synthesis Example 3

### Synthesis of 11,12-dibromoheptacene

11,12-Dibromoheptacene was synthesized by the following procedure using, as a starting raw material, 2,3,9,10-tetra(trimethylsilyl)tetracene in Synthesis Example 2. That is, first, 2,3,10,11-tetra(trimethylsilyl)hexacene was synthesized by applying two times the same procedure as the procedure for synthesizing 9,10-dihydroxypentacene from 2,3,9,10-tetra(trimethylsilyl)tetracene in, Synthesis Example 2 except that 3,4-di(trimethylsilyl)furan was used in place of 3,4-di(oxytrimethylsilyl)furan. Further, by applying one time the same procedure as the procedure for synthesizing 9,10-dibromopentacene from 2,3,9,10-tetra(trimethylsilyl)tetracene in Synthesis Example 2, 11,12-dibromoheptacene was obtained.

### Synthesis Example 4

### Synthesis of 13,14-dibromononacene

According to the same procedure as that of Synthesis Example 3 except that the same procedure as the procedure for synthesizing 9,10-dihydroxypentacene from 2,3,9,10-tetra(trimethylsilyl)tetracene was applied not two times but four times, 13,14-dibromononacene was synthesized.

### Example 15-1

### Synthesis of Si(OC₂H₅)₃[H]P4[H]C18 and Formation of thin Film Using the Compound

Si(OC₂H₅)₃[H]P4[H]C18 was synthesized by the following procedure.

First, magnesium was added to, for example, a chloroform solution containing a prescribed amount of 1-bromooctadecane to form a Grignard reagent. Subsequently, a chloroform solution of 9-bromotetracene of Synthesis Example 1 was added slowly to form 9-octadecyltetracene. Subsequently, for example, NBS was used to brominate the intermediate, and a compound in which positions other than a 3-position were brominated was extracted to remove it, to obtain 3-bromo-9-octadecyltetracne. Further, H—Si(OC₂H₅)₃ was dissolved in chloroform, and the solution was added to a chloroform solution containing 3-bromo-9-octadecyltetracene to react the materials, to synthesize Si(OC₂H₅)₃[H]P4[H]C18 (yield 10%).

Regarding the resulting compound, infrared absorption was measured, and absorption of Si—O—C was seen at a wavelength of 1050 nm⁻¹. From this, it was confirmed that the resulting compound contains a silyl group. An ultraviolet-visible absorption spectrum of a chloroform solution containing the compound was measured, and absorption was observed at a wavelength of 4.81 nm. This absorption results from π→π* transition of a tetracene skeleton contained in a molecule, and it was confirmed that the compound contains a tetracene skeleton.

Further, nuclear magnetic resonance (NMR) of the compound was measured.

7.80 ppm to 7.30 ppm (m) (20H derived from aromatic)
2.80 ppm to 1.30 ppm (m) (52H derived from methylene and methyl group (hydrogen atom contained in octadecyl group and ethyl group))

From these results, it was confirmed that this compound is Si(OC₂H₅)₃[H]P4[H]C18.

Subsequently, using a chemical binding method, a functional organic thin film using Si(OC₂H₅)₃[H]P4[H]C18 was formed.

First, a quartz substrate was immersed in a mixed solution of hydrogen peroxide and concentrated sulfuric acid (mixing ratio 3:7) for 1 hour to hydrophilization-treat a surface of the quartz substrate. Thereafter, the resulting substrate was immersed in a non-aqueous solvent (e.g. toluene) containing 2 mM Si(OC₂H₅)₃[H]P4[H]C18 for 10 minutes under the inert atmosphere, pulled up slowly, and washed with a solvent to form a functional organic thin film of Si(OC₂H₅)₃[H]P4[H]C18 on the quartz substrate. By measurement of the formed functional organic thin film with atomic force microscope (AFM), it was confirmed that a difference in a height is about 32.5 nm. In addition, by AFM measurement and electron beam diffraction (ED) measurement, a periodic structure of the compound was observed on the thin film, and it was confirmed that an oriented film of the compound is formed.

### Example 15-2

### Synthesis of Si(OC₂H₅)₃[Si(OC₂H₅)₃]P5[C18]C18 and Formation of Thin Film Using the Compound

Si(OC₂H₅)₃[Si(OC₂H₅)₃]P5[C18]C8 was synthesized by the following procedure as in Example 15-1.

First, magnesium was added to, for example, a chloroform solution containing a prescribed amount of 1-bromooctadecane as in Example 15-1 to form a Grignard reagent. Subsequently, a chloroform solution of 9,10-dibomopentacene of Synthesis Example 2 was slowly added to form 9,10-dioctadecylpentacene. Subsequently, for example, NBS was used to brominated the intermediate, and a compound in which positions other than 2,3-positions were brominated was extracted to remove, to obtain 2,3-dibromo-9,10-dioctadecylpentacene. Further, H—Si(OC₂H₅)₃ was dissolved in chloroform, and the solution was added to a chloroform solution of 2,3-dibromo-9,10-dioctadecylpentacene to react the materials, to synthesize Si(OC₂H₅)₃[Si(OC₂H₅)₃]P5[C18]C18 (yield 7%).

In addition, by the same assessment as that of Example 15-1, it was confirmed that the resulting compound is Si(OC₂H₅)₃[Si(OC₂H₁₅)₃]P5[C18]C18.

Subsequently, a method of forming an organic thin film of the compound using a LB method will be described.

First, the Si(OC₂H₅)₃[Si(OC₂H₅)₃]P5[C18]C18 was dissolved, for example, in a chloroform solvent to make a 2 mM sample solution. Subsequently, a prescribed amount (e.g. 100 μl) of the sample solution was added dropwise to a water surface in a trough to form a monomolecular film (L film) of the compound on the water surface. In this state, a pressure was applied to the water surface to obtain a prescribed surface pressure (e.g. 30 mN/cm²), and a substrate which had been immersed in water was pulled up at a constant rate to form a LB film.

By AFM measurement of the formed thin film of Si(OC₂H₁₅)₃[Si(OC₂H₅)₃]P5[C18]C18, it was confirmed that a difference in a height is about 36.2 nm. In addition, by AFM measurement and ED measurement, a periodic structure of the compound was observed on the thin film. As a result, it was confirmed that an oriented film of the compound is formed.

### Example 15-3

### Manufacturing of Organic TFT Using Thin Film of Si(OC₂H₅)₃[Si(OC₂H₅)₃]P5[C18]C18 as Organic Semiconductor Layer

First, chromium was deposited on a substrate 24 comprising mica to form a gate electrode 25. Then, a gate insulating film 26 of a silicon nitride film was deposited by a plasma CVD method, chromium and gold were sequentially deposited, and a source electrode 27 and a drain electrode 28 were formed by the normal lithography technique. Subsequently, using Si(OC₂H₅)₃[Si(OC₂H₅)₃]P5[C18]C18 obtained in Example 15-2, an organic semiconductor layer 29 was formed on the resulting substrate as in Example 15-3 to obtain organic TFT shown in FIG. 7.

The resulting organic semiconductor layer 29 is characterized in that durability is high because a π electron conjugation system molecule is bound to a substrate via a chemical bond, and an upper part is protected with an alkyl group. Therefore, durability of TFT itself is also enhanced.

Property of the resulting organic TFT is shown in FIG. 8. From this result, organic TFT of Example 15-3 had a field-effect mobility of 2.1×10⁻¹ cm²/Vs, and an on/off ratio of about 6 digit and, thus, had better performance.

### Example 15-4

### Manufacturing of Organic Thin Film Transistor Using Si(OC₂H₅)₃[Si(OC₂H₅)₃]P7[C15]C15

According to the same manner as that of Example 15-2 except that dibromoheptacene of Synthesis Example 3 was used in place of dibromopentacene of Synthesis Example 2, Si(OC₂H₅)₃[Si(OC₂H₅)₃]P7[C15]C15 was obtained. According to the same manner as that of Example 15-3 except that the above organic silane compound was used, organic TFT was obtained.

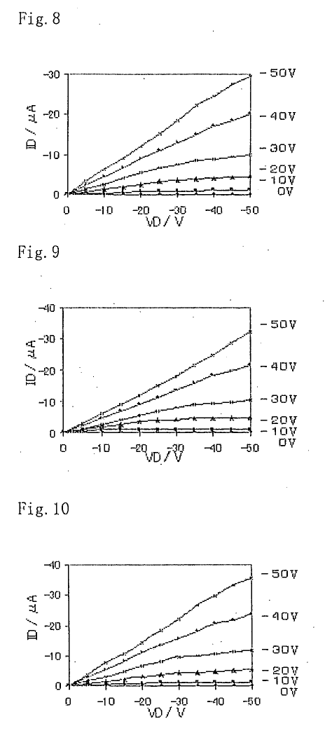

Property of the resulting organic TFT is shown in FIG. 9. From this result, organic TFT of Example 15-4 had a field-effect mobility of 2.3×10⁻¹ cm²/Vs, and an on/off ratio of about 6 digit and, therefore, had better performance.

### Example 15-5

### Manufacturing of Organic Thin Film Transistor Using Si(OCH₃)₃[Si(OCH₃)₃]P9[C21]C21

According to the same manner as that of Example 15-2 except that dibromononacene of Synthesis Example 4 was used in place of dibromopentacene of Synthesis Example 2, 1-bromohenicocene was used in place of 1-bromooctadecane, and H—Si(OCH₃)₃ was used in place of H—Si(OC₂H₅)₃, Si(OCH₃)₃[Si(OCH₃)₃]P9[C21]C21 was obtained. According to the same manner as that of Example 15-3 except that the above organic silane compound was used, organic TFT was obtained.

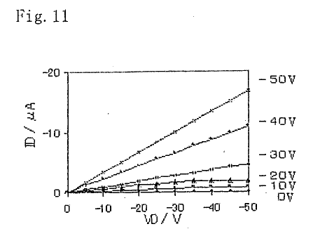

Property of the resulting organic TFT is shown in FIG. 10. From this result, organic TFT of Example 15-5 had a field-effect mobility of 2.7×10⁻¹ cm²/Vs, and an on/off ratio of about 6 digit and, therefore, had better performance.

### Example 15-6

### Synthesis of 2-(tert-butyl)8-trichlorosilylperylene and manufacturing of organic thin film transistor using the compound

2-(Tert-butyl)8-trichlorosilylperylene was synthesized by the following procedure. First, 20 mM perylene and NBS dissolved in 50 mL of carbon tetrachloride were charged in a 100 ml egg plant flask equipped with a stirrer, a refluxing condenser, a thermometer and an addition funnel, AIBN was added, and this was refluxed for 2.5 hours to synthesize 2,8-dibromoperylene. Subsequently, 2,8-dibromoperylene and (CH₃)₃CMgBr were dissolved in 30 mL of diethyl ether, the solution was added to a 100 ml egg plant flask equipped with a stirrer, a refluxing condenser, a thermometer and an addition funnel, and this was refluxed for 5 hours under the nitrogen atmosphere to synthesize 2-(tert-butyl)8-bromoperylene. Further, 5 ml of dry THF, 5 mM 2-(tert-butyl)8-bromoperylene, and magnesium were added to a 200 ml egg plant flask under the nitrogen atmosphere, this was stirred for 1 hour to form a Grignard reagent, 5 mM tetrachlorosilane and 30 ml of THF were charged into a 100 ml egg plant flask equipped with a stirrer, a refluxing condenser, a thermometer and an addition funnel, this was ice-cooled, the Grignard reagent was added, and this was aged at 30° C. for 2 hours. Then, the reaction solution was filtered under reduced pressure to remove magnesium chloride, and THF and unreacted chlorodi(tert-butyl)methoxysilane were stripped from the filtrate to obtain the title 2-(tert-butyl)8-trichlorosilylperylene at a yield of 15%.

Regarding the synthesized 2-(tert-butyl)8-trichlorosilylperylene, infrared absorption measurement, ultraviolet-visible absorption measurement, and NMR measurement were performed. Direct measurement of the resulting compound is impossible due to high reactivity of the compound. Therefor, the compound was reacted with ethanol (generation of hydrogen chloride was confirmed), chlorine at an end was converted into an ethoxy group, and measurement was performed. As a result, by infrared absorption measurement, absorption of Si—O—C was seen at a wavelength of 1030 cm⁻¹. In addition, by ultraviolet-visible absorption spectrum measurement, π→π* transition absorption at a wavelength of 380 nm was obtained. Regarding results of NMR measurement, the following results were obtained.

(8.0 ppm˜7.8 ppm) (m) (2H: derived from perylene skeleton)

(7.5 ppm˜7.3 ppm) (m) (8H: derived from perylene skeleton)

(3.8 ppm˜3.6 ppm) (m) (6H: derived from ethyl group of silyl group)

(1.5 ppm˜1.4 ppm) (m) (18H: derived from methyl group of silyl group and tert-butyl group)

From these results, it was confirmed that this compound is 2-(tert-butyl)8-trichlorosilylperylene.

According to the same manner as that of Example 15-3 except that the above organic silane compound was used, organic TFT was obtained.

Property of the resulting organic TFT is shown in FIG. 11. From this result, organic TFT of Example 6 had a field-effect mobility of 1.1×10⁻¹ cm²/Vs, and an on/off ratio of about 6 digit and, therefore, had better performance.

In Examples 15-1, 2 and 4 to 6, methods of synthesizing Si(OC₂H₅)₃[H]P4[H]C18, Si(OC₂H₅)₃[Si(OC₂H₅)₃]P5[C18]C18, Si(OC₂H₅)₃[Si(OC₂H₅)₃]P7[C15]C15, Si(OCH₃)₃[Si(OCH₃)₃]P9[C21]C21, and 2-(tert-butyl)8-trichlorosilylperylene were shown. In addition, in Examples 15-1 and 2, a method of forming a thin film using Si(OC₂H₅)₃[H]P4[H]C18 and Si(OC₂H₅)₃[Si(OC₂H₅)₃]P5[C18]C18 was shown. In Examples 15-3 to 6, organic TFT using Si(OC₂H₅)₃[Si(OC₂H₅)₃]P5[C18]C18, Si(OC₂H₅)₃[Si(OC₂H₅)₃]P7[C15]C15, Si(OCH₃)₃[Si(OCH₃)₃]P9[C21]C21, and 2-(tert-butyl)8-trichlorosilylperylene were shown.

However, these Examples are not limited to only the above compounds, but other organic silane compounds of the present invention can be produced by the same method as that of Examples 15-1, 2 and 4 to 6. In addition, the organic silane compounds of the present invention other than Examples 15-1 and 2 can be made into a thin film by the same method as that of these Examples. In addition, organic silence compounds of the present invention other than Examples 15-4 to 6 can be also made into organic TFT by the same method as that of these Examples.

Further, as in Example 15-2, the thin film using the organic silane compound of the present invention has high orienting property, and acene skeletons exerting electrical conductivity are not bound in a direction parallel to a substrate surface. For this reason, the thin film can be used as a semiconductor layer of organic TFT as in Example 15-3 and, in that case, organic TFT having high mobility, and having high property capable of suppressing a leak current is obtained.

### Example 16-1

### Synthesis of Organic Silane Compound Represented by the Following Formula (a)

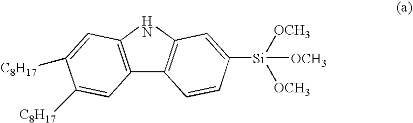

The above compound was synthesized by the following procedure.

First, a carbon tetrachloride solution containing 0.1 M carbazole (CAS 86-74-8) was added to a 100 ml egg plant flask equipped with a stirrer, a refluxing condenser, a thermometer and an addition funnel, NBS was charged therein, and AIBN was added, and this was refluxed for 5 hours to synthesize 6,7-dibromocarbazole. Subsequently, 0.05 M 6,7-dibromocarbazole and 0.1 M CH₃(CH₂)₇MgBr were dissolved in 30 mL of diethyl ether, the solution was added to a 100 ml of egg plant flask equipped with a stirrer, a refluxing condenser, a thermometer and an addition funnel, and this was refluxed for 5 hours under the nitrogen atmosphere to synthesize 6,7-dioctylcarbazole. Subsequently, the 6,7-dioctylcarbazole was added to a 100 ml egg plant flask equipped with a stirrer, a refluxing condenser, a thermometer and an addition funnel, NBS was charged therein, AIBN was added, this was refluxed for 2.5 hours to form 3-bromo-6,7-dioctylcarbazole, 0.02 M trimethoxychlorosilane was further added, and this was refluxed for 6 hours to synthesize the title 2-trimethoxysilyl-6,7-dioctylcarbazole.

By infrared absorption measurement of the title compound, absorption of Si—O—C was seen at a wavelength of 1030 cm⁻¹. In addition, regarding results of NMR measurement, the following results were obtained.

8.5 ppm (1H: derived from hydrogen directly binding to N of carbazole)

7.4 ppm (3H: derived from carbazole)

7.2 ppm (1H: derived from carbazole)

7.0 ppm (1H: derived from carbazole)

3.6 ppm (9H: derived from methyl group of silyl group)

2.6 ppm (4H: derived from octyl group)

1.6 ppm (4H: derived from octyl group)

1.3 ppm (16H: derived from octyl group)

1.2 ppm (6H: derived from octyl group)

From the above results, it was confirmed that the synthesized compound is the title compound.

### Example 16-2

### Synthesis of Organic Silane Compound Represented by the Following Formula (b)

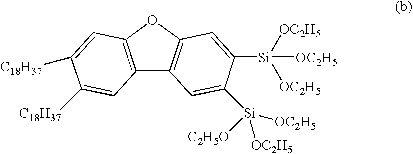

The above compound was synthesized by the following procedure.

First, by applying the same procedure as that of Example 16-1 except that 0.1 M dibenzofuran (CAS 132-641-9) was used as a starting material, dibenzofuran was used in place of carbazole, and CH₃(CH₂)₁₇MgBr was used in place of (CH₃)(CH₂)₇MgBr, 6,7-dioctadecyl-dibenzofuran was synthesized. Subsequently, the 6,7-dioctadecyl-dibenzofuran was added to a 100 ml egg plant flask equipped with a stirrer, a refluxing condenser, a thermometer and an addition funnel, NBS was charged therein, AIBN was added, this was refluxed for 7 hours to form 2,3-dibromo-6,7-dioctadecyl-dibenzofuran, 0.04 M triethoxychlorosilane was further added, and this was refluxed for 6 hours to synthesize the title 2-triethoxysilyl-6,7-dioctadecyl-dibenzofuran.

By infrared absorption measurement of the title compound, absorption of Si—O—C was seen at a wavelength of 1020 cm⁻¹. In addition, regarding results of NMR measurement, the following results were obtained.

7.4 ppm (2H: derived from dibenzofuran)

7.2 ppm (2H: derived from dibenzofuran)

3.8 ppm (12H: derived from methylene group of silyl group)

2.6 ppm (4H: derived from octadecyl group)

1.6 ppm (4H: derived from octadecyl group)

1.3 ppm (56H: derived from octadecyl group)

1.2 ppm (24H: derived from octadecyl group and methyl group of silyl group)

From the above results, it was confirmed that the synthesized compound is the title compound.

### Example 16-3

### Synthesis of Organic Silane Compound Represented by the Following Structural Formula (c)

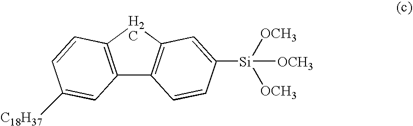

The above compound was synthesized by the following procedure.

First, a carbon tetrachloride solution containing 0.1 M fluorene (CAS 86-73-7) was added to a 100 ml egg plant flask equipped with a stirrer, a refluxing condenser, a thermometer, and an addition funnel, NBS was charged therein, AIBN was added, and this was refluxed for 2.5 hours to synthesize 6-bromofluorene. Subsequently, 0.05 M 6-bromofluorene and 0.05 M CH₃(CH₂)₁₇MgBr were dissolved in 30 mL of diethyl ether, the solution was added to a 100 ml egg plant flask equipped with a stirrer, a refluxing condenser, a thermometer and an addition funnel, and this was refluxed for 5 hours under the nitrogen atmosphere to synthesize 6-octadecylfluorene. Subsequently, the 6-octadecylfluorene was added to a 100 ml egg plant flask equipped with a stirrer, a refluxing condenser, a thermometer and an addition funnel, NBS was charged therein, AIBN was added, this was refluxed for 2.5 hours to form 3-bromo-6-octadecylfluorene, 0.01 M trimethoxychlorosilane was further added, and this was refluxed for 4 hours to synthesize the title 2-trimethoxysilyl-6-octadecylfluorene.

By infrared absorption measurement of the title compound, absorption of Si—O—C was seen at a wavelength of 1025 cm⁻¹. In addition, regarding results of NMR measurement, the following results were obtained.

7.6 ppm (4H: derived from fluorene)

7.4 ppm (2H: derived from fluorene)

3.8 ppm (10H: derived from methylene group of silyl group and fluorene)

2.6 ppm (2H: derived from octadecyl group)

1.6 ppm (2H: derived from octadecyl group)

1.3 ppm (30H: derived from octadecyl group)

1.2 ppm (3H: derived from octadecyl group)

From the above results, it was confirmed that the synthesized compound is the title compound.

### Example 16-4

### Synthesis of Organic Silane Compound Represented by the Following Structural Formula (d)

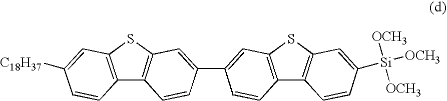

The above compound was synthesized by the following procedure.

According to the same procedure as that of Example 16-3 except that dibenzothiophene (CAS 132-65-0) was used in place of fluorene, 6-bromodibenzothiophene and 2-bromo-6-octadecyl-dibenzothiophene were synthesized.

Subsequently, a carbon tetrachloride solution of the 6-bromodibenzothiophene was added to a 100 ml egg plant flask to which a metal magnesium had been added, this was refluxed for 2 hours to form a Grignard reagent, a carbon tetrachloride solution of 2-bromo-6-octadecyl-dibenzothiophene was added to a 100 ml egg plant flask equipped with a stirrer, a refluxing condenser, a thermometer and an addition funnel, and this was refluxed for 5 hours under the nitrogen atmosphere to synthesize a dimer. Further, the dimer was added to a 100 ml egg plant flask equipped with a stirrer, a refluxing condenser, a thermometer and an addition funnel, NBS was charged therein, AIBN was added, this was refluxed for 2.5 hours to brominate the material, 0.01 M trimethoxychlorosilane was added, and this was refluxed for 4 hours to synthesize the title compound.

By infrared absorption measurement of the title compound, absorption of Si—O—C was seen at a wavelength of 1020 cm⁻¹. In addition, regarding results of NMR measurement, the following results were obtained.

8.0 ppm (2H: derived from dibenzothiophene group)

7.8 ppm (5H: derived from dibenzothiophene group)

7.5 ppm (3H: derived from dibenzothiophene group)

7.2 ppm (2H: derived from dibenzothiophene group)

3.6 ppm (9H: derived from methyl group of silyl group)

2.6 ppm (2H: derived from octadecyl group)

1.6 ppm (2H: derived from octadecyl group)

1.3 ppm (30H: derived from octadecyl group)

1.2 ppm (3H: derived from octadecyl group)

From the above results, it was confirmed that the synthesized compound is the title compound.

### Preparation Example 3

### Synthesis of Pentaphene

Pentaphene to be used in Example 16-5 was synthesized by the following procedure.

First, dissolved 1 mM phenanthrene (CAS 85-01-8) and NCS were added to a 100 ml egg plant flask equipped with a stirrer, a refluxing condenser, a thermometer and an addition funnel, and this was reacted for 10 hours in the presence of AIBN. Unreacted materials and HBr were removed by filtration, and an accumulated material in which four places were chlorinated was taken out using column chromatography to obtain 2,3,6,7-tetrachlorophenanthrene.

Subsequently, 0.4 M magnesium, 100 mL of HMPT (hexamethyl-phosphorous triamide), 20 mL of THF, 12 (catalyst), and 0.1 M 2,3,9,10-tetrachlorophenanthrene were added to a 200 ml glass flask equipped with a stirrer, a refluxing condenser, a thermometer and an addition funnel, 0.4 M chlorotrimethylsilane was added dropwise at a temperature of 80° C., and this was stirred for 30 minutes, and refluxed at 130° C. for 4 days to synthesize 2,3,6,7-tetra(trimethylsilyl)phenanthrene.

Subsequently, 40 mM i-PrNH, 100 mM PhI(OAc)₂ ((diacetoxyiodo)benzene), and 100 mL of dichloromethane were added to a 200 mL egg plant flask, 100 mM CF₃CO₂H(T_{f}OH) was added dropwise at 0° C., and this was stirred for 2 hours. Subsequently, 10 mL of a dichloromethane solution containing 50 mM 2,3,6,7-tetra(trimethylsilyl)phenanthrene was added dropwise at 0° C., and this was stirred at room temperature for 2 hours to synthesize triflate. Further, subsequently, a THF solution of 2.0 M Bu₄NF was charged into a 50 mL egg plant flask, 10 mL of a dichloromethane solution containing 5 mM triflate and 20 mM 3,4-di(oxytrimethylsilyl)furan was added dropwise at 0° C., and this was stirred for 2 hours to progress the reaction. After the completion of the reaction, the reaction was extracted with dichloromethane and water, and purified by column chromatography, 1 mM of this was introduced into a 50 ml glass flask equipped with a stirrer, a refluxing condenser, a thermometer and an addition funnel, containing 10 mL of a THF solution containing 1 mM lithium iodide and 10 mM DBU (1,8-diazabicyclo[5.4.0]undec-7-ene), and this was refluxed for 3 hours under the nitrogen atmosphere to progress the reaction. After completion of the reaction, extraction and water removal with MgSO₄ were performed to synthesize pentaphene.

### Example 16-5

### Synthesis of Organic Silane Compound Represented by the Following Structural Formula (e)

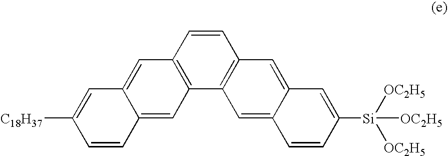

The above compound was synthesized by the following procedure using pentaphene synthesized in Preparation Example 3.

First, according to the same procedure as that of Example 9 except that pentaphene was used in place of fluorene, 10-octadecylpentaphene, and 3-bromo-10-octadecylpentaphene were synthesized. Further, this was reacted with triethoxychlorosilane as in Example 16-4 to synthesize the title compound.

By infrared absorption measurement of the title compound, absorption of Si—O—C was seen at a wavelength of 1020 cm⁻¹. In addition, regarding results of NMR measurement, the following results were obtained.

8.3 ppm (4H: derived from pentaphene)

7.9 ppm (5H: derived from pentaphene)

7.4 ppm (2H: derived from pentaphene)

7.2 ppm (1H: derived from pentaphene)

3.8 ppm (6H: derived from methylene group of silyl group)

2.6 ppm (2H: derived from octadecyl group)

1.6 ppm (2H: derived from octadecyl group)

1.3 ppm (30H: derived from octadecyl group)

1.2 ppm (12H: derived from octadecyl group and methyl group of silyl group)

From the above results, it was confirmed that the synthesized compound is the title compound.

### Example 16-6

### Synthesis of Organic Silane Compound Represented by the Following Structural Formula (f)

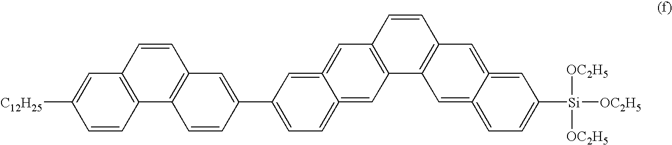

The above compound was synthesized by the following procedure. A carbon tetrachloride solution containing 0.1 M phenanthrene was added to a 100 ml egg plant flask equipped with a stirrer, a refluxing condenser, a thermometer and an addition funnel, NBS was charged therein, AIBN was added, and this was refluxed for 2.5 hours to synthesize 2-bromophenanthrene. Subsequently, 0.05 M 2-bromophenanthrene and 0.05 M CH₃(CH₂)₁₁MgBr were dissolved in 30 mL of diethyl ether, the solution was added to a 100 ml of egg plant flask equipped with a stirrer, a refluxing condenser, a thermometer, an addition funnel, and this was refluxed for 5 hours under the nitrogen atmosphere to synthesize 2-bromophenanthrene. Subsequently, a carbon tetrachloride solution of the 2-bromophenanthrene was added to a 100 ml egg plant flask containing a metal magnesium, this was refluxed for 2 hours to form a Grignard reagent, a carbon tetrachloride solution of 10-bromo-pentaphenone which is an intermediate of Example 16-5 was further added to a 100 ml egg plant flask equipped with a stirrer, a refluxing condenser, a thermometer, and an addition funnel, and this was refluxed for 5 hours under the nitrogen atmosphere to dimerize it. Further, the dimer was added to a 100 ml egg plant flask equipped with a stirrer, a refluxing condenser, a thermometer, and an addition funnel, NBS was charged therein, AIBN was added, this was refluxed for 2.5 hours to brominate, 0.01 M triethoxychlorosilane was added, and this was refluxed for 4 hours to synthesize the title compound.

By infrared absorption measurement of the compound, absorption of Si—O—C was seen at a wavelength of 1020 cm⁻¹. In addition, regarding results of NMR measurement, the following results were obtained.

8.5 ppm (2H: derived from phenanthrene group)

8.3 ppm (5H: derived from phenanthrene group and pentaphenone group)

8.1 ppm (3H: derived from pentaphene group)

7.9 ppm (3H: derived from phenanthrene group and pentaphene group)

7.7 ppm (3H: derived from phenanthrene group and pentaphene group)

7.6 ppm (1H: derived from pentaphene group)

7.5 ppm (21H: derived from pentaphene group)

3.8 ppm (6H: derived from methylene group of silyl)

2.6 ppm (21H: derived from dodecyl group)

1.6 ppm (2H: derived from dodecyl group)

1.3 ppm (18H: derived from dodecyl group)

1.2 ppm (12H: derived from dodecyl group and methyl group of silyl group)

From the above results, it was confirmed that the synthesized compound is the title compound.

### Example 16-7

### Synthesis of Organic Silane Compound Represented by the Following Structural Formula (g)

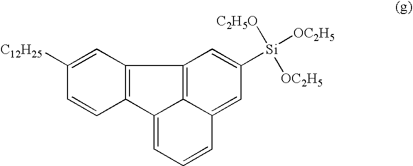

The above compound was synthesized by the following procedure. First, a carbon tetrachloride solution containing 0.1 M fluoranthene (CAS 206-44-0) was added to a 100 ml egg plant flask equipped with a stirrer, a refluxing condenser, a thermometer, and an addition funnel, NBS was charged therein, AIBN was added, and this was refluxed for 5 hours to synthesize 8-bromofluoranthene. Subsequently, 0.05 M 8-bromofluoranthene and 0.1 M CH₃(CH₂)₁₁MgBr were dissolved in 30 mL of diethyl ether, the solution was added to a 100 ml egg plan flask equipped with a stirrer, a refluxing condenser, a thermometer, and an addition funnel, and this was refluxing for 5 hours under the nitrogen atmosphere to synthesize 8-didodecylfluoranthene. Subsequently, the 8-didodecylfluoranthene was added to a 100 ml egg plant flask equipped with a stirrer, a refluxing condenser, a thermometer, and an addition funnel, NBS was charged therein, AIBN was added, this was refluxed for 2.5 hours to form 5-bromo-8-dodecylfluoranthene, 0.02 M triethoxychlorosilane was further added, and this was refluxed for 6 hours to synthesize the title 3-triethoxysilyl-6-dodecylfluoranthene.

By infrared absorption measurement of the title compound, absorption of Si—O—C was seen at a wavelength Of 1040 cm⁻¹. In addition, regarding results of NMR measurement, the following results were obtained.

7.8 ppm (3H: derived from fluoranthene)

7.6 ppm (2H: derived from fluoranthene)

7.3 ppm (3H: derived from fluoranthene)

3.6 ppm (6H: derived from methylene group of silyl group)

2.5 ppm (2H: derived from dodecyl group)

1.5 ppm (2H: derived from dodecyl group)

1.3 ppm (24H: derived from dodecyl group)

1.2 ppm (12H: derived from dodecyl group and methyl group of silyl group)

From the above results, it was confirmed that the synthesized compound is the title compound.

### Example 16-8

### Synthesis of Organic Silane Compound Represented by the Following Structural Formula (h)

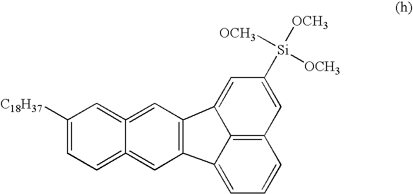

The above compound was synthesized by the following procedure. First, 100 mM NBS and AIBN were added to a carbon tetrachloride solution containing 50 mM benzofluoranthene (CASNO. 207-08-9), this was reacted at 60° C. for 2 hours under the N₂ atmosphere, unreacted materials were removed by filtration, and an accumulated material in which only one place was brominated was taken out using column chromatography to synthesize 9-bromo-benzofluoranthene. Subsequently, 20 mM 9-bromo-benzofluoranthene was added to a THF solution containing 20 mM CH₃(CH₂)₁₇MgBr, and this was reacted at 20° C. for 4 hours to synthesize 9-octadecylbenzofluoranthene. Subsequently, the 9-octadecylbenzofluoranthene was added to a 100 ml egg plant flask equipped with a stirrer, a refluxing condenser, a thermometer, and an addition funnel, NBS was charged therein, AIBN was added, this was refluxed for 2.5 hours to form 5-bromo-9-octadecylbenzofluoranthene, 0.02 M trimethoxychlorosilane was further added, and this was refluxed for 6 hours to synthesize the title 5-trimethoxysilyl-9-octadecylbenzofluoranthene.

By infrared absorption measurement of the title compound, absorption of Si—O—C was seen at a wavelength of 1045 cm⁻¹. In addition, regarding NMR, the following results were obtained.

8.1 ppm (1H: derived from benzofluoranthene group)

8.0 ppm (1H: derived from benzofluoranthene group)

7.9 ppm (1H: derived from benzofluoranthene group)

7.8 ppm (1H: derived from benzofluoranthene group)

7.7 ppm (5H: derived from benzofluoranthene group)

7.6 ppm (1H: derived from benzofluoranthene group)

7.3 ppm (1H: derived from benzofluoranthene group)

3.6 ppm (9H: derived from methoxy group, methyl group)

2.5 ppm (2H: derived from octadecyl group)

1.5 ppm (2H: derived from octadecyl group)

1.3 ppm (30H: derived from octadecyl group)

1.2 ppm (3H: derived from octadecyl group)

From the above results, it was confirmed that the above compound is the title compound.

### Example 16-9

### Synthesis of Organic Silane Compound Represented by the Following Structural Formula (i)

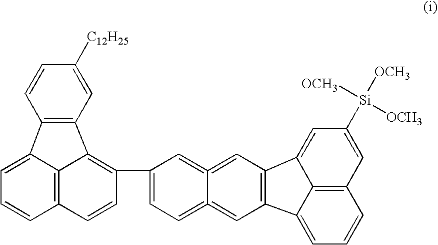

The above compound was synthesized by the following procedure. First, a carbon tetrachloride solution of 9-bromobenzofluoranthene which is an intermediate of Example 16-8 was added to a 100 ml egg plant flask containing a metal magnesium, this was refluxed for 2 hours to form a Grignard reagent, this was introduced into a 100 ml egg plant flask equipped with a stirrer, a refluxing condenser, a thermometer, and an addition funnel, a carbon tetrachloride solution of 3-bromo-6-dodecylfluoranthene which is an intermediate of Example 16-7 was further added, and this was refluxed for 5 hours under the nitrogen atmosphere to synthesize a dimer. Subsequently, the dimer was added to a 100 ml egg plant flask equipped with a stirrer, a refluxing condenser, a thermometer, and an addition funnel, NBS was charged therein, AIBN was added, this was refluxed for 2.5 hours to brominate, 0.01 M triethoxychlorosilane was added, and this was refluxed for 4 hours to synthesize the title compound.

From infrared absorption measurement of the title compound, absorption of Si—O—C was seen at a wavelength of 1045 cm⁻¹.

In addition, regarding NMR, the following results were obtained.

8.1 ppm (1H: derived from benzofluoranthene group)
8.0 ppm (1H: derived from benzofluoranthene group)
7.9 ppm (1H: derived from benzofluoranthene group)
7.8 ppm (4H: derived from benzofluoranthene group and fluoranthene group)
7.7 ppm (5H: derived from benzofluoranthene group)
7.6 ppm (3H: derived from benzofluoranthene group and fluoranthene group)
7.3 ppm (4H: derived from benzofluoranthene group and fluoranthene group)
3.6 ppm (6H: derived from methylene group of silyl group)
2.5 ppm (2H: derived from dodecyl group)
1.5 ppm (2H: derived from dodecyl group)
1.3 ppm (24H: derived from dodecyl group)
1.2 ppm (12H: derived from dodecyl group and methyl group of silyl group)

From the above results, it was confirmed that the above compound is the title compound.

### Example 16-10

### Formation of Thin Film and TFT Device

According to the same manner as that of Example 3, organic TFT devices using materials synthesized in Examples 7 to 15 as a semiconductor layer were formed. Properties of formed organic TFT devices are shown in Table 1.

TABLE 1

| | | | ON/ |
|---|---|---|---|
| | | | OFF |
| Material | Main skeleton | Mobility | ratio |
| Compound of Example 16-1 | Carbazole | 2.2 × 10⁻² | 5 |
| Compound of Example 16-2 | Dibenzofuran | 3.2 × 10⁻² | 5 |
| Compound of Example 16-3 | Fluorene | 1.2 × 10⁻² | 4 |
| Compound of Example 16-4 | Dibenzothiophene | 7.5 × 10⁻² | 5 |
| Compound of Example 16-5 | Pentaphene | 0.15 | 6 |
| Compound of Example 16-6 | Phenanthrene- | 0.17 | 6 |
| | pentaphene | | |
| Compound of Example 16-7 | Fluoranthene | 3.0 × 10⁻² | 4 |
| Compound of Example 16-8 | Benzofluoranthene | 4.0 × 10⁻² | 5 |
| Compound of Example 16-9 | Fluoranthene- | 5.5 × 10⁻² | 5 |
| | benzofluoranthene | | |

From the results of Table 1, it was confirmed that organic TFT devices using any material have TFT property.

1. An organic silane compound represented by the general formula (a);
(T)ₖ-SiX¹X²X³ (a)
wherein T is an organic group derived from a fused polycyclic hydrocarbon compound of a fusion number of 2 to 10 composed of a 5-membered and/or 6-membered monocyclic hydrocarbon; k is an integer of 1 to 10; at least one group of X¹ to X³ is a group which gives a hydroxy group by hydrolysis, or a halogen atom, and other groups of X¹ to X³ are a group which does not react with an adjacent molecule.

2. The organic silane compound according to claim 1, wherein T is the organic group derived from a fused polycyclic hydrocarbon compound selected from the group consisting of compounds represented by the general formulas (I) to (IX); 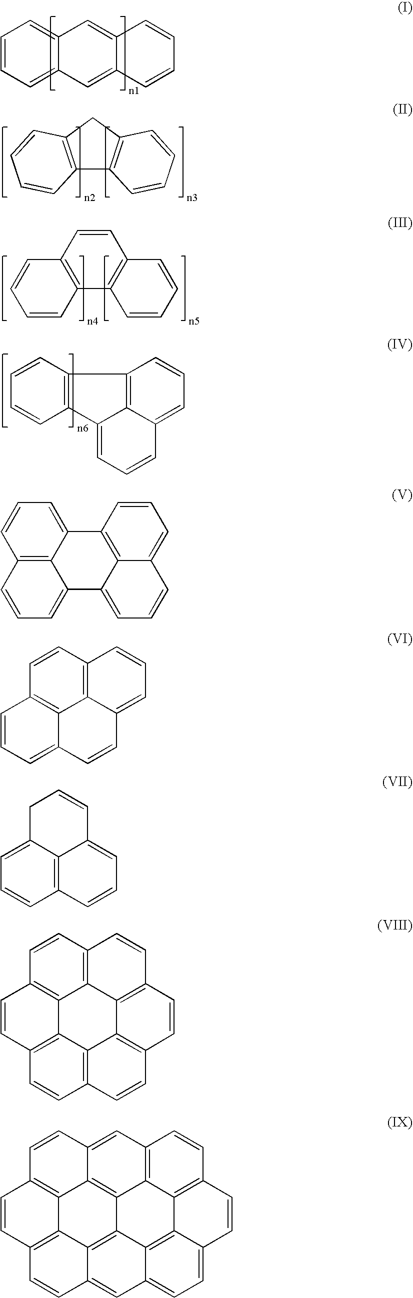
in the formula (I), n¹ is an integer of 0 to 10; in the formula (II), n² and n³ are integers of 0 or more, a sum of which is 1 to 9, respectively; in the formula (III), n⁴ and n⁵ are integers of 1 or more, a sum of which is 2 to 9, respectively; in the formula (IV), n⁶ is an integer of 0 to 7; in the formula (X), Y is an atom selected from carbon, nitrogen, oxygen and sulfur atoms, or an organic residue containing any of these atoms.

3. The organic silane compound according to claim 1, wherein the organic group further has a functional group, and the functional group is a substituted or unsubstituted alkyl group, a halogenated alkyl group, a cycloalkyl group, an aryl group, a diarylamino group, a di- or triarylalkyl group, an alkoxy group, an oxyaryl group, a nitrile group, a nitro group, or an ester group.

4. The organic silane compound according to claim 1, wherein the group which does not react with the adjacent molecule is a substituted or unsubstituted alkyl group, a cycloalkyl group, an aryl group, a diarylamino group, or a di- or triarylalkyl group.

5. The organic silane compound according to claim 3, wherein the fused polycyclic hydrocarbon compound is represented by the formula (1); 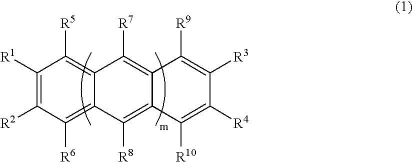
wherein m is 0 to 10; at least one group of R¹ to R¹⁰ is a silyl group represented by the general formula —SiX¹X²X³ (at least one group of X¹ to X³ is a group which gives a hydroxy group by hydrolysis, or a halogen atom, and other groups are a group which does not react with an adjacent molecule), and at least one group is an electron donating or electronattracting functional group, and other groups are a hydrogen atom.

6. The organic silane compound according to claim 5, wherein m is 0 to 7.

7. The organic silane compound according to claim 5, wherein at least one of R¹ and R² is the silyl group, and R³ and R⁴ are both a linear hydrocarbon group of a carbon number of 1 to 30.

8. The organic silane compound according to claim 5, wherein one of R³ and R⁴ is a linear hydrocarbon group of a carbon number of 1 to 30, and the other is a hydrogen atom.

9. The organic silane compound according to claim 3, wherein the organic silane compound is represented by the formula (V); 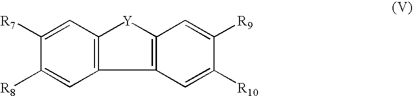
wherein R⁷ and R⁸ are the same or different, and are a silyl group represented by SiX¹X²X³, or a hydrogen atom (provided that the case where R⁷ and R⁸ are a hydrogen atom at the same time is not included), Y is selected from C(R¹¹)₂, NR¹², O and S (herein, R¹¹ and R¹² are a hydrogen atom, and may be directly bound to other functional group), X¹ to X³ are the same or different, and are an alkoxy group represented by O(CH₂)ₘCH₃ (m=0 to 9), or a halogen atom, and R⁹ and R¹⁰ are a hydrophobic group or hydrogen atom (provided that the case where R⁹ and R¹⁰ are a hydrogen atom at the same time is not included).

10. The organic silane compound according to claim 3, wherein the organic silane compound is represented by the formula (III)′; 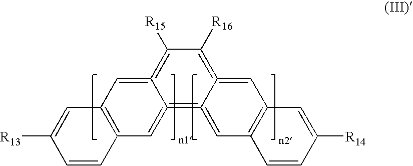
wherein R¹³ is a silyl group represented by SiX¹X²X³, R¹⁴ to R¹⁶ are the same or different, and are a hydrophobic group or a hydrogen atom (provided that the case where R¹⁴ to R¹⁶ are a hydrogen atom at the same time is not included), n^{1′} and n^{2′} are integers, a sum of which is 0 to 8, and X¹ to X³ are the same or different, and are an alkoxy group represented by O(CH₂)ₘCH₃ (m=0 to 9), or a halogen atom.

11. The organic silane compound according to claim 3, wherein the organic silane compound is represented by the formula (IV)′; 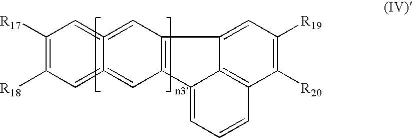
wherein R¹⁷ to R²⁰ satisfy any of the following two conditions:
condition 1: R¹⁷ and R¹⁸ are the same or different, and are a silyl group represented by SiX¹X²X³, or a hydrogen atom (provided that the case where R¹⁷ and R¹⁸ are a hydrogen atom at the same time is not included), R¹⁹ and R²⁰ are the same or different, and are a hydrogen atom or a hydrophobic group (provided that the case where R¹⁹ and R²⁰ are a hydrogen atom at the same time is not included), and X¹ to X³ are the same or different, and are an alkoxy group represented by O(CH₂)ₘCH₃ (m=0 to 9), or a halogen atom,
condition 2: R¹⁹ and R²⁰ are the same or different, and are a silyl group represented by SiX¹X²X³, or a hydrogen atom (provided that the case where R¹⁹ and R²⁰ are a hydrogen atom at the same time is not included), R¹⁷ and R¹⁸ are the same or different, and are a hydrogen atom or a hydrophobic group (provided that the case where R¹⁷ and R¹⁸ are a hydrogen atom at the same time is not included), and X¹ to X³ are the same or different, and are an alkoxy group represented by O(CH₂)ₘCH₃ (m=0 to 9), or a halogen atom.

12. A process for producing an organic silane compound, comprising Subjecting to the Grignard reaction of a compound represented by the general formula (b);
(T)ₖ-MgL¹ (b)
wherein T is an organic group derived from a fused polycyclic hydrocarbon compound of a fusion number of 2 to 10 composed of a 5-membered and/or 6-membered monocyclic hydrocarbon; k is an integer of 1 to 10; L¹ is a halogen atom, and a compound represented by the general formula (c);
L²-SiX¹X²X³ (c)
wherein L² is a hydrogen atom, a halogen atom, or an alkoxy group of a carbon number of 1 to 4; at least one group of X¹ to X³ is a group which gives a hydroxy group by hydrolysis, or a halogen atom, and other groups are a group which does not react with an adjacent molecule, to obtain a π electron conjugation system organic silane compound represented by the general formula (a);
(T)ₖ-SiX¹X²X³ (a)
wherein T, k, and X¹ to X³ are as defined above.

13. The process for producing an organic silane compound according to claim 12, wherein, via a first step of reacting a naphthalene derivative represented by the formula (1-1); 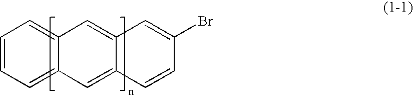
wherein n is an integer of 0 to 10, with R³—Br (R³ is a hydrophobic group) using a Grignard reaction to form an intermediate represented by the formula (1-2); 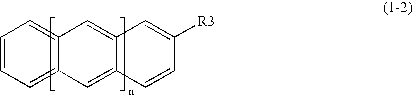
wherein n and R³ are as defined above,
a second step of brominating an α carbon of R³ of the intermediate, and Subjecting to the Grignard reaction of this with R⁴—Br (R⁴ is a hydrophobic group) to form the formula (1-3); 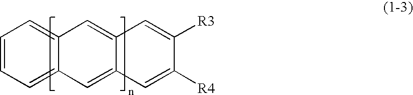
wherein n, R³ and R⁴ are as defined above,
a third step of brominating the intermediate represented by the formula (1-3) to obtain an intermediate represented by the formula (1-4); 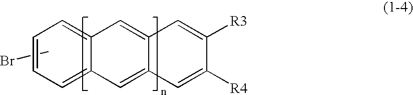
wherein n, R³ and R⁴ are as defined above,
or the formula (1-5); 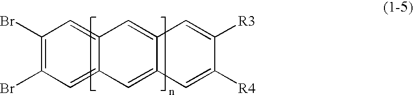
wherein n, R³ and R⁴ are as defined above, and
a fourth step of reacting the intermediate represented by the formula (1-4) and (1-5) with a silane compound represented by H—SiX¹X²X³ (provided that at least one group of X¹ to X³ is a group which gives a hydroxy group by hydrolysis, or a halogen atom, and other groups are a group which does not react with an adjacent molecule), thereby obtain the formula (I)′; 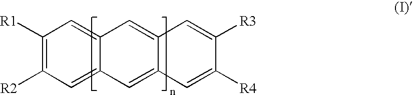
wherein n, and R¹ to R⁴ are as defined above.

14. The process for producing an organic silane compound according to claim 12, wherein r is represented by the formula (I); 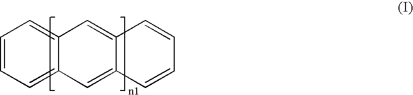
wherein n¹ is an integer of 0 to 10, and
a fused polycyclic hydrocarbon compound represented by the formula (I) is obtained by:
(1) a method of repeating a step of substituting a hydrogen atom binding to adjacent two carbon atoms of a raw material compound with an ethynyl group or a derivative thereof, and ring-closing reacting ethynyl groups, or
(2) a method of repeating a step of substituting a hydrogen atom binding to a carbon atom of a raw material compound with a triflate group, reacting this with furan or a derivative thereof, and then oxidizing this.

15. The process for producing an organic silane compound according to claim 12, wherein T is represented by the formula (IV) or (V); 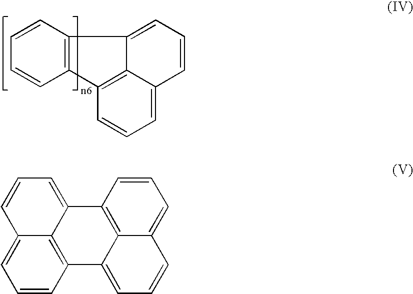
wherein n⁶ is an integer of 0 to 7, and
a fused polycyclic hydrocarbon compound represented by the formula (IV) or (V) is obtained by a method of repeating a step of substituting a hydrogen atom binding to adjacent two carbon atoms of a raw material compound with an ethynyl group or a derivative thereof, and ring-closing reacting ethynyl groups.

16. A functional organic thin film comprising a thin film which is derived from an organic silane compound represented by the general formula (a);
(T)ₖ-SiX¹X²X³ (a)
wherein T is an organic group derived from a fused polycyclic hydrocarbon compound of a fusion number of 2 to 10 composed of a 5-membered and/or 6-membered monocyclic hydrocarbon; k is an integer of 1 to 10; at least one group of X¹ to X³ is a group which gives a hydroxy group by hydrolysis, or a halogen atom, and other groups are a group which does not react with an adjacent molecule, and is bound to a substrate via a siloxane bond.

17. The functional organic thin film according to claim 16, wherein the organic group further has a hydrophobic group, and the hydrophobic group is a substituted or unsubstituted alkyl group, a halogenated alkyl group, a cycloalkyl group, an aryl group, a diarylamino group, a di- or triarylalkyl group, an alkoxy group, an oxyaryl group, a nitrile group, a nitro group, or an ester group.

18. The functional organic thin film according to claim 16, wherein the group which does not react with the adjacent molecule is a substituted or unsubstituted alkyl group, a cycloalkyl group, an aryl group, a diarylamino group, or a di- or triarylalkyl group.

19. The functional organic thin film according to claim 16, wherein T is the organic group derived from a fused polycyclic hydrocarbon compound selected from the group consisting of compounds represented by the general formulas (I) to (IX); 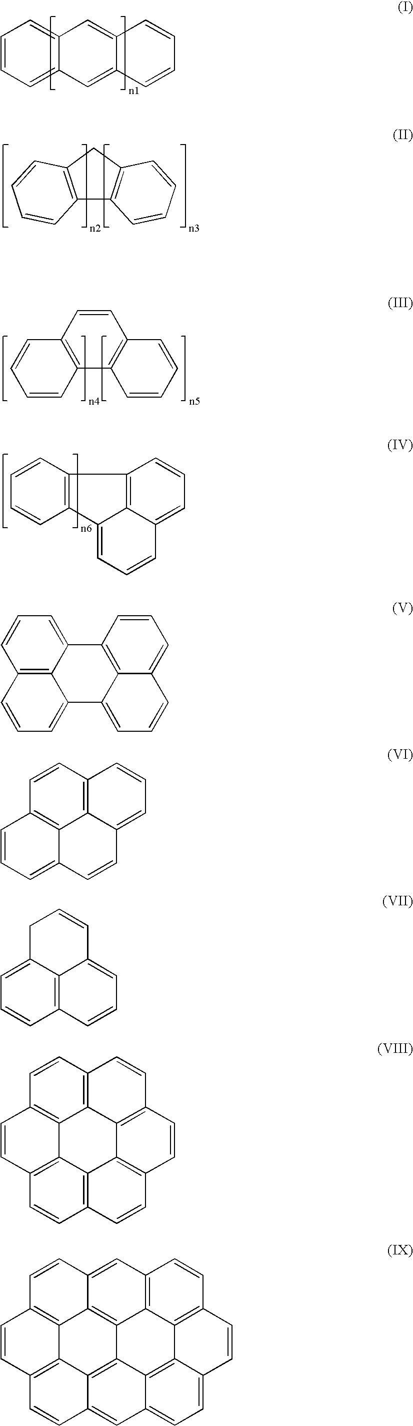
(in the formula (I), n¹ is an integer of 0 to 10; in the formula (II), n² and n³ are integers of 0 or more, a sum of which is 1 to 9, respectively; in the formula (III), n⁴ and n⁵ are integers of 1 or more, a sum of which is 2 to 9, respectively; in the formula (IV), n⁶ is an integer of 0 to 7; in the formula (X), Y is an atom selected from carbon, nitrogen, oxygen and sulfur atoms, or an organic residue containing any of these atoms).

20. The functional organic thin film according to claim 16, wherein the thin film is represented by the formula (I)″; 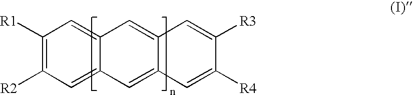
wherein n is an integer of 0 to 10, at least one of R¹ and R² constitutes a network composed of the following siloxane bond; 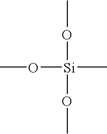
and is bound to the substrate via the siloxane bond (provided that the case where R¹ and R² are a hydrogen atom at the same time is not included), and R³ and R⁴ are a hydrophobic group, or a hydrophobic group and a hydrogen atom.

21. The functional organic thin film according to claim 20, wherein n is 0 to 7.

22. The functional organic thin film according to claim 20, wherein R³ and R⁴ are both a linear hydrocarbon group of a carbon number of 1 to 30.

23. The functional organic thin film according to claim 20, wherein one of R³ and R⁴ is a linear hydrocarbon group of a carbon number of 1 to 30, and the other is a hydrogen atom.

24. A process for manufacturing a functional organic thin film, comprising subjecting an organic silane compound represented by the general formula (a);
(T)ₖ-SiX¹X²X³ (a)
wherein T is an organic group derived from a fused polycyclic hydrocarbon compound of a fusion number of 2 to 10 composed of a 5-membered and/or 6-membered monocyclic hydrocarbon; k is an integer of 1 to 10; at least one group of X¹ to X³ is a group which gives a hydroxy group by hydrolysis, or a halogen atom, and other groups are a group which does not react with an adjacent molecule, to a chemical binding method to bind to a substrate via a siloxane bond.

25. The process for manufacturing a functional organic thin film according to claim 24, wherein the chemical binding method is a LB method.

26. An organic thin transistor, comprising a substrate, a functional organic thin film which is derived from an organic silane compound represented by the general formula (a);
(T)ₖ-SiX₁X₂X₃ (a)
wherein T is an organic group derived from a fused polycyclic hydrocarbon compound of a fusion number of 2 to 10 composed of a 5-membered and/or 6-membered monocyclic hydrocarbon; k is an integer of 1 to 10; at least one group of X₁ to X₃ is a group which gives a hydroxy group by hydrolysis, or a halogen atom, and other groups are a group which does not react with an adjacent molecule, and is bound to a substrate via a siloxane bond, a gate electrode formed on one surface of the functional organic thin film via a gate insulating film, and a source electrode/a drain electrode which are formed on both sides of the gate electrode, contacting with one surface or other surface of the functional organic thin film.

27. The organic thin film transistor according to claim 26, wherein the organic silane compound is represented by the formula (I)′; 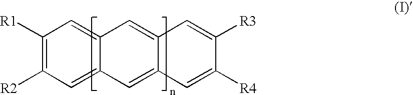
wherein n is an integer of 0 to 10, R¹ and R² are the same or different, and are a silyl group represented by SiX¹X²X³, or a hydrogen atom (provided that the case where R¹ and R² are a hydrogen atom at the same time is not included), X¹ to X³ are as defined above, and R³ and R⁴ are a hydrophobic group, or a hydrophobic group and a hydrogen atom.

28. A process for manufacturing an organic thin film transistor, comprising the steps of (A) forming a functional organic thin film which is derived from an organic silane compound represented by the general formula (a);
(T)ₖ-SiX¹X²X³ (a)
wherein T is an organic group derived from a fused polycyclic hydrocarbon compound of a fused number of 2 to 10 composed of a 5-membered and/or 6-membered monocyclic hydrocarbon; k is an integer of 1 to 10; at least one group of X¹ to X³ is a group which gives a hydroxy group by hydrolysis, or a halogen atom, and other groups are a group which does not react with an adjacent molecule, and is bound to a substrate via a siloxane bond, directly or indirectly on the substrate, (B) forming a gate electrode indirectly or directly on the substrate, (C) forming a source electrode•a drain electrode on one surface side or other surface side of the functional organic thin film, and (D) forming a gate insulating film between the gate electrode and the source electrode•drain electrode.

29. An organic electroluminescence device, comprising having one or more organic thin films between an anode and a cathode, wherein at least one organic thin film is a functional organic thin film which is derived from an organic silane compound represented by the general formula (a);
(T)ₖ-SiX¹X²X³ (a)
wherein T is an organic group derived from a fused polycyclic hydrocarbon compound of a fusion number of 2 to 10 composed of a 5-membered and/or 6-membered monocyclic hydrocarbon; k is an integer of 1 to 10; at least one group of X¹ to X³ is a group which gives a hydroxy group by hydrolysis, or a halogen atom, and other groups are a group which does not reactive with an adjacent molecule, and is bound to the anode, the cathode or other organic thin film via a siloxane bond.

30. The organic electroluminescence device according to claim 29, wherein the construction having one or more organic thin films between the anode and the cathode is a construction of anode-light emitting layer-electron transporting layer-cathode or a construction of anode-hole transporting layer-light emitting layer-electron transporting layer-cathode, and the electron transporting layer is bound to the light emitting layer via a chemical bond.

31. The organic electroluminescence device according to claim 29, wherein the construction having one or more organic thin films between the anode and the cathode is a construction of anode-hole transporting layer-light emitting layer-cathode or a construction of anode-hole transporting layer-light emitting layer-electron transporting layer-cathode, and the hole transporting layer is bound to the anode via a chemical bond.

32. The organic electroluminescence device according to claim 29, wherein the organic silane compound is represented by the formula (1); 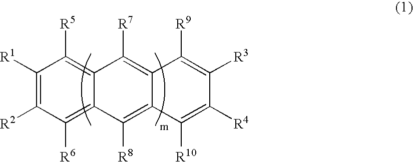
wherein m is 0 to 10; at least one group of R¹ to R¹⁰ is a silyl group represented by the general formula —SiX¹X²X³ (at least one group of X¹ to X³ is a group which gives a hydroxy group by hydrolysis, or a halogen atom, and other groups are a group which does not react with an adjacent molecule), at least one group is an electron donating or electronattracting functional group, and other groups are a hydrogen atom.

33. The organic electroluminescence device according to claim 29, wherein the group which does not react with the adjacent molecule is a substituted or unsubstituted alkyl group, a cycloalkyl group, an aryl group, a diarylamino group, or a di- or triarylalkyl group.
